(19) United States
(12) Patent Application Publication
(10) Pub. No.: US 2013/0262028 A1
(43) Pub. Date: Oct. 3, 2013

(54) Efficient Method For Selecting Representative Elementary Volume In Digital Representations Of Porous Media

(71) Applicants: Giuseppe DE PRISCO, Houston, TX (US); Jonas TOELKE, Houston, TX (US)

(72) Inventors: Giuseppe DE PRISCO, Houston, TX (US); Jonas TOELKE, Houston, TX (US)

(73) Assignee: Ingrain, Inc., Houston, TX (US)

(21) Appl. No.: 13/546,053

(22) Filed: Jul. 11, 2012

Related U.S. Application Data
(60) Provisional application No. 61/618,265, filed on Mar. 30, 2012.

(51) Int. Cl. G06F 17/18

(52) U.S. Cl. 702/156

(57) ABSTRACT

The present invention relates a method to estimate representative elementary volume (REV) in a sample of porous media wherein the sub-volume selected is a better approximation of the elementary volume than existing methods. REV in a sample of porous media such as rock can be defined wherein the REV is selected with respect to the expected direction of fluid flow through the porous media. The method can quantify how good is the digital representation of a rock and how accurate a description of a fluid flow through Darcy's law will be, and allows the evaluation of different length scales in different directions for the REV and an assessment of the anisotropy of the pores structures when the method is applied in different directions. The method also can determine a robust criteria to understand when a trend of porosity-permeability breaks down due to an insufficient size of the subsample.

This application claims the benefit under 35 U.S.C. §119(e) of prior U.S. Provisional Patent Application No. 61/618,265, filed Mar. 30, 2012, which is incorporated in its entirety by reference herein.

### BACKGROUND OF THE INVENTION

The present invention relates to methods and systems for predicting the properties of the flow of fluids through porous media, such as porous rock and, in particular, relates to such methods and systems for selecting, from a digital representation of a heterogeneous porous medium, the most representative subsample to use for predicting properties, such as porosity, permeability, and/or related characteristics.

Digital representations of porous media, such as rock, bone, soil, and other materials can be produced via x-ray computed tomographic image scans, scanning electron microscopy, confocal microscopy, and other techniques. Such digital representations are useful for characterizing porous media using computer simulations (Knackstedt, M. A., et al, “Digital Core Laboratory: Properties of Reservoir Core Derived from 3D Images”, Society of Petroleum Engineers, 2004; and Vermeulen, J. P., “New Developments in FESEM Technology”, Carl Zeiss nano-technology Systems Division, http://www.zeiss.com/C1256E4600307C70/EmbedTitelIntern/NewDevelopmentinFESEMTechn ology/$File/New_Development_FESEM_Technology.pdf.).

An important issue in digital simulation of porous media characteristics is sample size. Many of the samples of practical interest, such as porous rock, are heterogeneous and average properties for large volumes of porous media would require very large samples to be digitized. Many of the rock characteristics, such as absolute permeability, require significant computational resources to simulate and as a result sample sizes are often much smaller than the volume of interest for representative characterization. Subsamples may be selected visually by a trained geologist, but this approach is subjective and highly variable. Furthermore, business and technical decisions, such as investment in wells, well perforation plans, recoverable reserve estimates and other such decisions, made on the basis of the digital simulation of rock characteristics often involve great expense. As a result there is a need to remove subjectivity, error, and variation in characterizing such porous media.

One approach to identifying suitable subsamples is identifying a representative elementary volume (REV). The REV is the smallest volume over which a specific measurement can be made that will yield a value representative of the whole. Volumes below the REV, exhibit variation in the specific measurement making samples smaller than the REV unsuitable for simulations. A method for calculating REV using volumetric porosity as the measurement is described in the literature by Bear (Bear, J., Dynamics of Fluids in Porous Media; General Publishing Company Ltd., Canada, 1972, pp. 19-21). Many methods that are labeled as REV are not truly “elementary” in the result. That is, many of the methods in use can find sub-volumes of a larger volume that are representative of the larger volume but the method may not produce the smallest possible or elementary volume.

Razavi et al. describes a common approach to REV (Razavi, et al., “Representative Elementary Volume Analysis of Sands Using X-Ray Computed Tomography,” Geotechnical Testing Journal, Vol. 30, No. 3, Paper ID GTJ100164, 2006). The flow chart for the method described by Razavi et al. is shown in FIG. 1 thereof. In the method shown by Razavi et al., a point at the approximate center of a sample is selected and then a spherical subsample volume is examined around this central point. Sample properties are computed for the spherical subsample. The radius of the sub-sample is increased and the properties recalculated. The sub-sample volume is increased stepwise until the REV is reached. This method has a number of shortcomings. It may not yield a suitable result in certain heterogeneous samples. While it may result in an acceptable RV, it may not yield a REV. As mentioned above, computations on digital representations of rock samples can require significant computer time to complete, so determining the smallest REV within a sample is of great value.

U.S. Pat. No. 6,516,080 (Nur) discloses a method for selecting an REV from a representative area. FIG. 2 thereof shows how a square area centered on one face of a sample is increased in size until a representative area is found. The length of the side of the square of representative area is then selected as the length of sides of a cube centered in the three dimensional sample. This method depends upon the sample being homogeneous and isotropic. This is not typical of many real world samples such as well cores.

U.S. Patent Application Publication No. 2011/0004447 (Hurley, et al.) relates to a method for characterizing a three-dimensional sample of porous media using at least one measuring tool that retrieves two or more sets of transmitted measured data at two or more depths of the sample. In this method, the porosity representative element volume (REV) is estimated by (1) randomly selecting multiple, non-overlapping blocks of uniform size from a measured or modeled sample, (2) plotting individual block porosity versus corresponding block volume, and (3) determining the variance between the porosity measured for each sample for a given block volume. The porosity is the average of porosity within the selected sample. When variance of the measured porosity falls below a chosen threshold, the corresponding volume is the porosity REV of the rock under study. This method of Hurley et al. does not grow a volume starting from a point and as such will cover more possible sub-volumes that would effectively reduce sample size. The method has shortcomings in that it is designed to use many subsamples such that a statistically relevant variance can be obtained and may need to use a large sample in order to achieve the desired convergence, which are two needs that are not always possible and may give the whole original sample as RV. The present investigators have recognized that this is the case for a sample subjected to Laser Scanning Confocal Microscopy (LSCM). The method of Hurley et al. also may not identify the smallest possible REV within a sample.

An interesting and powerful approach to characterize the microstructures of a porous media is the stochastic analysis of the local porosity theory by Hilfer (1992). This method is formulated in a scale-dependent way and gives a good estimation of the integral length scale for an REV. However, the local porosity method does not give results regarding the anisotropy of the porous space. An improvement of this method was made by Liu et al (2009 and 2010) where a local anisotropy distribution, evaluated in a scale depended way, was evaluated. This improvement required the application of the method by Ketcham (2005), where the anisotropy is a function of the directional variation of the character of the pore structures.

Many estimates of the properties of porous media, such as rock, are made using Darcy's Law. Darcy's law is a phenomenologically derived equation that approximates the flow of a fluid through a porous medium. The law was formulated by Henry Darcy based on the results of experiments that he conducted on the flow of water through beds of sand. Darcy's Law is essentially an expression of conservation of momentum. Darcy's Law, as it is often applied to flow through porous media, such as rock samples, can be used to make an estimate of volumetric flow with the following Equation 1, which has Darcy Flow parameters such as illustrated in FIG. 24:

$$Q = \frac{- kA}{μ} \frac{Pb - P a}{L}$$

wherein
   Q=Volumetric flow rate within one phase in the sample per unit time.
   k=is the absolute permeability of the porous medium
   A=the cross sectional area for flow
   μ=the dynamic viscosity
   Pb, Pa=pressure at the inlet and outlet of the volume.
   L=length of the sample.

Formally, to derive Darcy's law, so as to define a permeability, for example, from first principle some hypothesis must be verified. In particular, as shown by Whitaker, S., Transport in Porous Media 1, 1986, pp. 3-25, a way to derive Darcy law from Navier Stokes equations (i.e., equation for the momentum) is to apply Gary's decomposition:

P= P̅+\tilde{p}

that is fundamentally a decomposition of scales: P is an averaged quantity (in this case pressure) that is supposed to be “well behaved” over the averaging integral scale (that can be the length scale of the sample, like the transverse or longitudinal dimension). In other words, these averaged functions are supposed to sufficiently describe the quantities that they represent. For instance, a pressure signal that rapidly changes over a length scale comparable to the averaging length scale cannot represent the pressure over that length. The quantity \tilde{p} is the fluctuating part of the pressure, wherein it represents the variation of the function. A hypothesis is that the averaged quantities do not change on the small scales where the fluctuating part are allowed to have small variation. To derive Darcy' law, together with Gary's decomposition, an average operation must be applied to the Navier-Stokes equations (e.g., the volume-averaged method). However, in this case, one obtains the average of gradients of fields while it is the gradient of the averaged quantities that is desired (as shown in Darcy's law). It can be proved easily that the two operators (gradient and average) commute when applied to functions that do not change rapidly over the averaging length scales. In particular, if the porosity is uniform. Darcy's law can then be written in a more general notation as the following Equation 2:

$$\overline{q ( x )} = \frac{- k ( x )}{μ} ∇ \overline{P ( x )}$$

wherein
   q̅(̅x̅)̅=Volume averaged flux at a position x.
   k=is the absolute permeability of the porous medium at the position x
   μ=the dynamic viscosity
   ∇ P̅=Gradient of the intrinsic (within the pores) average pressure at position x.
      Using this equation, a scale where the averaged quantities change with position are looked at and the fluctuating part is not seen anymore. This equation can be used to simulate flow in a reservoir.

When an REV is selected by any of the means described above, there is a possibility that variation of porosity within the REV can exist which makes assumptions about Darcy Flow invalid or prone to error. Moreover, the pressure gradient can rapidly change along the flow direction which makes it impossible to define a permeability associated with a particular sub-sample. This is especially true for highly heterogeneous samples, such as those which can be found in real world rock formations.

The present investigators have recognized that there is a need for a more efficient method to estimate a representative elementary volume (REV) in a sample of porous media, including for heterogeneous samples. Moreover, the analysis has to account for directional variation of the pores structure in order to account for the anisotropy of the porous media and, in case that a directional property like flow is considered, the direction of the flow.

### SUMMARY OF THE INVENTION

A feature of the present invention is to provide an efficient method to estimate a representative elementary volume (REV) in a sample of porous media such as rock wherein the sub-volume selected is a better approximation of the elementary volume than existing methods.

A further feature of the present invention is to provide an efficient method to define an REV in a sample of porous media such as rock wherein the REV is selected with respect to the expected direction of fluid flow through the porous media.

A further feature of the present invention is to provide an efficient method to quantify how good (or how bad) is the digital representation of a rock and how accurate a description of a fluid flow through Darcy's law is going to be.

A further feature of the present invention is to provide a method to determine a robust criteria to understand when a trend of porosity-permeability breaks down due to an insufficient size of the subsample.

A further feature of the present invention is to provide a method to analyze the porous structure in a scale-depended way including directional information of the variation of the heterogeneities.

To achieve these and other advantages, and in accordance with the purposes of the present invention, as embodied and broadly described herein, the present invention relates, in one part, to a method for identifying a subsample representative digital volume corresponding to a sample of a porous media, which comprises the steps of a) obtaining a segmented volume characterizing pore space and at least one solid phase; b) deriving an average property value <P1> of a first target function P1 for the whole of the segmented volume; c) calculating a standard deviation σᵥₒₗ with respect to average property value <P1> for the whole of the segmented volume; d) defining a plurality of subvolumes within the volume; e) calculating a standard deviation σᵢ of property value P of first target function P1 with respect to average property value <P1> for each of said subvolumes; f) finding all candidate representative subvolumes for which standard deviation σᵢ is a satisfactory match to σᵥₒₗ; g) selecting and storing a representative subvolume from among the candidates; and h) using the representative subvolume to derive at least one property value of interest.

The present invention also relates to a method for identifying a subsample representative digital volume corresponding to a sample of a porous media, which comprises steps of a) obtaining a segmented volume characterizing pore space and at least one solid phase; b) orienting a selected axis of the Cartesian grid of the segmented volume to a defined flow direction; c) deriving values as one or more functions of at least a first target function P1 for the whole of the segmented volume through analysis of digital slices orthogonal to the defined flow direction; d) defining a plurality of subvolumes within the volume; e) calculating values for the one or more functions of at least a first target function P1 for each of said subvolumes respecting the defined direction of flow; f) finding all representative subvolume candidates for which the function(s) identify a match between volume and subvolume values; g) selecting a representative volume form among the candidates; h) storing the representative subvolume; and i) using the representative subvolume for simulation or to derive at least one property value of interest.

The present invention also relates to a method to obtain an efficient estimate of a representative elementary volume from a larger 3D digital image of a porous sample, which comprises steps of a) obtaining a segmented volume characterizing pore space and at least one solid phase; b) deriving values as at least one function for at least a first target function P1 for the whole of the segmented volume; c) defining a plurality of subvolumes within the volume, comprising defining an initial size for a subvolume, populating the whole of the volume with subvolumes of the defined initial size, iterating the sized for further subvolumes and populating the whole of the volume with subvolumes of such size and repeating this step until a stop criteria is met; d) calculating values as at least one function for at least the first target function for each of said subvolumes; e) finding all representative subvolumes candidates for the values of the volume and the subvolume satisfactory match; f) selecting and storing a representative subvolume from among the candidates; and g) using the representative subvolume to conduct a simulation or derive at least one property value of interest.

The present invention also relates to a method to obtain an efficient estimate of a representative elementary volume from a larger 3D digital image of a porous sample, which comprises the steps of a) obtaining a segmented volume characterizing pore space and at least one solid phase; b) orienting a selected axis of the Cartesian grid of the segmented volume to a defined flow direction; c) deriving an average property value <P1> of a first target function P1 for the whole of the segmented volume using an analysis of multiple digital slices of the sample volume taken orthogonal to the defined flow direction; d) calculating a standard deviation with respect to average property value <P1> for the whole of the segmented volume; e) defining a plurality of subvolumes within the volume, comprising defining an initial size for a subvolume, populating the whole of the volume with subvolumes of the defined initial size, iterating the sizes for further subvolumes from large to small and populating the whole of the volume with subvolumes of such size and repeating this step until a stop criteria is met; f) calculating a standard deviation σᵢ of property P with respect to average property value <P1> for each of said subvolumes respecting the defined direction of flow; g) finding all candidate representative subvolumes for which σᵢ is a satisfactory match to σᵥₒₗ; h) selecting the smallest candidate and storing this as a representative elementary volume; and i) using the representative elementary volume to derive at least one property value of interest.

The present invention also relates to a method for identifying a subsample representative digital volume corresponding to a sample of a porous media, which comprises the steps of 1) loading a segmented three dimensional image of a porous medium into a computer system, wherein the segmented three-dimensional image comprises voxels each of which is assigned a grey scale value; 2) selecting a flow direction that is defined as the Z direction; 3) defining sizes of interrogation volumes wherein i) an interrogation volume is a subsample of the original segmented three-dimensional image with dimensions Xi, Yi and Zi, wherein the dimensions of the entire sample are Xs, Ys, Zs, ii) a maximum number of interrogation volumes, imax, is defined, iii) dimensions in voxels for each interrogation volume (Xi, Yi, Zi) are set, wherein Xi, Yi and Zi are defined for values of i from 1 to imax, and iv) the initial value of i is set to 1; 4) calculating selected properties Ps(0,0,0) through Ps(0,0,Zs) for each slice of the interrogation volume; 5) calculating σs(0,0,0); 6) setting the maximum coordinates that the interrogation volume of size Xi, Yi, Zi occupy within the entire sample of size Xs, Ys, Zs, wherein amax=Xs−Xi+1, bmax=Ys−Yi+1, cmax=Zs−Zi+1; 7) setting location coordinates of the current interrogation volume to a=b=c=0; 8) calculating selected properties Pi(a,b,c) through Pi(a,b,c+Zi) for slices of the current interrogation volume, wherein the selected properties comprise porosity, surface area to volume ratio, similar properties, or any combination thereof, 9) calculating σi(a,b,c), wherein optionally values of Pi that are used to calculate the value of σi are filtered, wherein optionally an average value for Pi is set; 10) moving the location of the interrogation volume by 1 voxel in the X direction, a=a+1; 11) repeating steps 8) through 10) and storing all values of Pi and σi until the value of the X coordinate of the current interrogation volume, a, has equaled the maximum value that the current interrogation volume can occupy, amax; 12) setting the X coordinate of the current interrogation volume to zero, a=0, and incrementing the Y coordinate of the current location volume by one voxel, b=b+1; 13) repeating steps 8) through 12) and storing all values of Pi and σi until the value of the Y coordinate of the current interrogation volume, b, has equaled the maximum value that the current interrogation volume can occupy, bmax; 14) setting the X coordinate of the current interrogation volume to zero, a=0, setting the Y coordinate of the current interrogation volume to zero, b=0, and incrementing the Z coordinate of the current location volume by one voxel, c=c+1; 15) repeating steps 8) through 14) and storing all values of Pi and σi until the value of the Z coordinate of the current interrogation volume, c, has equaled the maximum value that the current interrogation volume can occupy, cmax; 16) increasing the size of the current interrogation volume, comprising i) selecting the next set of interrogation volumes by increasing the pointer to the next interrogation volume, i=i+1, and ii) setting the current interrogation size to Xi, Yi, Zi; 17) repeating steps 6) through 16) until all of the interrogation volumes have been selected and all values of Pi and σi have been calculated and stored; 18) choosing one or more selected properties to match; 19) calculating λi for each interrogation volume; 20) selecting the interrogation volume with the smallest value of λi, wherein the selected interrogation volume is the size and location of the REV; and 21) computing properties of the porous medium.

Computerized systems, computer readable media, and programs for performing the methods are also provided.

It is to be understood that the foregoing general description and the following detailed description are exemplary and explanatory only and are only intended to provide a further explanation of the present invention.

The accompanying drawings, which are incorporated in and constitute a part of this application, illustrate some of the embodiments of the present invention and together with the description, serve to explain the principles of the present invention. The drawings are not necessarily drawn to scale. Like numerals in the drawings refer to like elements in the various views.

### BRIEF DESCRIPTION OF DRAWINGS

FIG. 1 is a flow diagram illustrating a prior practice for identifying an REV using an M-REV program.

FIG. 2 illustrates another prior sampling scheme for identifying an REV with selecting REV from a representative area.

FIG. 3 illustrates another prior sampling scheme for identifying an REV using a porosity REV method.

FIG. 4 is a graph of measured property against sample volume illustrating a prior definition of REV.

FIGS. 5A and 5B illustrate subsample selection in pore space connectivity modeled with a fluid flow system of pipes having large conduits connected through small restrictive conduits according to an example of the present application.

FIG. 6 illustrates a flow diagram of a method to estimate a REV based on statistically qualifying subvolumes according to an example of the present application.

FIG. 7 illustrates a sample volume and an interrogation volume, which includes a definition of terms related to sample and interrogation volume, according to an example of the present application.

FIGS. 8A and 8B illustrate subvolume selection in a modeled fluid flow system having a markedly direction fluid flow characteristics according to an example of the present application, wherein FIG. 8A is an overhead view of fluid flow conduits and FIG. 8B is a cross-sectional view of the fluid flow conduits taken along line 8B-8B of FIG. 8A.

FIG. 9 illustrates a digital slice of an interrogation volume according to an example of the present application.

FIG. 10 is a flow diagram illustrating a method to estimate a REV further including orienting the grid to flow, testing subvolume suitability with multiple properties, and methodically moving through the subvolumes according to an example of the present application.

FIGS. 11A and 11B illustrate subvolume selection in a more complex modeled fluid flow system according to an example of the present application, in which Cartesian grid is realigned in FIG. 11A and FIG. 11B is a cross sectional view taken at line 11B-11B in FIG. 11A.

FIG. 12 illustrates a segmented volume representing a natural rock sample having substantially heterogeneous features according to an example of the present application.

FIG. 13 illustrates a segmented volume representing a natural rock sample having a less heterogeneous structure than that illustrated in FIG. 12 according to an example of the present application.

FIG. 14 is a detailed flow chart outlining one embodiment according to an example of the present application.

FIGS. 15A and 15B illustrate standard deviation distributions for the surface/volume ratio and porosity, respectively, for the fluid flow system modeled in FIGS. 11A and 11B where the size of the interrogation volume matches the elementary cell which corresponds to the periodicity within the sample whole according to an example of the present application.

FIGS. 16A-16E illustrate the standard deviation of porosity in the fluid flow system for different interrogation volume sizes in the fluid flow system modeled at FIG. 11A-11B according to an example of the present application.

FIGS. 17A-17E illustrate the standard deviation of the surface to volume ratio of pore space in the fluid flow system for different interrogation volume sizes in the fluid flow system modeled at FIG. 11A-11B according to an example of the present application.

FIGS. 18A-18B illustrate the standard deviation for the target functions of porosity (FIG. 18A) and surface to volume ratio (FIG. 18B) for the rock sample of at FIG. 13 for a 450×450×450 interrogation volume according to an example of the present application.

FIGS. 19A-19B illustrate the standard deviation for the target functions of porosity (FIG. 19A) and surface to volume ratio (FIG. 19B) for the rock sample of at FIG. 13 for a 300×300×300 interrogation volume according to an example of the present application.

FIGS. 20A-20B illustrate the standard deviation for the target functions of porosity (FIG. 20A) and surface to volume ratio (FIG. 20B) for the rock sample of at FIG. 13 for a 200×200×200 interrogation volume according to an example of the present application.

FIGS. 21A-21B illustrate the standard deviation for the target functions of porosity (FIG. 21A) and surface to volume ratio (FIG. 21B) for the rock sample of FIG. 12 for a 450×450×450 interrogation volume according to an example of the present application.

FIGS. 22A-22B illustrate the standard deviation for the target functions of porosity (FIG. 22A) and surface to volume ratio (FIG. 22B) for the rock sample of FIG. 12 for a 300×300×300 interrogation volume according to an example of the present application.

FIGS. 23A-23B illustrate the standard deviation for the target functions of porosity (FIG. 23A) and surface to volume ratio (FIG. 23B) for the rock sample of FIG. 12 for a 200×200×200 interrogation volume according to an example of the present application.

FIG. 24 is a schematic illustration of Darcy Flow.

FIG. 25 illustrates three poro-perm trends in a plot of absolute permeability (mD) against porosity (as a fractional value between 0-1.0) for a Fountainebleau rock sample for subsample dimensions of 95×95×95 (grey triangles), 190×190×190 (grey circles), and 285×285×285 (grey crosses), and which includes a poro-perm value for an original sample size of 500×500×500 for a trend line (the “UL” solid grey line that includes the hollow diamond symbol data point), and the black symbols are the optimal choices made by targeting both the function surface/volume and porosity, according to an example of the present application. The two lines are the lower and upper limits respectively that are from experiments made on these rocks.

FIG. 26 illustrates porosity/permeability correlation (poro-perm) trends in plots of absolute permeability (mD) against porosity for a non-consolidated sandstone sample for subsample dimensions of 300×300×300 (grey crosses), 200×200×200 (grey circles), and 100×100×100 (grey triangles), according to an example of the present application. The two sets of data, i.e., “1_{—}100” and “1_{—}200” and also “2_{—}100” and “2_{—}200,” are for two different samples (Samples 1 and 2). The two samples are very similar.

FIG. 27 illustrates poro-perm trend curves in plots of absolute permeability (mD) against porosity for a Fontainebleau sample of lower porosity than the sample of FIG. 25, which includes poro-perm trends for subsample dimensions of 190×190×190 (grey triangles), 285×285×285 (grey circles), and 380×380×380 (grey crosses), and which includes a poro-perm value for an original sample size of 500×500×500 for a trend line UL (solid grey line that intersects the hollow diamond symbol), and the black symbols are the optimal choices made by targeting both the function surface/volume and porosity, according to an example of the present application. The “Lower Lab” curve is a lower limit from experiments made on these rocks.

FIGS. 28A-28H illustrate the average ratio value (A) of the distribution of standard deviation for porosity (FIG. 28A), the surface to volume ratio (FIG. 28B), the variance (V) of the same distribution for porosity (FIG. 28C), the variance of the surface to volume ratio (FIG. 28D), the skewness for porosity (FIG. 28E), the variance of the skewness (FIG. 28F), the kurtosis for porosity (FIG. 28G), and the variance of the kurtosis (FIG. 28H), all versus sub-volume sample dimension (size), for the two different Fontainebleau rocks addressed in FIG. 25 and FIG. 27, respectively, according to an example of the present application. The Fontainebleau rock addressed in FIG. 25 is represented by the curves in FIGS. 28A-28H which are defined by black circles, and the rock addressed in FIG. 27 is represented by the curves defined in FIGS. 28A-28H by grey circles. In FIGS. 28A-28H, the plots are numbered in correspondence with the numbers given in the inset legends thereof and in FIGS. 25 and 27.

FIGS. 29A-29H illustrate the average ratio value (A) of the distribution of standard deviation for porosity (FIG. 29A), the surface to volume ratio (FIG. 29B), the variance (V) of the same distribution for porosity (FIG. 29C), the variance of the surface to volume ratio (FIG. 29D), the skewness for porosity (FIG. 29E), the variance of the skewness (FIG. 29F), the kurtosis for porosity (FIG. 29G), and the variance of the kurtosis (FIG. 29H), all versus sub-volume sample dimension (size), for two different carbonate rocks, respectively, with one sample indicated by grey circles and the other by black circles in these plots, according to an example of the present application. In FIGS. 29A-29H, the plots are numbered in correspondence with the numbers given in the inset legends thereof and in FIGS. 291 and 29J.

FIGS. 29I-29J illustrate poro-perm trends for the two different carbonate rocks addressed in FIGS. 29A-29H according to an example of the present application. FIG. 29I includes poro-perm trends for the sample identified by grey circles in FIGS. 29A-29H for subsample dimensions of 95×95×95, 190×190×190, and 285×285×285, and which includes a poro-perm value for an original sample dimension size of 500×500×500 for a trend line D1 (solid grey line, hollow diamond symbol), and the black symbols are the optimal choices made by targeting both the function surface/volume and porosity. FIG. 29J includes poro-perm trends for the sample identified by black circles in FIGS. 29A-29H for subsample dimensions of 190×190×190, 285×285×285, and 380×380×380, and which includes a poro-perm value for an original sample size of 500×500×500 for a trend line D2 (solid grey line, hollow diamond symbol), and the black symbols are the optimal choices made by targeting both the function surface/volume and porosity.

FIGS. 30A-30H illustrate the average ratio value (A) of the distribution of standard deviation for porosity (FIG. 30A), the surface to volume ratio (FIG. 30B), the variance (V) of the same distribution for porosity (FIG. 30C), the variance of the surface to volume ratio (FIG. 30D), the skewness for porosity (FIG. 30E), the variance of the skewness (FIG. 30F), the kurtosis for porosity (FIG. 30G), and the variance of the kurtosis (FIG. 30H), all versus sub-volume sample dimension (size) for two different relatively homogeneous rocks, respectively, with one sample indicated by grey circles and the other by black circles in these plots, according to an example of the present application. In FIGS. 30A-30H, the plots are numbered in correspondence with the numbers given in the inset legends thereof. As with the previous figures, these FIGS. show plots for two different homogenous rock samples.

FIGS. 31A-31H illustrate the average ratio value (A) of the distribution of standard deviation for porosity (FIG. 31A), the surface to volume ratio (FIG. 31B), the variance (V) of the same distribution for porosity (FIG. 31C), the variance of the surface to volume ratio (FIG. 31D), the skewness for porosity (FIG. 31E), the variance of the skewness (FIG. 31F), the kurtosis for porosity (FIG. 31G), and the variance of the kurtosis (FIG. 31H), all versus sub-volume sample dimension (size) for two additional rocks, respectively, with one sample indicated by grey circles and the other by black circles in these plots, according to an example of the present application. In FIGS. 31A-31H, the plots are numbered in correspondence with the numbers given in the inset legends thereof and in FIGS. 311 and 31J. The rocks used as samples were sandstones (Fontainbleau).

FIGS. 31I-31J illustrate poro-perm trends for the two different rocks addressed in FIGS. 31A-31H according to an example of the present application. FIG. 31I includes poro-perm trends for the sample identified by grey circles in FIGS. 31A-31H for subsample dimensions of 190×190×190, 285×285×285, and 380×380×380, and which includes a poro-perm value for an original sample dimension size of 500×500×500 for a trend line D3 (solid grey line, hollow diamond symbol), and the black symbols are the optimal choices made by targeting both the function surface/volume and porosity. FIG. 31J includes poro-perm trends for the sample identified by black circles in FIGS. 31A-31H for subsample dimensions of 95×95×95, 190×190×190, and 285×285×285, and which includes a poro-perm value for an original sample size of 500×500×500 for a trend line D4 (solid grey line, hollow diamond symbol), and the black symbols are the optimal choices made by targeting both the function surface/volume and porosity.

FIGS. 32A-32B, 33A-33B, and 34A-34B illustrate the DISTRIBUTION OF standard deviation for the target functions of porosity (FIGS. 32A, 33A, 34A) and surface to volume ratio (FIGS. 32B, 33B, 34B) for a sandstone rock sample analyzed with original dimension of 550×550×550, wherein the distribution of standard deviation was obtained with a sub sample of 200×200×200, and wherein the resolution of segmentation was 10× for FIGS. 32A-32B, 20× for FIGS. 33A-33B, and 40× for FIGS. 34A-34B, respectively, according to an example of the present application.

FIGS. 35A-35B and 36A-36B illustrate the standard deviation for the target functions of porosity (FIG. 35A, 36A) and surface to volume ratio (FIG. 35B, 36B) for a sandstone rock sample analyzed with original dimension of 550×550×550, wherein the distribution of standard deviation was obtained with a sub sample of 200×200×200, and wherein the resolution of segmentation was 4× for FIGS. 35A-35B and 10× for FIGS. 36A-36B, respectively, according to an example of the present application.

FIG. 37 shows a system which integrates three-dimensional (3D) scan imaging analysis of a porous medium with a method applied to a 3D digital representation of the porous medium, according to an example of the present application.

### DETAILED DESCRIPTION OF THE PRESENT INVENTION

The present invention relates in part to an efficient method to estimate a representative elementary volume (REV) in a sample of porous media, such as rock, wherein the sub-volume selected is a better approximation of the elementary volume than provided by existing methods.

The present invention also relates in part to a method for characterizing a porous sample such as a reservoir rock by using a smaller subsample that has the same or very similar selected characteristics and variation of selected characteristics in the direction of expected fluid flow through the sample. If samples are too large, they can compromise the memory of the computer and excessive computer time may be required to complete calculations. Therefore, the present invention relates in part to a method of picking REV for subsampling that will be representative of the entire sample so computation time can be decreased and computer memory is not compromised. The REV has a sample size and a specific location within the original sample. The REV can be, for example, the physical size and location of the subsample within the original sample or the REV can be the digital size and location of the subsample within the representation of original sample. This method produces a subsample in the location within the sample that best matches the porous medium characteristics of interest such as porosity and absolute permeability of the larger sample.

The method of the present invention can be performed on a digital representation of a sample of a porous medium. The digital representation of the sample of the porous medium can be produced by first generating a computed tomography X-ray image of the sample and then segmenting the digital representation to identify each voxel as grain or pore. Then, the main flow direction of the sample can be selected by choosing the inlet face where pressure is applied for subsequent Core Analysis (RCAL) and Special Core Analysis (SCAL) measurements. Properties such as porosity, the surface over pore volume ratio (which also is labeled as surface/volume herein and is computed as the ratio of the length (2d) or area (3d) of the boundary between pore and solid space and the area (2d) or the volume (3d) of the pore space), other sample properties or combinations thereof are calculated for each slice of the subsample, orthogonal to the flow direction, so that a property that depends only on the flow direction coordinate is obtained for the subsample. For such a property function ƒ(z), the standard deviation (a number), with respect to the average value ƒ_{V} of the entire sample, can be computed by the equation:

$$σ = \frac{\sqrt{{\sum }_{i = 1}^{Nz} \frac{{( f ( {z}_{i} ) - {f}_{V} )}^{2}}{{N}_{Z}}}}{{f}_{V}} .$$

If σ in the preceding equation is a small number, the function ƒ of the sample deviates by a small quantity with respect to the same function evaluated in the large original domain (ƒ_{V}), so it is a good representation of that function along the main flow direction (since its variations are small in that direction). In the ideal case (i.e., for an infinitely large medium), the value for a goes to zero. Initial subsample dimensions are selected close to the size of the original sample. The standard deviation with respect to the average value ƒ_{V} of the entire sample is computed for a subsample location i. Note that in this procedure the “information” contained in the function ƒ is used exhaustively: for each subsample statistical information is extracted along the flow direction. In some prior patents, only a volume averaged was used for each subsample. The subsample is then moved inside the original sample in all possible locations x_i and the standard deviation is computed for each location. This gives a distribution T of the standard deviations S_i of the selected propriety described by ƒ. The frequency among all the subsamples defines the distribution of the occurrences. The variance of the distribution (its standard deviation) is defined as V, the average as A, and the mode as M in the descriptions hereinbelow.

The subsample dimensions are decreased, for example by one voxel or more on each side, or only in some direction, and the selected properties are calculated for all possible subsample locations. This process is repeated until all possible subsample sizes are evaluated or until a stopping criteria is met.

The REV is selected by using the mode M, or the average A and variance V of the distribution T of standard deviations. The mode or the average and the variance of T are good indicators of the larger sample's characteristics. If the mode of the distribution T is close to the standard deviation a of the larger sample's volume, and the variance of the distribution T is small, then a large number of subsamples have the same variation of the selected property as the original large volume (e.g., heterogeneity in the case that the selected property is porosity), so the length scale of the sub-volume is large enough to represent the entire original volume. In the case that the standard deviation of the selected property of the original large volume is small, and the variance V of the distribution is small as well two statements can be made: 1) the original size of the whole volume is large enough with respect to the variation (e.g., heterogeneity) in the flow direction described by the function ƒ. This scale is an integral scale with respect to the selected property for the original volume, and 2) the heterogeneity in the flow direction is small for the majority of the sub-volumes as well, so these samples are good candidates to represent the larger volume. If the selected proprieties are, for example, porosity and surface over volume, it is expected that the subsample matching the same variation as the original volume has an absolute permeability close to the one of the original volume. In the extreme case that the standard deviation of the selected property of the original volume is zero and that the variance of the distribution T is also zero, it means that the original large volume is formed by the replication of the subvolume in a periodic manner in the flow direction: in this case the subvolume represents the elementary volume of the specific quantity described by ƒ. The best location to subsample, the REV, is the location where the standard deviation of one, two or more selected properties match as closely as possible the standard deviation of the whole original sample. If the standard deviation of the selected property of the subsample is smaller than the one of the original sample, the subsample has less variation than the original sample, meaning it is missing some of the heterogeneities that the original sample has and it is artificially better. If the standard deviation is larger than the one of the original sample, the subsample has stronger heterogeneities than the original sample, and the subsample should be rejected. As a result, the method of the present invention can identify the most representative subsample of near elementary size and it can also determine if the heterogeneity of the original sample is too large to allow a representative subsample to be used because Darcy's law cannot be applied.

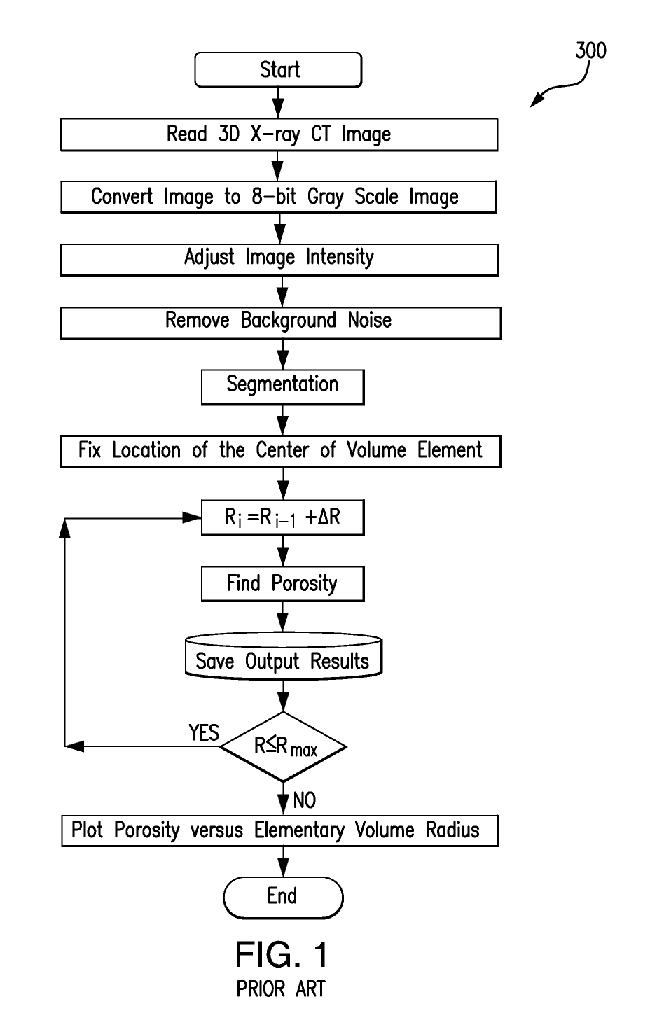

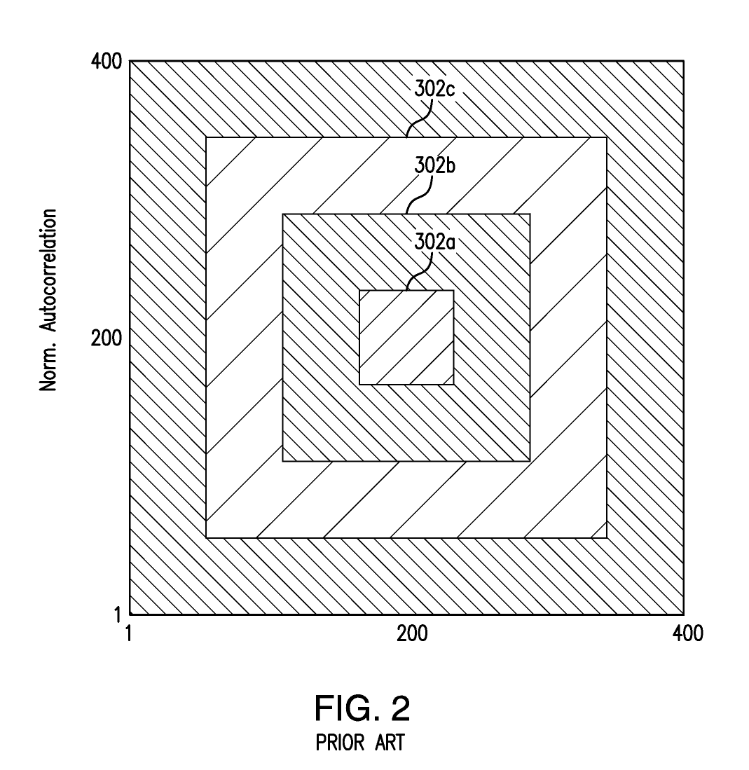

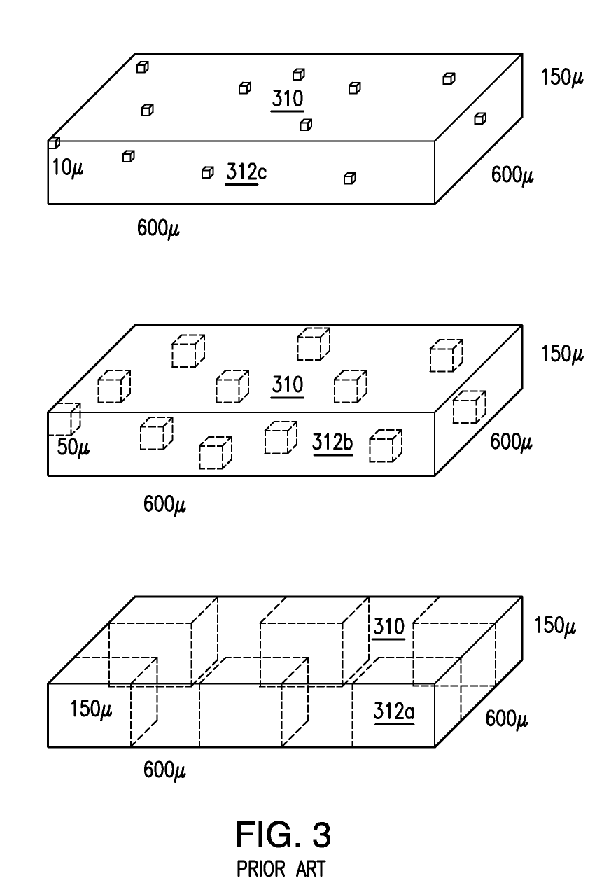

As discussed in the background above, FIGS. 1-3 illustrate prior efforts to identify REV's for application in representing porous materials such as rock samples in digital simulations and analysis. FIG. 1 illustrates flow diagram 300 for investigating concentric spherical subsample volumes of increasing diameters. FIG. 2 illustrates concentric squares 302a, 302b, and 302c, of increasing scope and converted to three dimensional cubes in an effort to select a suitable REV. FIG. 3 illustrates a modeled volume 310 with various uniformly sized sets of sub-volumes, here 312a, 312b and 312c, randomly (but not overlapping) disposed within volume 310. The subvolumes are shown having cubic or cuboid geometries. Volume 310 and subvolumes 312a, 312b, and 312c have the respective dimensions indicated in FIG. 3. For example, volume 310 has dimensions of 600×600×150 and subvolume 312a has dimensions of 150×150×150. Parameters such as porosity and/or permeability are selected and computed for each subsample and the variance or variability is calculated. Variance limits are chosen and suitability of a REV is determined by conformance to this limit, e.g., plus or minus (±) 5% to the average mean value.

Prior attempts have not produced an efficient method for approximating the smallest REV and have not well addressed the heterogeneous nature of natural rocks or other porous samples. Further, prior attempts have not provided guidance on the suitability of the REV to application of Darcy's law.

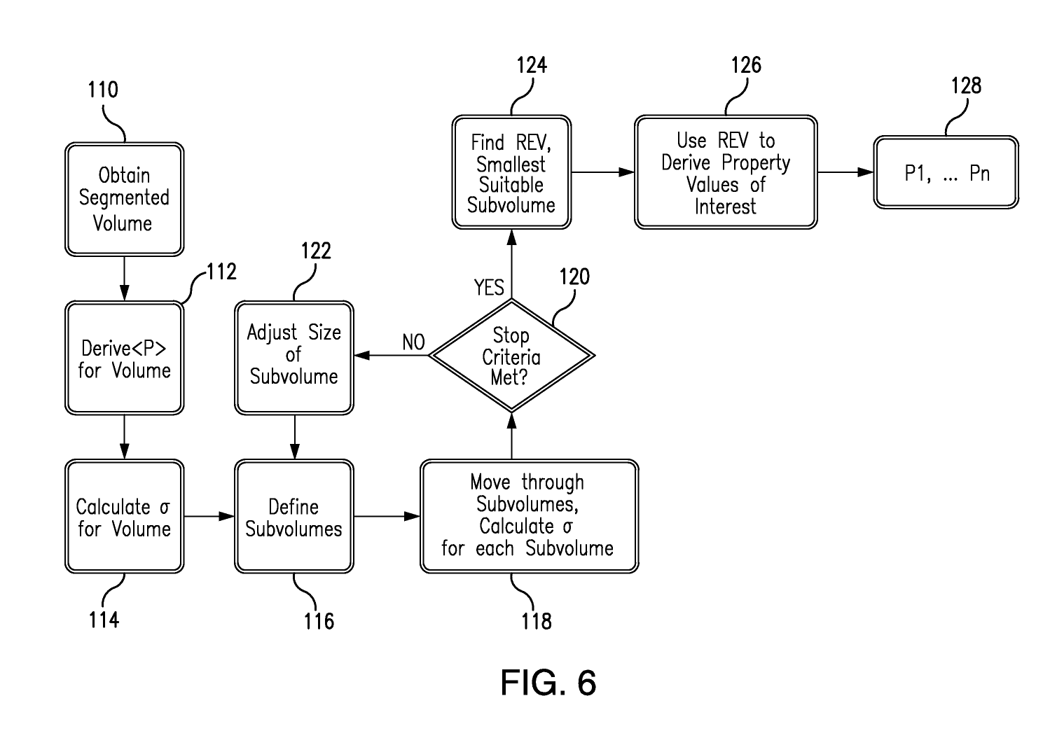

FIG. 6 is a flow diagram of a process of the present invention for better addressing an aspect of the heterogeneous nature of real world samples. A 3D digital image of the sample is obtained as a segmented volume 110 from which one or more property values “P” are derived and averaged across the whole of the volume to generate an average property value for the whole of the volume e.g., designated <Pᵥₒₗ> or <P> as indicated in the figure, such as shown in step 112. As will be discussed further herein below, porosity and surface area/volume are convenient target functions or properties to apply in qualifying REVs, although the invention is not limited thereto. The standard deviation σᵥₒₗ for the properties selected is also calculated for the whole of the volume at step 114 (“σ”). A set of subvolumes are defined at step 116, and at step 118 moved through the overall volume, with calculating of standard deviation σᵢ for each target function at each subvolume. The output of step 118 is compared against stop criteria 120, and if the stop criteria is not met, the size of the subvolumes is adjusted in step 122, and step 116 of defining subvolumes, step 118 of moving through the subvolumes and calculating the standard deviation σᵢ for each target function, and step 120 of comparing against the stop criteria are iteratively repeated until the stop criteria 120 is met. The stop criteria can be, e.g., a given size for the subvolume where adjusting the size of the subvolume comprises successively and progressively diminishing or enlarging the subvolume. A specific appropriate stopping criterion is described later herein within an illustration of a real application. When the stop criteria of 120 is met, the method proceeds to step 124 of finding the smallest suitable REV subvolume. Suitability is tested, e.g, by comparing the standard deviation of the subsample σᵢ against that of the overall volume σᵥₒₗ for agreement. The REV is stored and used in step 126 to derive property values of interest which are outputted in step 128. Practice of this aspect of the present invention provides for selection of a more representative REV, i.e., one that matches the heterogeneous nature of the overall sample volume as well as the average property values for one or more selection criteria properties.

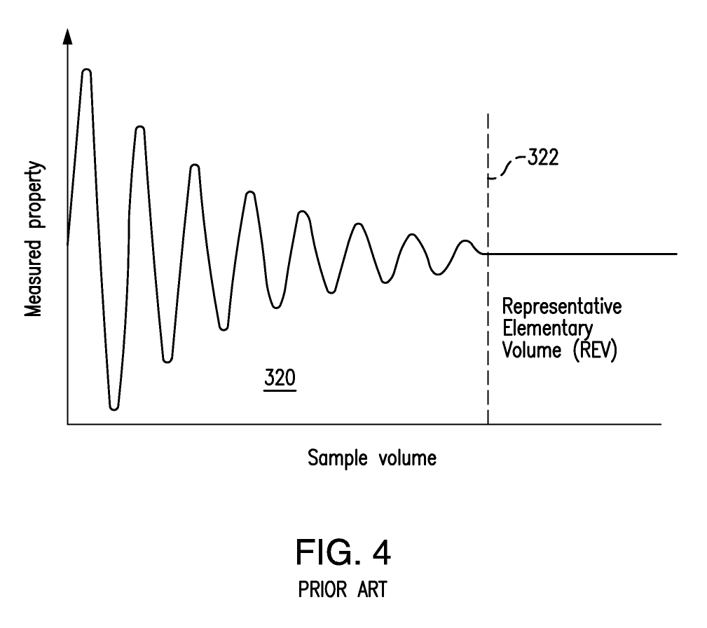

FIG. 4 is a graph schematically illustrating a prior general definition of representative elemental volume or REV. A measured property is plotted against the size of the sample volume. Fluctuations in the measured property tracked by curve 320 reduce with the size of the sample volume until reduced to a point at which the value for the property in the sub-sample can be taken as representative of whole of the volume. In this illustration, this is true for the region beyond sample volume size 322. The REV is the smallest sample sized for which this is observed.

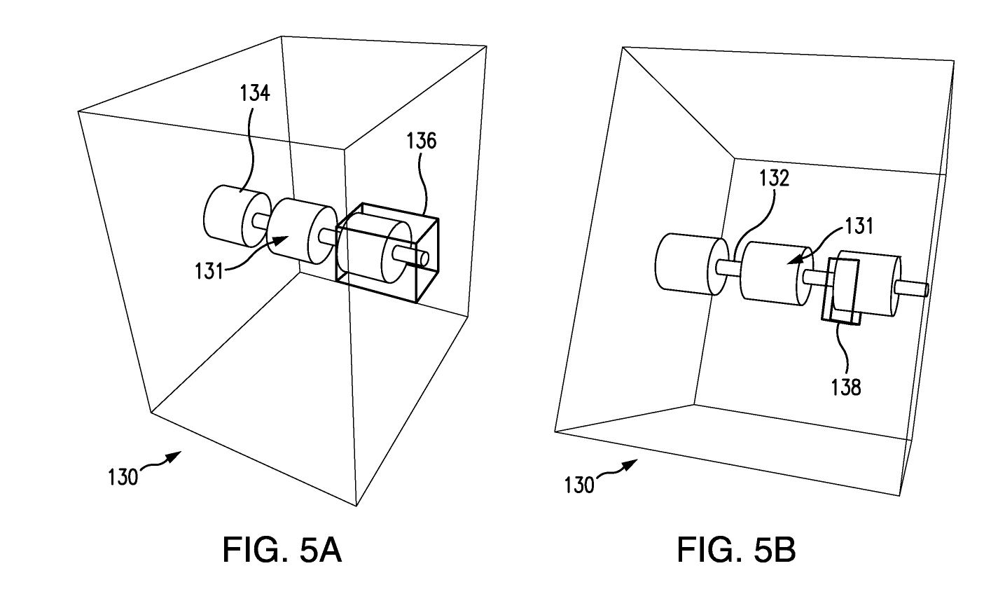

While the REV definition illustrated in FIG. 4 is a useful idealized model to start with, it best fits when the sample is homogeneous and isotropic. This is often not the case. Consider, e.g., the situation modeled in FIGS. 5A and 5B. In this example, a volume 130, which is outlined in the figures as a cubic volume, has a pipe 131 through it. The pipe is the porous space, and has a number of diameters, from large conduit 134 to restrictions of small conduit 132. An elementary cell containing a representative structure with respect to surface/volume (not with respect to porosity), in this case, is a segment of the pipe 131 that includes a transition from large conduit 134 to small conduit 132. The Surface/Volume of the whole sample of volume 130 has, in this case, the same value of the Surface/Volume of the elementary cell, subvolume 136. In fact, the whole volume is done with an integer number of replications of the elementary cell repeated in the direction of flow. If, as in FIG. 5A, the interrogation volume 136 used in the analysis of the REV is exactly the volume of the elementary cell, and the target function is the Surface/Volume, the optimal choice is provided. Thus, the standard deviation σᵢ for sub-volume 136 that exactly matches the standard deviation σᵥₒₗ of the surface/volume for the whole of volume 130 along the flow direction is the same as the volume of the elementary cell.

If the elementary volume is smaller than the elementary cell, see subvolume 138 in FIG. 5B, the final result will be a volume that crops a portion of pipe 131 so as to match the standard deviation of Surface/Volume of the whole volume as close as possible.

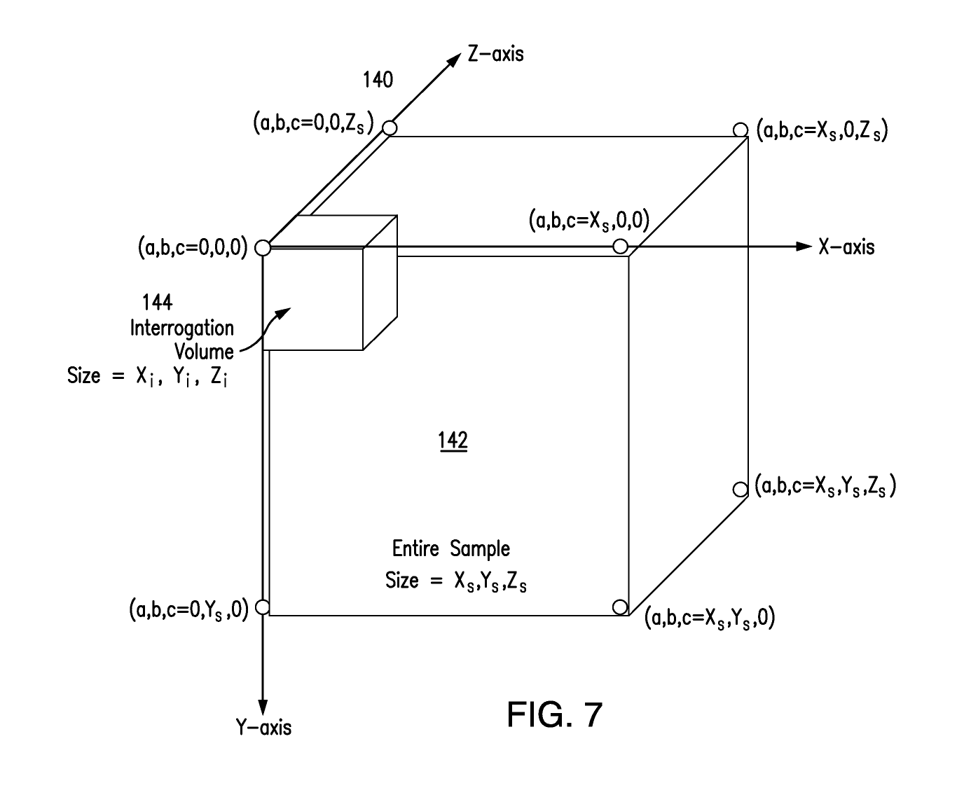

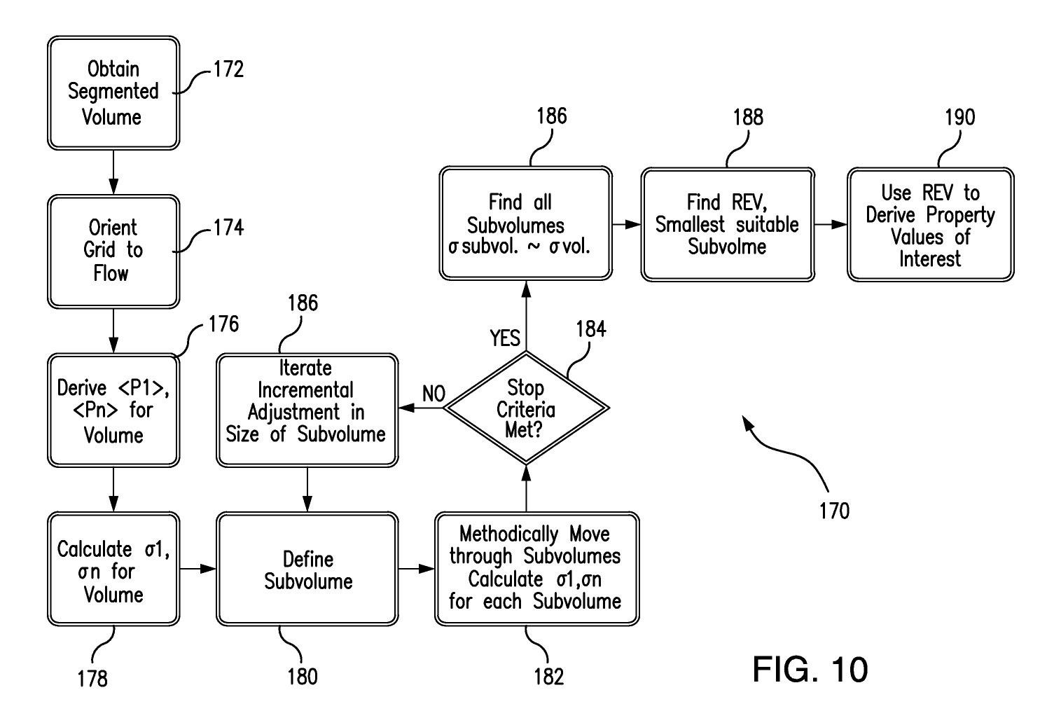

Efforts of the prior art to find a REV constrained to investigate either randomly or concentrically about a selected point are not well disposed to find or identify such an elementary cell. Thus, another feature in some practices of the present invention is a methodical subsampling that sequentially and incrementally moves through the entire sample volume with subvolumes of incrementally varying sizes. This aspect is introduced in the discussion of FIG. 10, below, and is facilitated by using a Cartesian grid 140 to set up sample volume 142 with coordinates a,b,c and sized to (Xₛ, Yₛ, Zₛ) and move an iteratively sized (Xᵢ, Yᵢ, Zᵢ) interrogation volume 144 therethrough, such as shown in FIG. 7.

Returning to FIG. 5B, at best, sub-volume 138 minimizes the difference between the standard deviation σᵢ of its own Surface/Volume with the standard deviation of the Surface/Volume of the whole volume σᵥₒₗ. Note that for this example it makes no sense to define a subvolume 138 that matches the standard deviation for porosity of the one for the whole sample. Another feature benefiting some practices of the present invention is the use of multiple target functions or properties to identify a much more robust REV useful in broad range of simulations and property derivations. For instance, constraints to satisfy both porosity and surface/volume with a match or an optimized combination will produce a more useful REV. This is addressed in the following further discussion herein of FIG. 10.

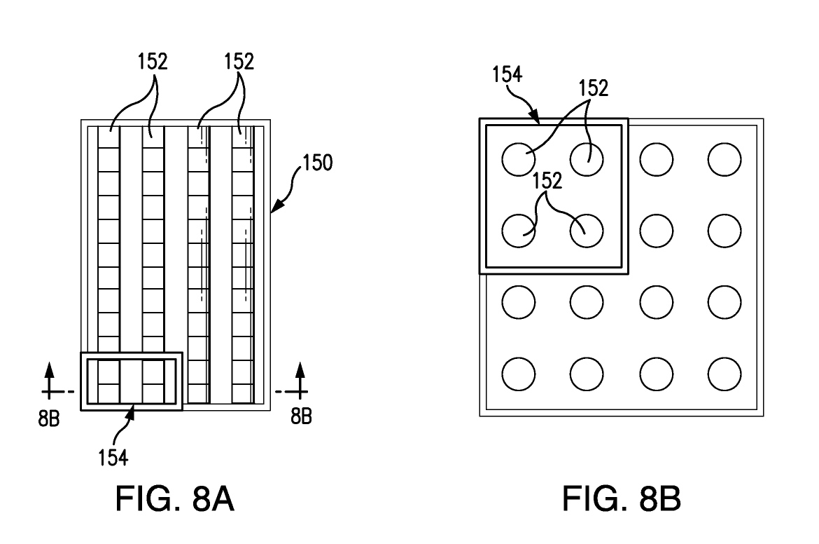

FIGS. 5A and 5B introduce another issue, the importance of flow direction and the definition of an REV with respect to a fixed flow direction. This is illustrated more particularly in FIGS. 8A and 8B. As shown in FIG. 8A, arrays of parallel conduits 152 traverse sample volume 150. FIG. 8B is a cross section of FIG. 8A taken at line 8B-8B in FIG. 8A. Subsample 154 is the identified REV having as target functions both standard deviation of porosity and surface/volume. It is not uncommon for important properties, including fluid transport properties, to be anisotropic in porous materials such as natural rock samples. That is, properties have directionality. Aligning the Cartesian grid to take this into account facilitates solving for the true REV. Returning to FIG. 7, aligning the direction of flow with, e.g., with the Z-axis, will facilitate the solution. Visual inspection of the segmented volume may be sufficient to align the grid by discerning a pattern among cracks or conduits providing pore space connectivity or it may be suggested by pore asymmetry. Alternatively, the anisotropic nature of properties can be determined by deriving preliminarily value estimates from the sample or subsamples. Also the flow direction can be fixed as a constraint with respect to the position of the core in the reservoir. The illustrated examples are with a fixed flow direction, but it will be understood that it may be useful to implement the invention for a combination of different flow directions.

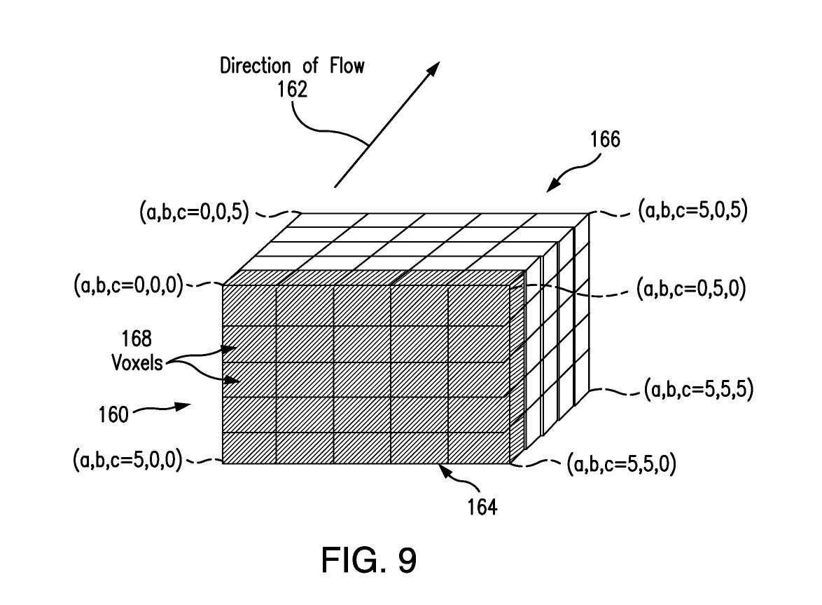

FIG. 9 illustrates the application of a Cartesian grid 160 aligned to the direction of flow (arrow 162) and advancing through digital slices 164 of interrogation volume 166 taken orthogonal to the direction of flow. Interrogation volume 166 and digital slice 164 are composed of individual voxels 168. Sequentially processing digital slices taken orthogonal to the direction of flow facilitates calculating not only the standard deviation for the interrogation volume σᵢ, but is also applicable for calculating the average value for target function(s) or property(ies) <P₁>, <Pₙ> and standard deviation(s) σ₁, σₙ for the whole of the sample, such as related to the discussion of steps 112 and 114 in FIG. 6.

Processing for REV selection in alignment with the flow direction is another feature benefiting some practices of the present invention adopted and illustrated in FIG. 10, below.

FIG. 10 presents flow diagram 170 functionally illustrating an embodiment of the present invention incorporating features introduced above and will be discussed with a further level of detail. The step of obtaining a segmented volume 172 begins with a 3D grey scale image of the natural rock sample or other porous material made by x-ray computed tomography, focused ion beam scanning electron microscope, magnetic resonance imaging, synchrotron imaging, or other microtomography or microradiology processes or the like. Examples of suitable CT scanners for making images usable with methods according to the present invention include, for example, 3D tomographic x-ray transmission microscopes, such as MicroXCT-200 and Ultra XRM-L200 CT, which are made by Xradia, Inc. (Pleasanton, Calif. USA). The grey scale image can, for example, be filtered or otherwise preprocessed prior to segmentation into multiple phases representing pore spaces and one or more solid phases such as grains and possibly one or more matrix phase. And the initial segmentation can, for example, have post-processing steps to present a better representation of the material sample originally imaged.

However, as discussed above, many of the simulations and derivations through which the properties and behavior of the sample can best be understood are computationally and memory extensive and not efficient nor feasible to conduct for the whole of the sample. So estimating the smallest REV is of great utility.

As shown in FIG. 10, the segmented volume obtained at 172 is oriented on a Cartesian grid aligned to the direction of flow, step 174. It is convenient to align the Z-axis with the direction of flow evident from a visual inspection of the pore space connectivity in the segmented volume representing the sample.

Successive vertical slices taken orthogonal to the direction of flow can be used to develop the averages <Pᵢ>, <Pₙ> in step 176 and standard deviations σ₁, σₙ in step 178 for multiple target functions or properties, Pᵢ through Pₙ. The discussion of FIG. 9 above is referenced in this respect. Preferably, the target functions are not computationally challenging and are also selected to provide for a diversity of inputs leading to a robust REV estimation useful for a wide range of simulations and property derivations among more computationally and memory challenging applications. Porosity (φ) and the ratio of surface to volume of the pore space are good candidates. As used herein, porosity (φ) is simply calculated as the number of voxels allocated to pore space in the digital slice divided by the total number of voxels in the slice, and it provides a basic target function. Calculating the surface area of the interface between pore space and solid and matrix phase(s) and dividing this by the total area in the pore spaces in the digital slice provides a second useful digital function. For many applications, these two properties meet well the desired criteria for suitable target functions, though it should be understood to those having the benefit of this disclosure and ordinary skill in the art that other properties may be substituted and/or added. For each property, the values for digital slices are averaged to establish a function of the target property that only depends on the flow direction, and to evaluate values for the overall sample volume. Another option, it is to apply a filter to the target function in a way to modify it in a specific location along the fixed flow direction. For example, a larger porosity than the one of the original rock could be desired by the subsample at the inlet or outlet.

A size for subsamples or subvolumes is defined at step 180. Subvolumes of the size defined are then propagated throughout the volume, completing the step of defining the subvolume. These could start at very small size and increase step by step, with reference made to the basic definition of REV illustrated in FIG. 4 or, they could start at a large size and work toward smaller subsamples. Having defined a continuous grid of subvolumes, step 182 methodically moves through the subsamples and calculates and stores the standard deviation σ_{I}, σₙ for each of the selected target functions. Step 184 polls whether the stop criteria is met and determines whether to qualify and select the REV from available subsamples or to instead increase the pool of candidates. Stop criteria may be as simple as reaching a preselected size, or may, e.g., be based on an analysis of one or more of the variance (V) and average (A) calculated for the last set of subsamples in relationship with the previous set of subsamples. If the stop criteria is not met, the pool of subsample candidates is increased by proceeding with an iterative do-loop and incrementally adjusting the size of the subvolumes in step 186 before returning to step 180 and defining a continuous grid of the subvolumes so sized throughout the sample. Standard deviations are again calculated and stored and the stop criteria 184 is again polled. When the stop criteria is met, REV selection proceeds by first identifying all subvolumes for which the standard deviation(s) of the subvolume satisfactorily match that of the sample volume, such as indicated in step 186. In the case of multiple target functions, e.g., porosity and surface to volume ratio of the pore space, it may be that no sample provides a suitable match. In this case, it may be desired to combine the two functions and apply a minimization procedure to select the subsamples that match all functions as closely as possible. The smallest subsample from this pool of matching subsamples is located per step 188 and used for simulations or to derive property values of interest, e.g., those requiring greater memory and/or computational demands, in step 190.

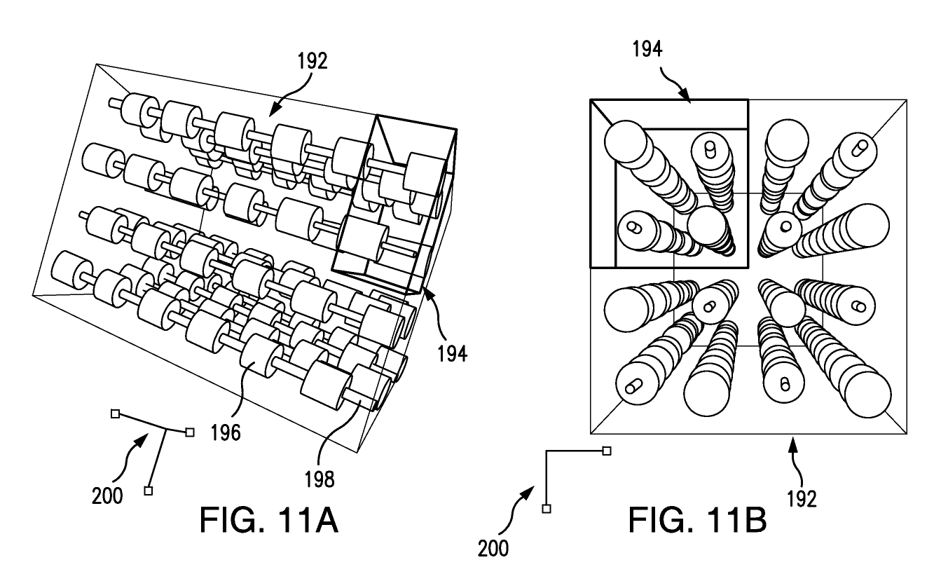

FIGS. 11A and 11B illustrate a more complex fluid flow model for sample volume 192. Here, the volume to analyze is made by the periodic replication in all the directions of an elementary cell 194. Reference is made to FIGS. 5A and 5B. The elementary cell is made by a transition large 196 to small 198 that is staggered in the transverse direction of the flow. Here, Cartesian grid 200 is realigned to orient with the direction of flow and each X-Y plane within the elementary cell orthogonal to the flow direction has the same value of porosity and surface volume ratio of pore space, so the standard deviation of these quantities in the flow direction is zero (no variation). The whole sample has same value of porosity and surface/volume of the elementary cell because it is formed by an integer number of replication of the elementary cell.

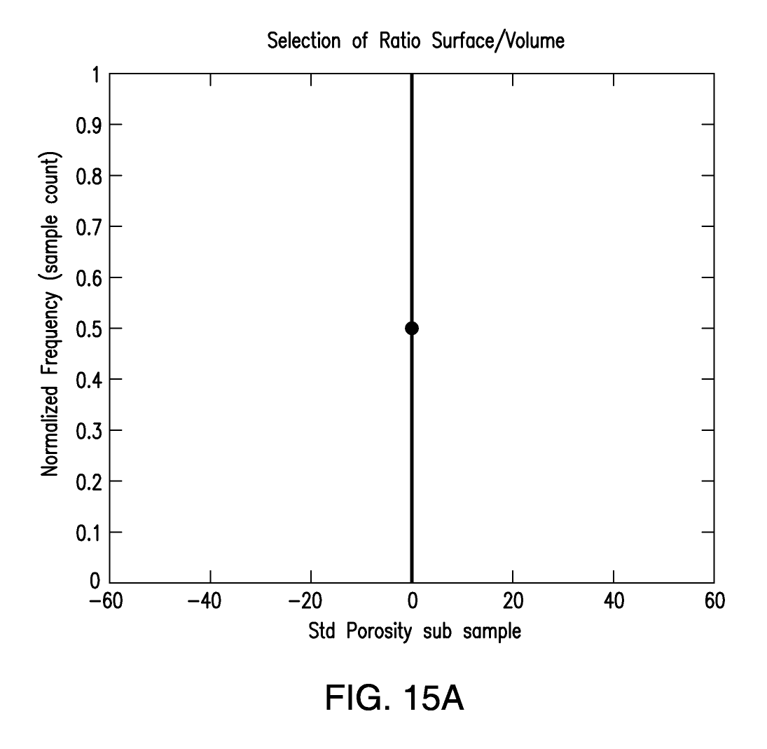

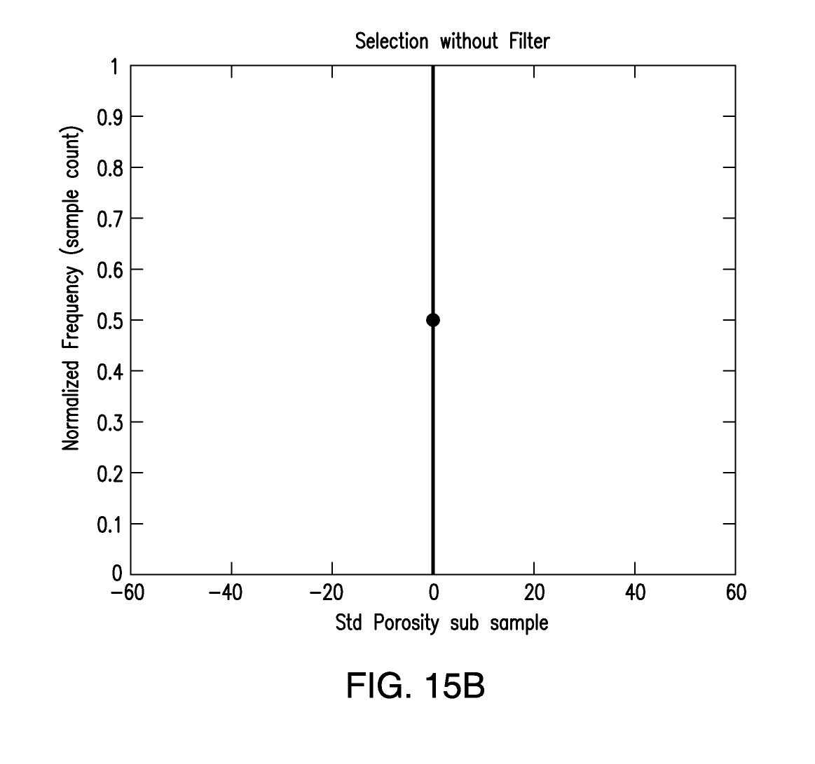

As in the example of FIGS. 5A and 5B, if the interrogation volume has the same dimension of the elementary cell, because of the periodicity all the possible volume of that dimension within the whole sample will have the same value of porosity and surface/volume with zero standard deviation. In this case modeled in FIGS. 11A and 11B (actually different views of the same system illustrated with FIGS. 8A and 8B, discussed above), a distribution of the standard deviation of surface/volume or porosity will be zero with a variance that is also zero. See FIGS. 15A and 15B, for example, illustrating the same standard deviation curves for both porosity and surface to volume ratio of pore space respectively.

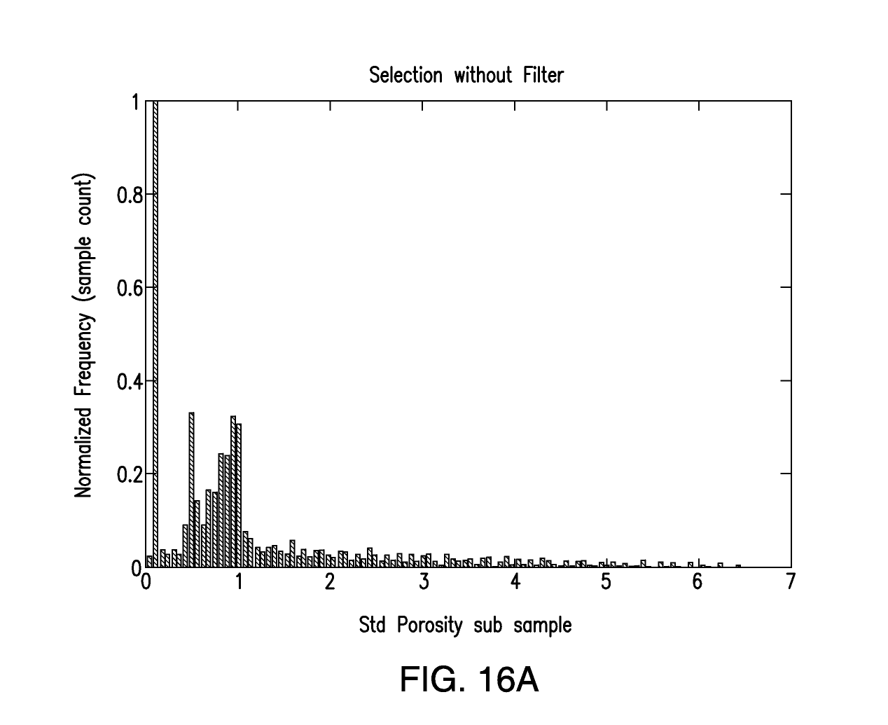

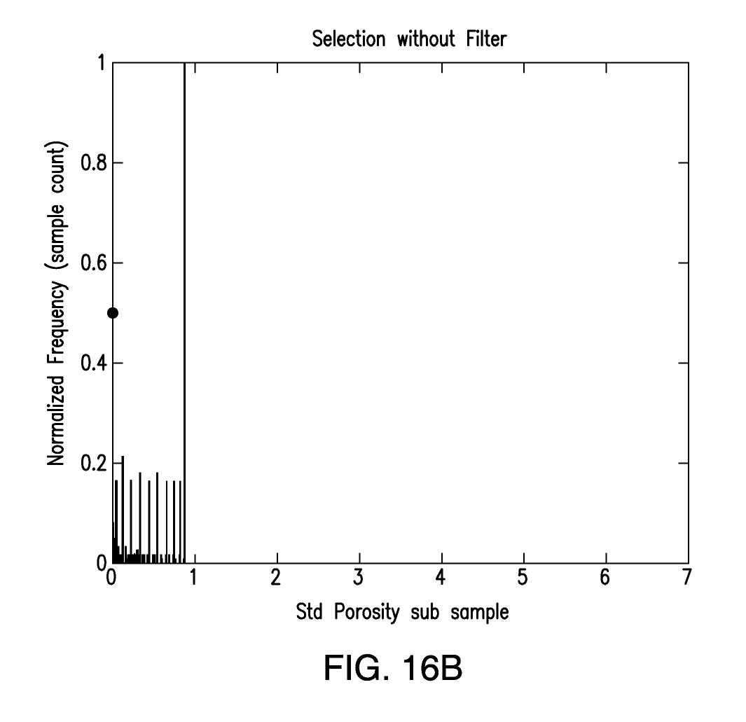

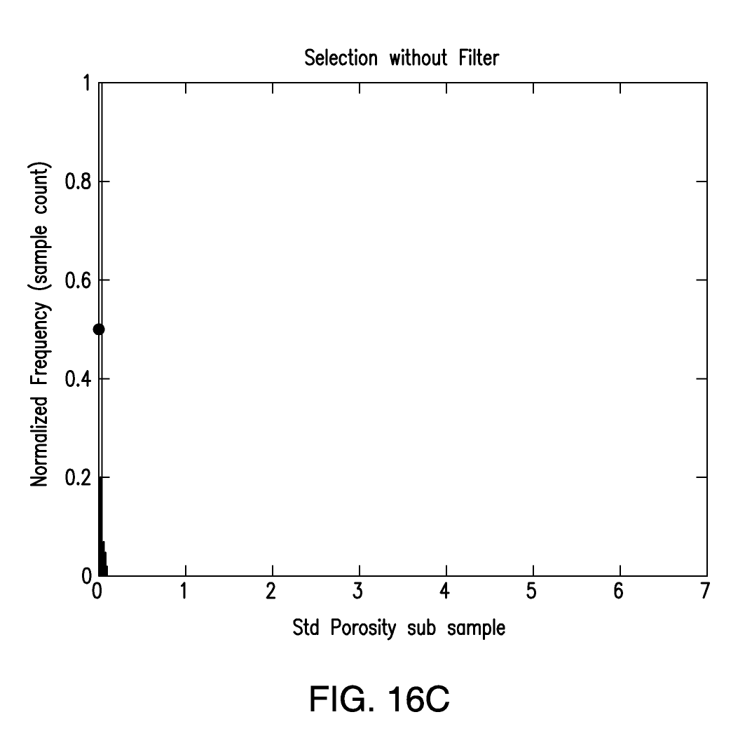

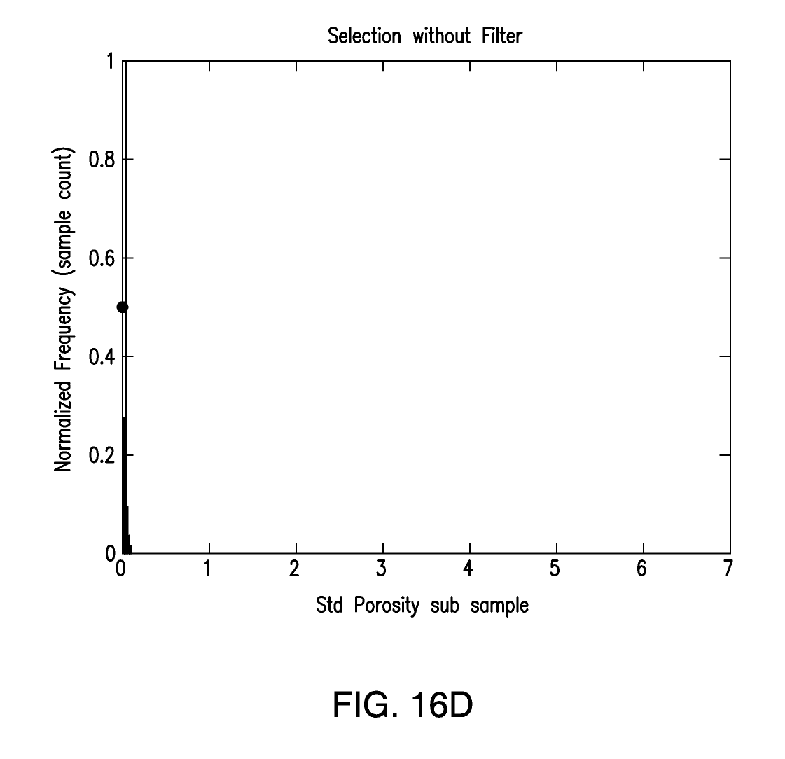

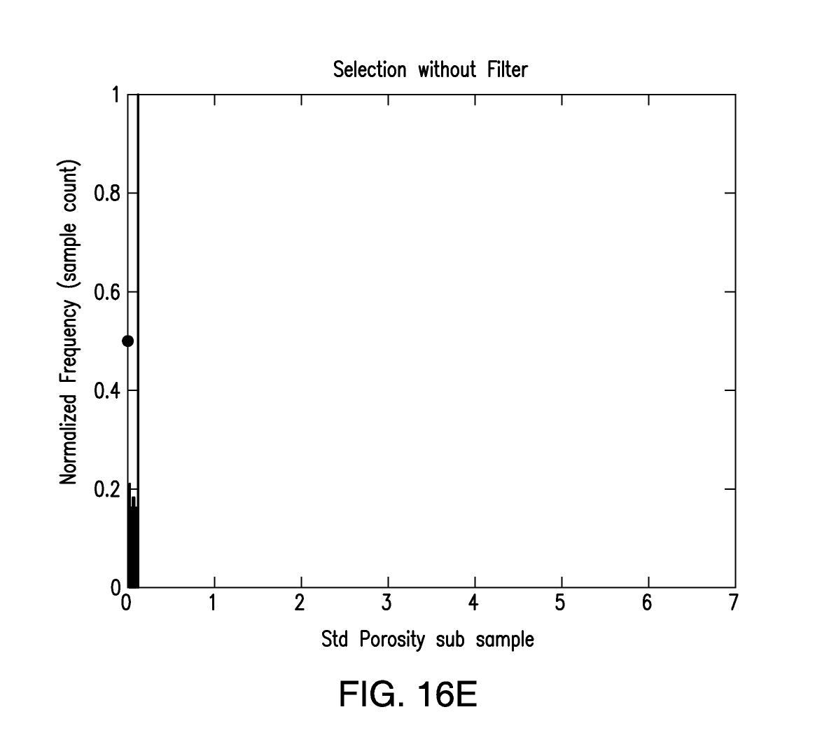

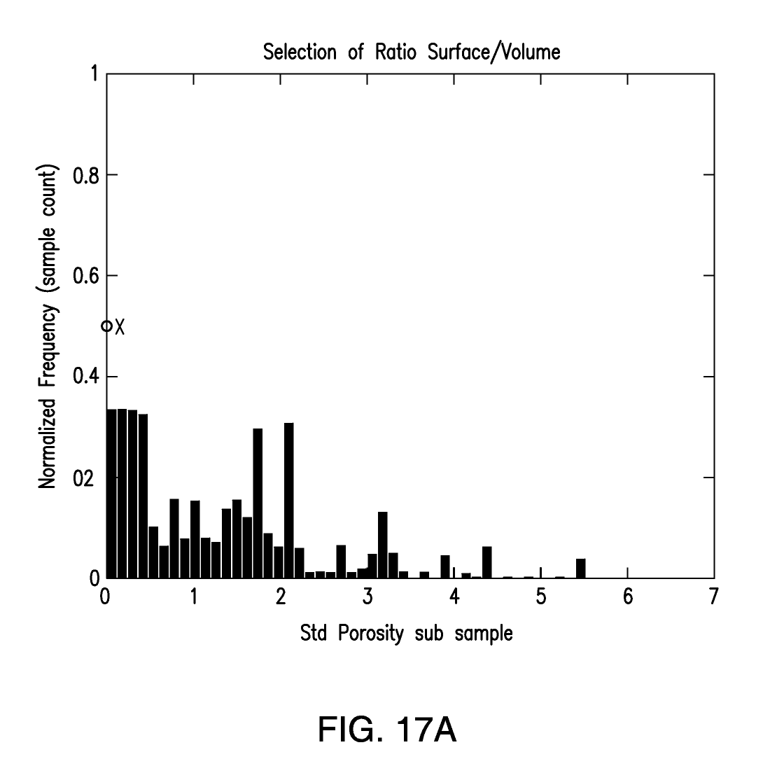

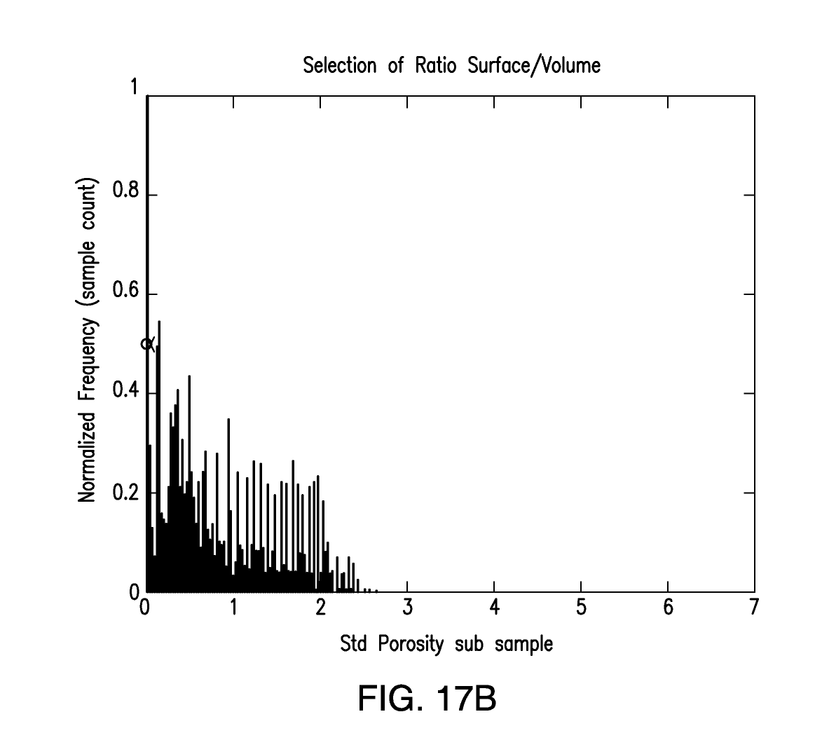

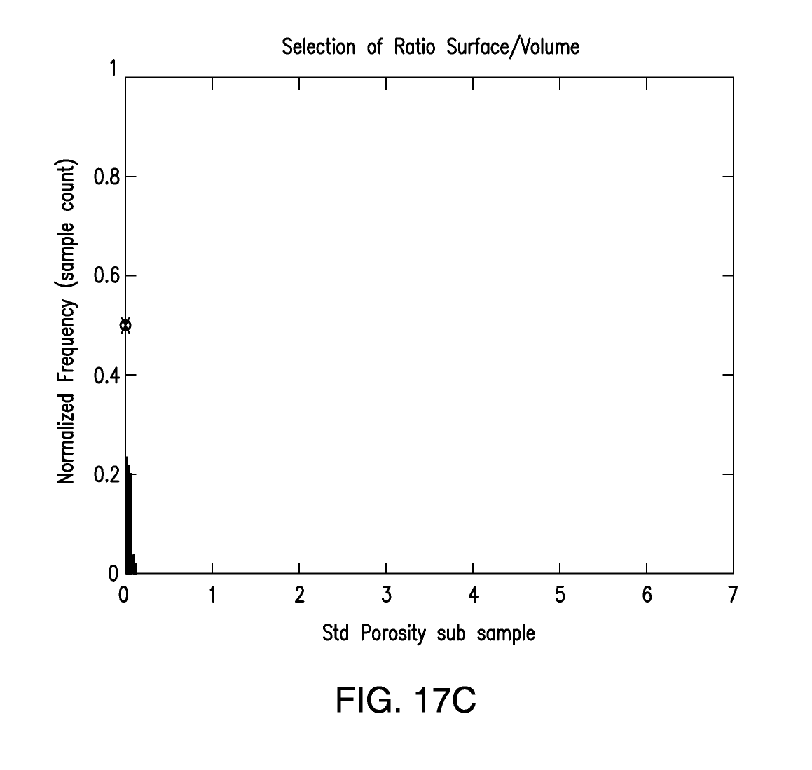

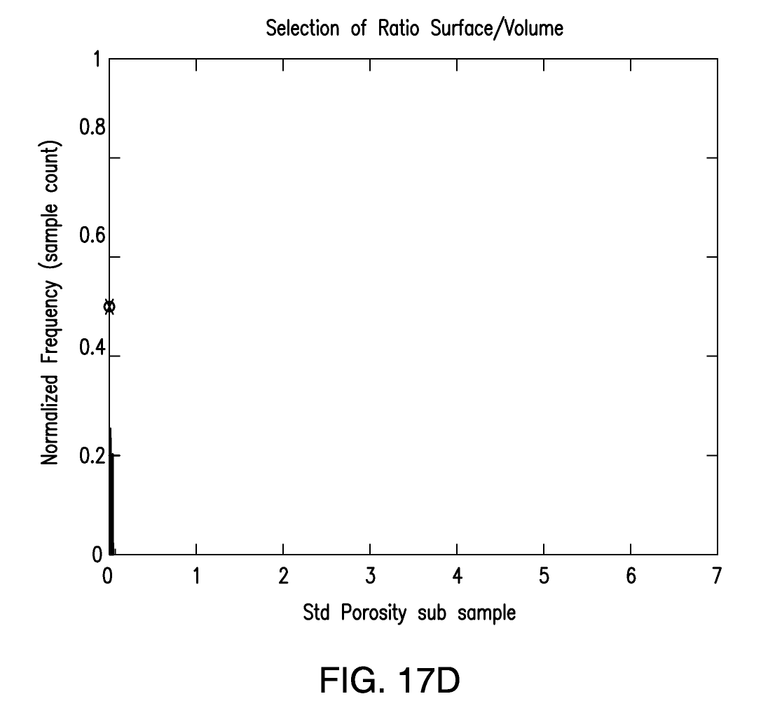

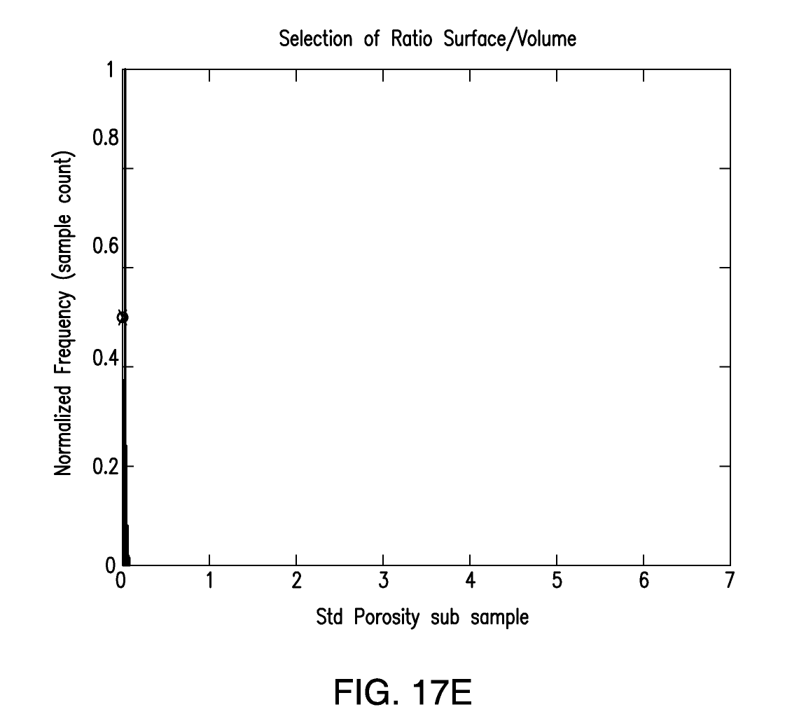

When the dimension of the interrogation volume starts to change with respect to the elementary cell, the distribution of standard deviation shows that that specific dimension is not periodic anymore within the entire region: the distribution with larger variance is the one where the interrogation volume is smaller than the elementary cell. In this case, a large variation is expected because in the flow direction the variation of porosity or surface/volume will be larger. FIGS. 16A-16E illustrate the distribution of the standard deviation of porosity for different interrogation volume sizes. The elementary cell illustrated in FIG. 11B has dimension of 80×80×40. FIG. 16A addresses an interrogation volume of 20×20×10. FIG. 16B addresses a 40×40×20 interrogation volume and FIGS. 16C-E address interrogation sizes 79×79×39, 81×81×41, and 120×120×60, respectively. FIGS. 17A-E address the distribution of surface/volume for sizes of the interrogation volume corresponding to FIGS. 16A-16E, respectively.

From the above examples, should be clear that when the mode of the distribution is close to zero and its variance is also small, the interrogation volume is a quasi-periodic structure within the whole sample, respect the specific target function (either porosity or Surface/Volume)

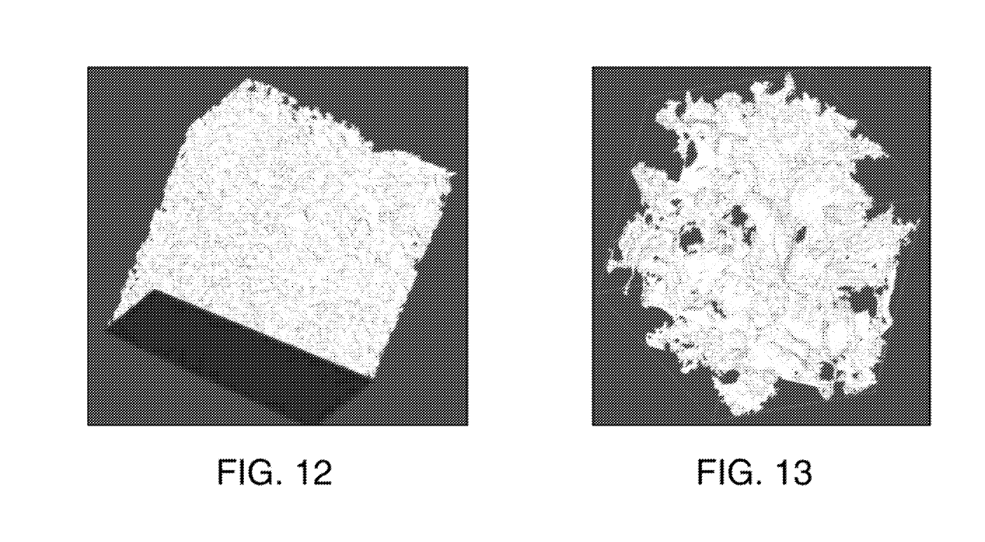

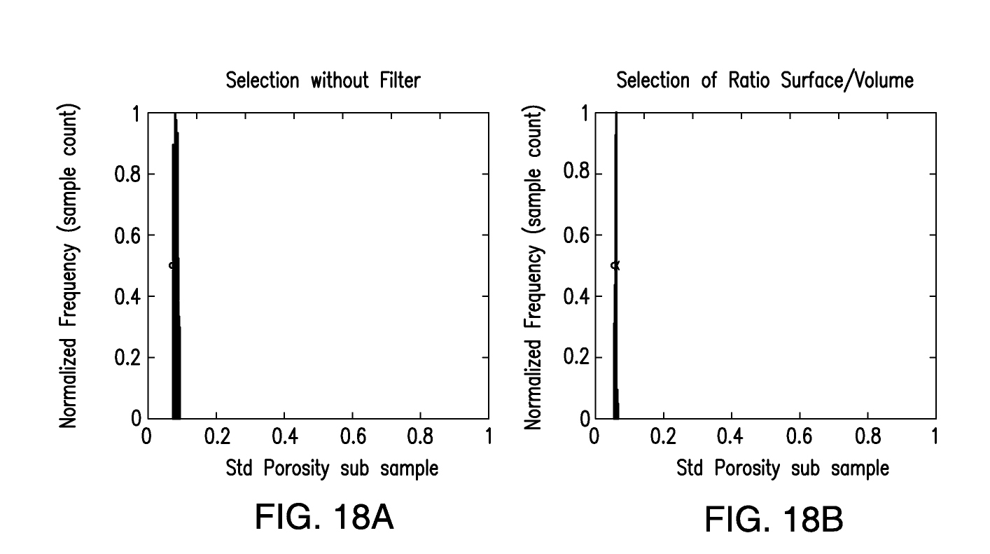

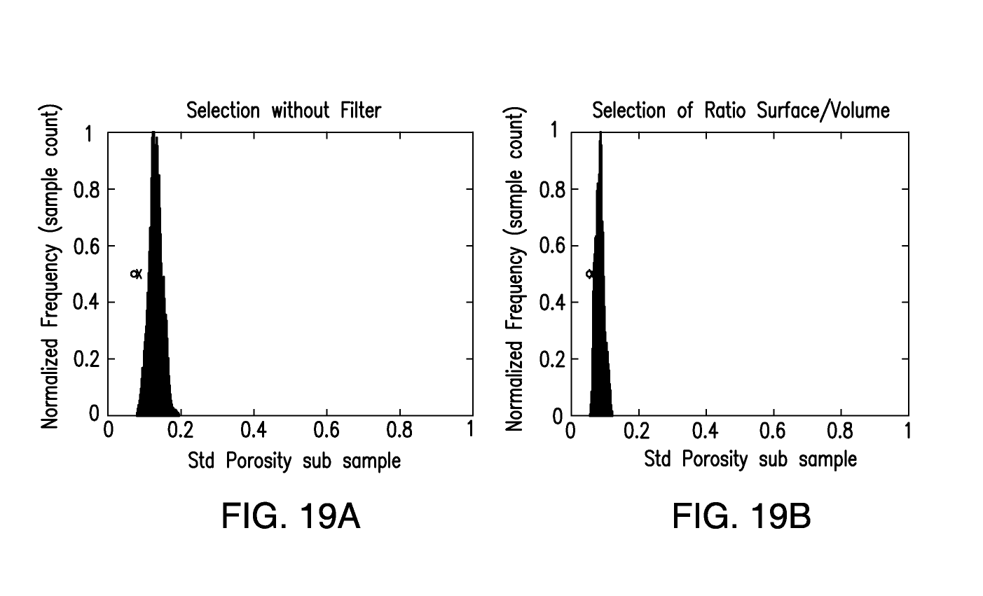

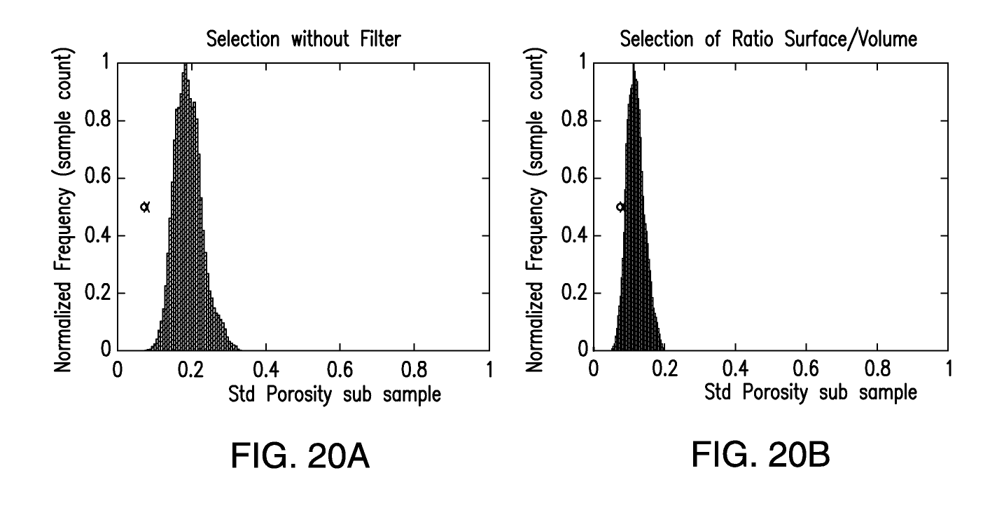

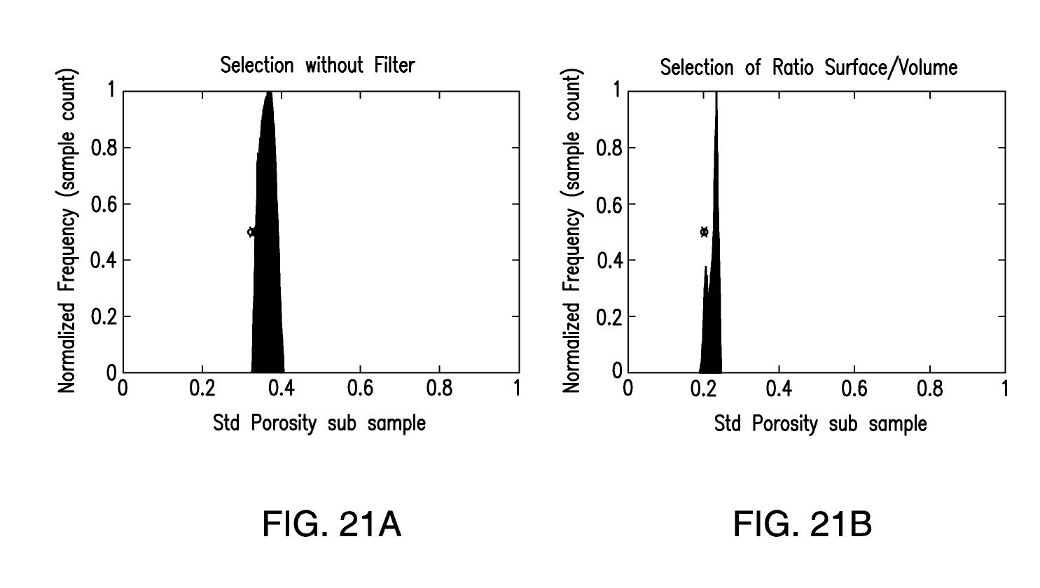

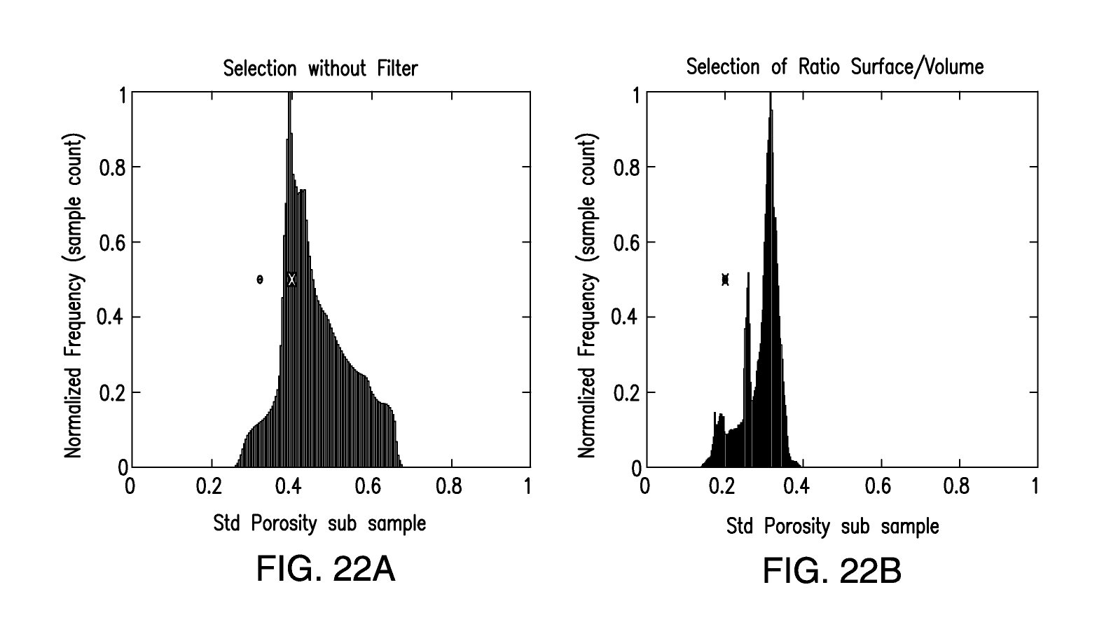

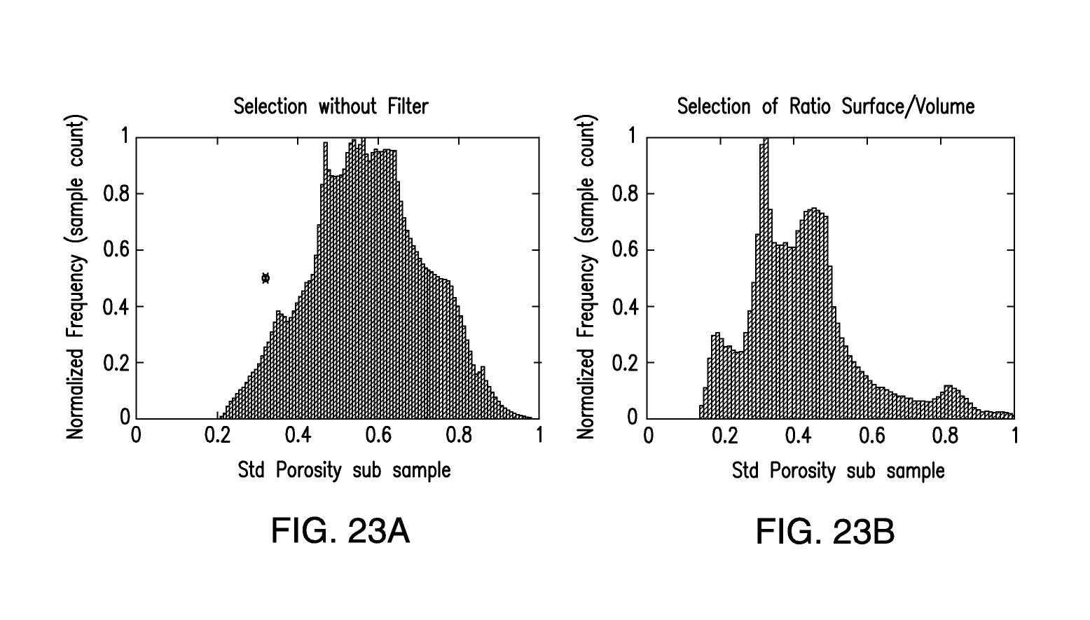

It is further useful to apply the same analysis to a real rock, see FIGS. 12 and 13. In FIG. 12, the sample present very small heterogeneities in contrast to FIG. 13 which illustrates a sample with larger heterogeneities. The sample dimension for both rocks is 500×500×500. For each of these rocks, three distributions are derived for two different target functions, porosity and surface/volume ratio of pore space, based on interrogation volumes of varying size. The distributions for the less heterogeneous rock, see FIG. 12, are set out in FIGS. 18A-18B, 19A-19B and 20A-20B, representing target function pairs for volumes sized 450×450×450, 300×300×300 and 200×200×200, respectively. In the graphs of FIGS. 18A-18B, 19A-19B and 20A-20B presenting the target function pairs, porosity is shown in FIGS. 18A, 19A, and 20A and surface/volume ratio of pore space is show in FIGS. 18B, 19B, and 20B. The same size samples and presentation is applied for the more heterogeneous rock illustrated in FIG. 12 in FIGS. 21A-21B, 22A-22B, and 23A and 23B. Each graph presents the standard deviation of the specific property of the whole sample <Pᵥₒₗ> as a point and the standard deviation distribution σᵢ of the interrogation subsample.

Accordingly, it is clear that as the dimension of the subvolume decreases, the variance of the distribution increases and its mode starts to move in a range of larger value. This means that the variations of the target function within a sub sample of smaller dimension along the flow direction are expected, statistically, larger than the original volume. In both the rocks, the distribution has a mode very close with respect to the value of the standard deviation of the original rock if either the dimension of the sub rock is very close to the dimension of the original rock, or the heterogeneities of the target function in the flow direction are small for the selected dimension of the sub rock. This latter case is for the less heterogeneous rock (e.g., FIG. 12). In the case of rock in FIG. 13, it can be seen that the distribution has a very large variance and the mode is very far from the value of the original whole rock already for size of 300×300×300.

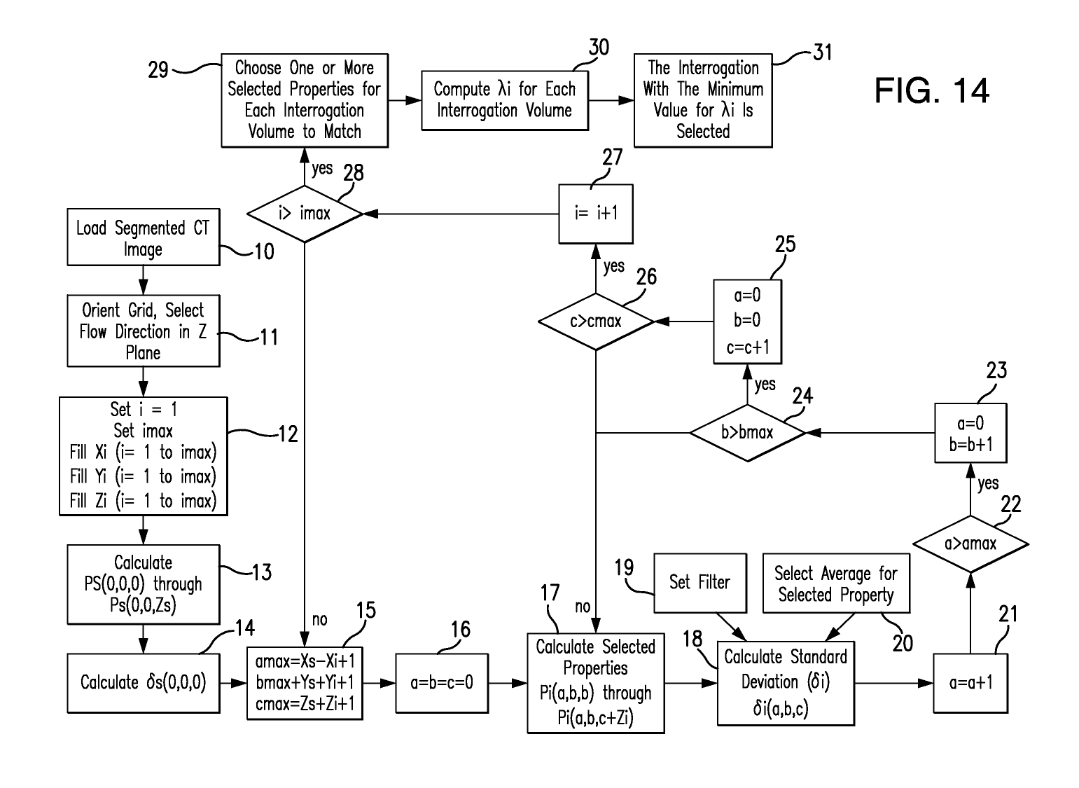

FIG. 14 is a flow diagram illustrating an embodiment of the present invention. The following definitions are used with respect to this detailed description of this embodiment of the invention.
1) Flow direction is perpendicular to the X-Y plane
2) Xs=width of sample in voxels
3) Ys=height of sample in voxels
4) Zs=depth of sample in voxels
5) Selected properties can be Φ, Sv, ect
6) i=pointer to the ith interrogation volume
7) imax=number of interrogation volumes
8) Xi=width of interrogation volume i in voxels
9) Yi=height of interrogation volume i in voxels
10) Zi=depth of interrogation volume i in voxels
11) Xmin, Ymin, Zmin=minimum dimension of interrogation volume
12) Xmax, Ymax, Zmax=maximum dimension of interrogation volume
13) a, b, c=coordinates of the interrogation volume. The coordinates a, b, c are the X, Y, and Z coordinates respectively of the top left corner of the interrogation volume as depicted in FIG. 6.
14) Ps(a,b,c)=selected property of the slice of the entire sample at location a,b,c
15) σs=standard deviation of the set of selected properties Ps(a,b,c) through Ps(a,b,c+Zi)
16) Pi(a,b,c)=selected property of the slice of the interrogation volume i at location a,b,c
17) σi=standard deviation of the set of selected properties Pi(a,b,c) through Pi(a,b,c+Zi) with respect to the entire sample.

$$18 ) λ i = \frac{\vert ( σ j ) - ( σ s ) \vert}{\vert ( μ s - σ s ) \vert}$$

where μ=the average of all σj's, that is the average of the distribution (A); σs is either the standard deviation of the whole sample or it is the minimum value of the distribution in the case that this minimum is larger than the value of the original sample. The index i of λ is for a specific target function, for example porosity. If multiple target function are present, a superposition (or combination) of λican be considered where I is the index of the target function.

This illustrative example of the present invention can use many of the features discussed above in combination, such as comprising the following steps, wherein the numbers placed in the parentheses are references to related process flow chart boxes identified in FIG. 14:

1) A segmented three dimensional image of a porous medium such as a reservoir rock can be loaded into a computer system for processing images and computing rock properties (10).
i. The segmented three-dimensional image can be segmented in using any segmentation technique which is used by those skilled in the art. One or more of the segmentation techniques mentioned in U.S. Pat. Nos. 8,170,799; 8,155,377; 8,085,974; 8,081,802, and 8,081,796 can be used here, and these patents are incorporated in their entirety by reference herein. The segmented three-dimensional images can comprise voxels each of which can be assigned a grey scale value, wherein each value represents the relative density of the voxel.
ii. The segmented three-dimensional image may be produced by a raw image from a computed tomographic x-ray scanner and which is then segmented by an appropriate software program to classify voxels as grain, pore or other.

2) The segmented three-dimensional image will later be used in a simulation to estimate the flow of fluids through the porous medium. A flow direction is selected and this is defined as the Z direction (11).

3) Sizes of interrogation volumes are defined. Details of this nomenclature are shown in FIG. 6.
i. An interrogation volume is a subsample of the original segmented three-dimensional image with dimensions Xi, Yi and Zi. The dimensions of the entire sample are Xs, Ys, Zs(12).
ii. A maximum number of interrogation volumes, imax, is defined.
iii. Dimensions in voxels for each interrogation volume (Xi, Yi, Zi) are set. Xi, Yi and Zi are defined for values of i from 1 to imax(12).
iv. The initial value of i is set to 1(12).

4) Calculate selected properties Ps(0,0,0) through Ps(0,0,Zs) for each slice of the interrogation volume(13). In FIG. 7, the shaded area represents a slice of a 5×5×5 interrogation volume. The coordinates of the corners of the slice are (0,0,0), (0,5,0), (5,5,0) and (5,0,0). There are 5 slices in this example moving from Z=0 through Z=5. The coordinates of corners the last slice are (0,0,5), (0,5,0), (5,0,5) and (5,5,5).

5) Calculate σs(0,0,0)(14).

6) Set the maximum coordinates that the interrogation volume of size Xi, Yi, Zi can occupy within the entire sample of size Xs, Ys, Zs(15).
i. amax=Xs−Xi+1
ii. bmax=Ys−Yi+1
iii. cmax=Zs−Zi+1

7) Set location coordinates of the current interrogation volume to a=b=c=0(16).

8) Calculate selected properties Pi(a,b,c) through Pi(a,b,c+Zi) for slices of the current interrogation volume(17).
i. Selected properties comprise porosity, surface area to volume ratio, similar properties, or any combination thereof.

9) Calculate σi(a,b,c)(18).
i. Optionally averaged values of Ps that are used to calculate the value of σi may be filtered(19).
ii. Optionally an average value for Pi may be set(20).

10) Move the location of the interrogation volume by 1 voxel in the X direction, a=a+1 (21).

11) Repeat steps 8) through 10) of this method storing all values of Pi and σi until the value of the X coordinate of the current interrogation volume, a, has equaled the maximum value that the current interrogation volume can occupy, amax(22).

12) The X coordinate of the current interrogation volume is set to zero, a=0, and the Y coordinate of the current location volume is incremented by one voxel, b=b+1(23).

13) Repeat steps 8) through 12) of this method storing all values of Pi and σi until the value of the Y coordinate of the current interrogation volume, b, has equaled the maximum value that the current interrogation volume can occupy, bmax(24).

14) The X coordinate of the current interrogation volume is set to zero, a=0, the Y coordinate of the current interrogation volume is set to zero, b=0, and the Z coordinate of the current location volume is incremented by one voxel, c=c+1(25).

15) Repeat steps 8) through 14) of this method storing all values of Pi and σi until the value of the Z coordinate of the current interrogation volume, c, has equaled the maximum value that the current interrogation volume can occupy, cmax(26).

16) Increase (or decrease) the size of the current interrogation volume(27).
i. Select the next set of interrogation volumes by increasing the pointer to the next interrogation volume, i=i+1.
ii. The current interrogation size is set to Xi, Yi, Zi.

17) Repeat steps 6) through 16) until all of the interrogation volumes have been selected and all values of Pi and σi have been calculated and stored (28).

18) Choose one or more selected properties to match(29).

19) Calculate λi for each interrogation volume(30).

20) Select the interrogation volume with the smallest value of λi. This is the size and location of the REV (31).

21) Compute desired properties of the porous medium.
i. Desired properties can comprise routine Core Analysis (RCAL) and Special Core Analysis (SCAL). RCAL analysis includes but is not limited to porosity (connected, isolated, total), kerogen content, absolute permeability in multiple axes (x,y,z). SCAL analysis includes but is not limited to relative permeability (two-phase relative permeability: water-oil, gas-oil, or water-gas displacement), capillary pressure (capillary pressure values at each saturation for primary drainage, imbibitions and secondary drainage cycles), grain size distribution, electrical properties (formation factor, resistivity index, a, m, n), elastic properties (Vp.Vs, E, K, G, Poisson's ratio), and similar analyses.

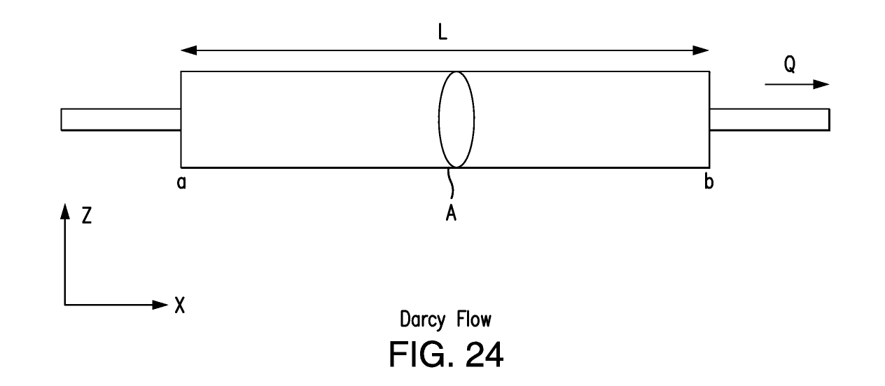

Referring to FIG. 24, another feature of the present invention is an analysis of the suitability of the REV for application of Darcy's Law. As noted above, Darcy's Law as it is often applied to flow through porous media such as rock samples is shown in Equation 1. Permeability is often obtained by applying Darcy Law through Navier Stokes equations (equation for the momentum) employing Gary's decomposition (see Equation 2). However, as discussed above, this method relies upon an averaged quantity (in this case pressure) that is supposed to be “well behaved” over the averaging integral scale. Unfortunately, a pressure signal that rapidly changes over a length scale comparable to the averaging length scale cannot represent the pressure over that length for these applications to provide dependable results. When an REV is selected in accordance with the foregoing, there remains a possibility that variations of porosity within the subsample can exist making assumptions about Darcy Flow invalid or prone to error. Moreover the pressure gradient can rapidly change along the flow direction making it impossible to define a permeability associated with a particular sub-sample. This is especially true for highly heterogeneous samples such as those found in real world rock formations.

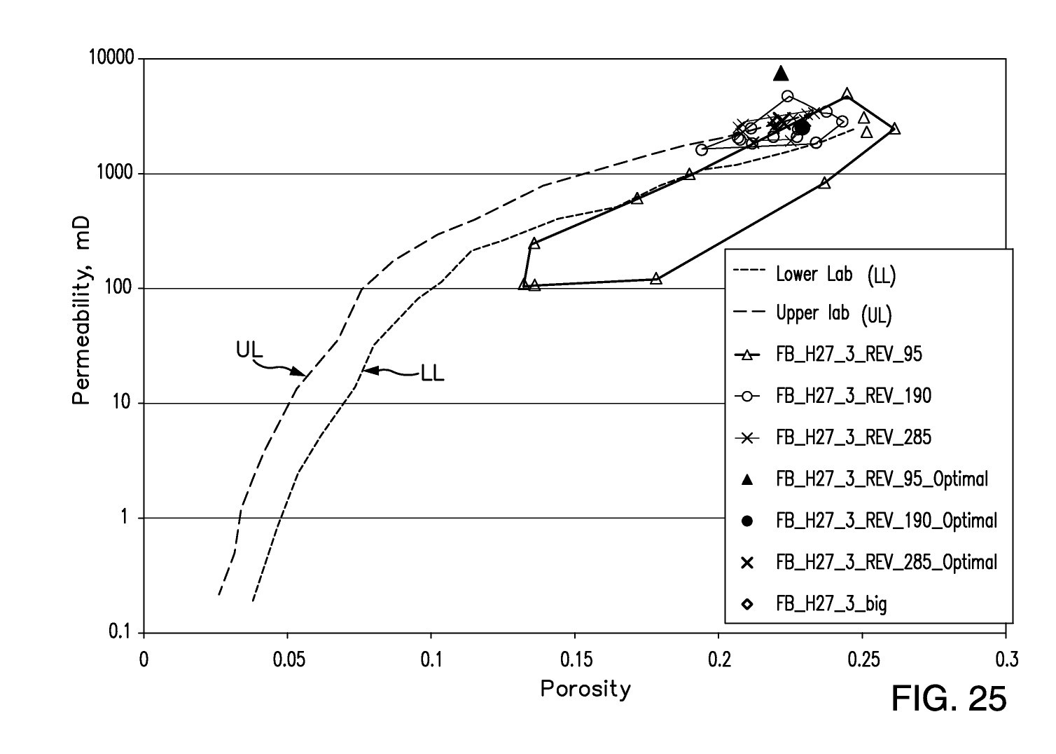

Thus, a further feature of the present invention is an efficient method to quantify how good (or how poor) is the digital representation of a rocks and how accurate is going to be a description of a fluid flow through Darcy law, i.e., to predict in a robust and efficient manner the breakdown of the porosity/permeability correlation (“poro-perm”) trend because the digital sub-sample has become too small. FIG. 25 addresses this issue illustrating poro-perm trends in a cross-plot of the log of permeability against porosity.

Here, the original rock is a sample of well documented Fontainebleau rock and the original digital sample has a dimension of 500×500×500. The poro-perm value derived from the whole of the digital sample is the large hollow diamond and it is exactly on the “Upper lab” experimental trend shown for Fontainebleau rocks (solid grey line “UL”). “LL” is the lower limit. This proves that the original size is large enough to have a correct a poro-perm relation, confirming it is an RV (Representative Volume). It can be useful to know if a trend poro-perm subdividing the initial whole rock into smaller samples can be traced. The smaller samples will correctly conform with poro-perm trend shown with the hollow diamond if they are large enough to be considered an RV. At issue is the point at which the single sub-sample becomes smaller than the REV, in other words, when the sub-sample is no longer a representative volume. The grey cross and grey circle symbols are the poro-perm trends derived from subsamples of 285×285×285 and 190×190×190 dimensions, respectively. Through these dimensions, the “Upper lab” experimental trend is satisfied. However, the trend breaks down for dimensions of ˜100×100×100, illustrated by trend (grey triangles) for a dimension of 95×95×95. Note the optimal value (black triangle), constrained by this subsample size, is substantially separated from the “Upper lab” experimental trend. Compare optimal poro-perm values shown for 190×190×190 and 285×285×285 sized sub-samples, respectively, which are indicated by the black circle and cross symbols, respectively.

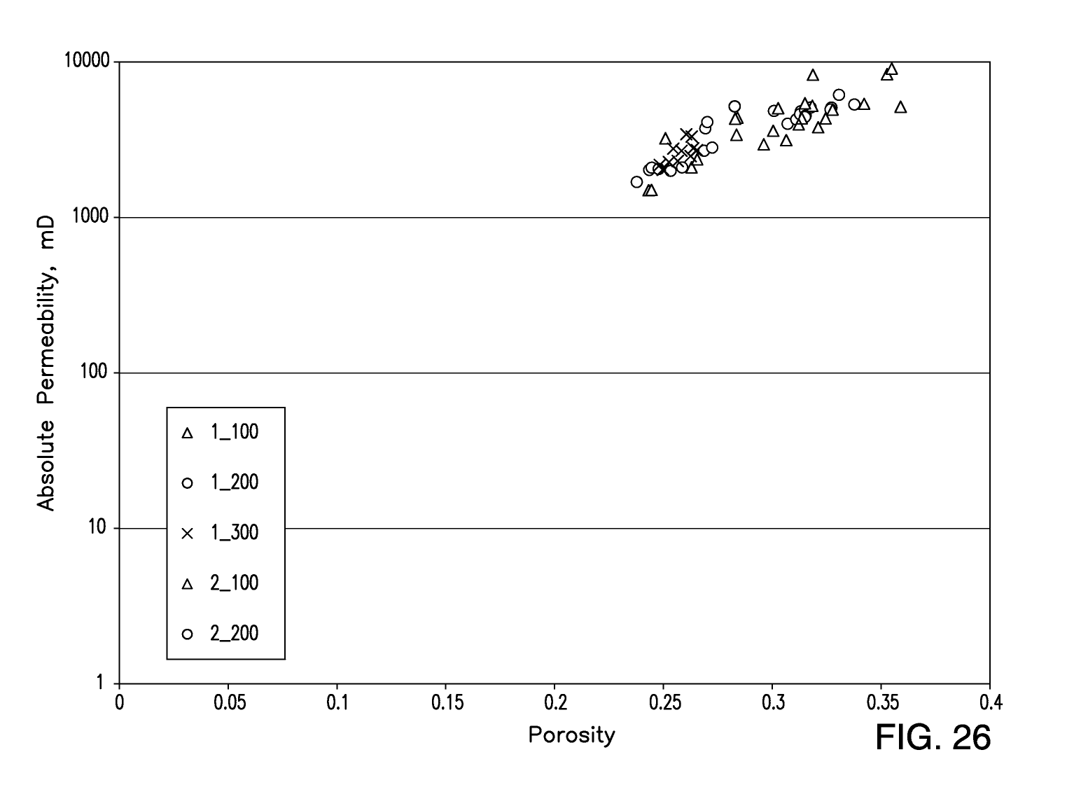

FIG. 26 is an example from another type of rock, which is a non-consolidated sandstone, showing a study of data points indicated by grey crosses, grey circles, and grey triangles for subsample dimensions of 300×300×300, 200×200×200 and 100×100×100, respectively, demonstrates that the elementary volume for this rock is evidently equal or smaller than 100×100×100.

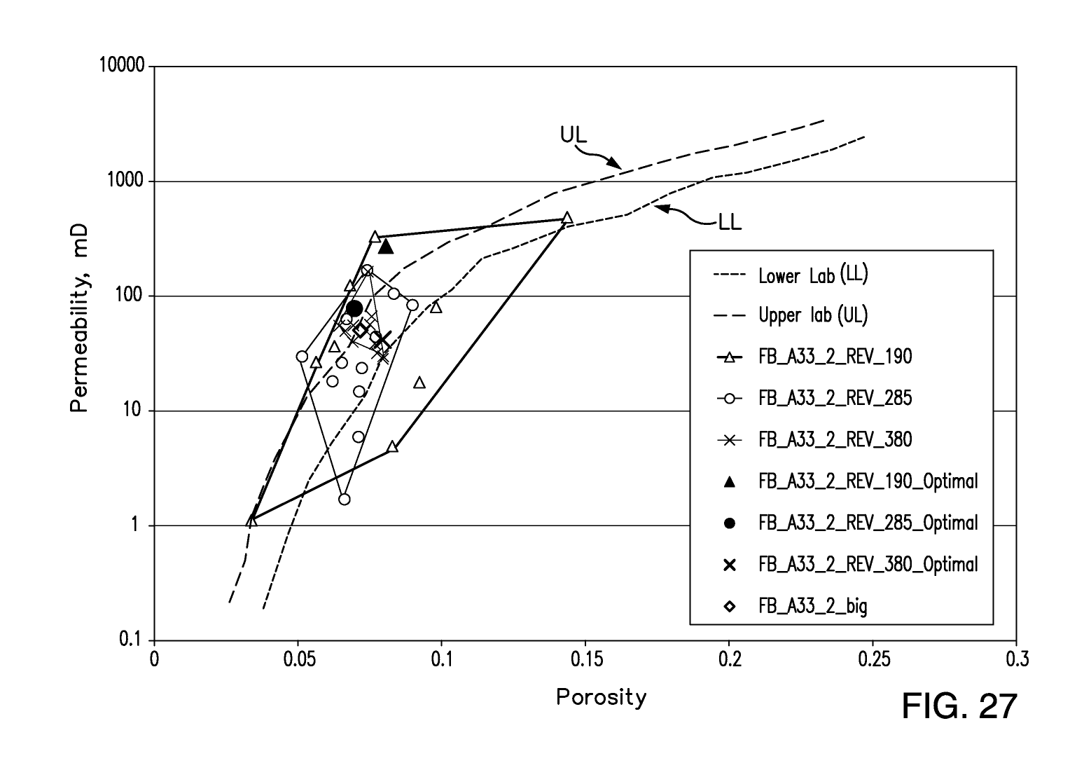

Results from a Fontainebleau sample with lower porosity than the sample of FIG. 25 are illustrated in FIG. 27. The poro-perm value (the hollow diamond) for the original sample size of 500×500×500 is on top of the “Upper Lab” experimental curve (the upper solid grey line “UL”), so that size is a representative size. “LL” is the lower limit. In this case the poro-perm correlation breaks down at size of almost 300×300×300, with reference made in this regard to the values shown by the grey circles for sample sizes of 285×285×285, and in comparison with the trends shown by the grey triangles and the grey crosses for samples sizes of 190×190×190 and 380×380×380, respectively.

Thus, the porosity-permeability cross-plots of FIGS. 25-27 illustrate very different behavior. Clearly, it would be useful to be able to accurately and efficiently predict that behavior.

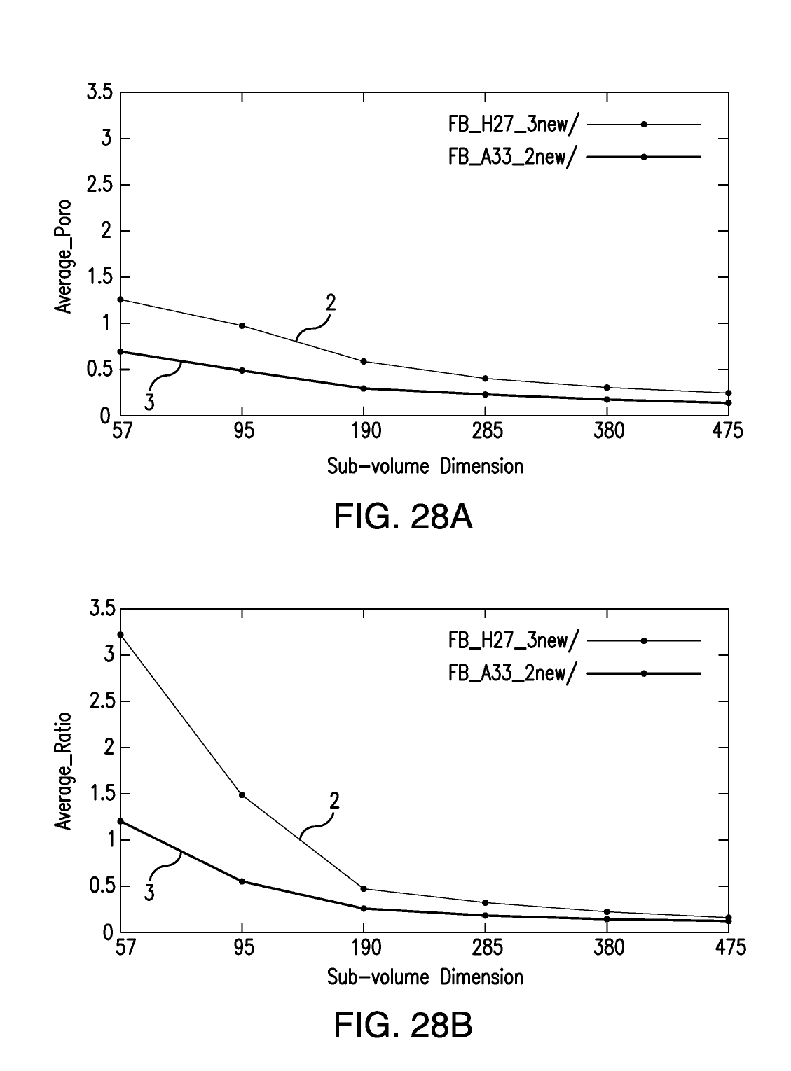

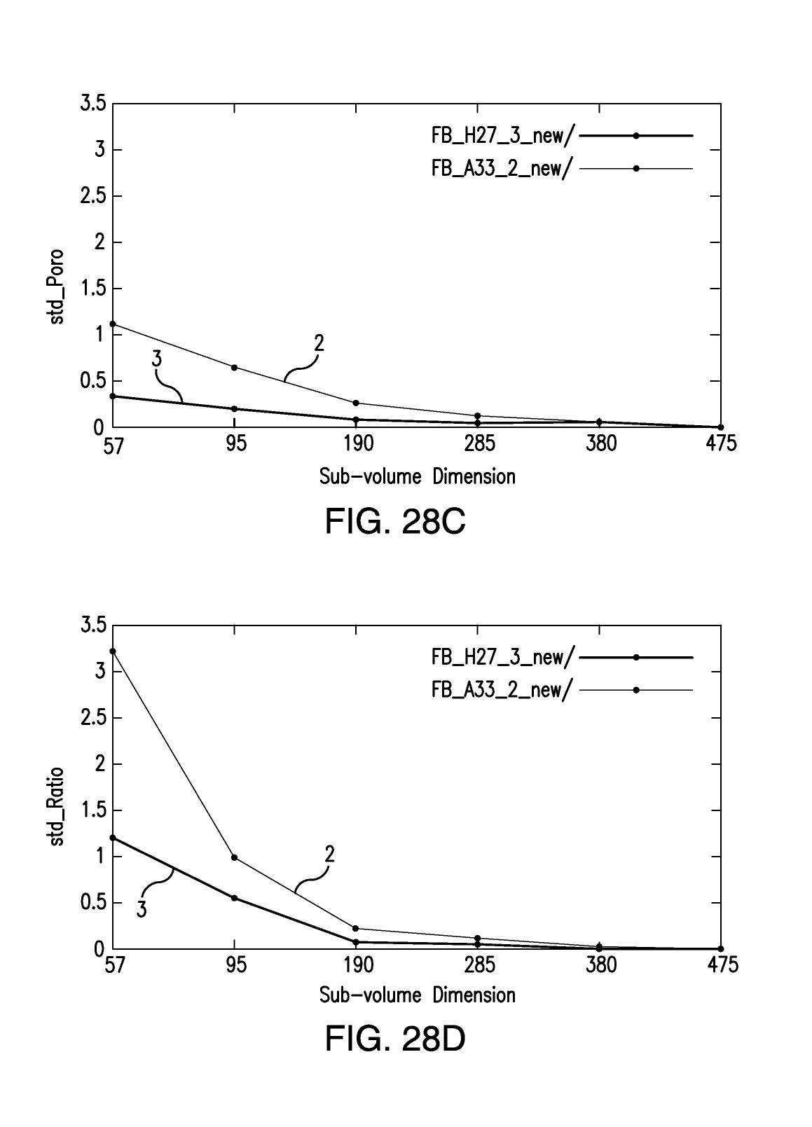

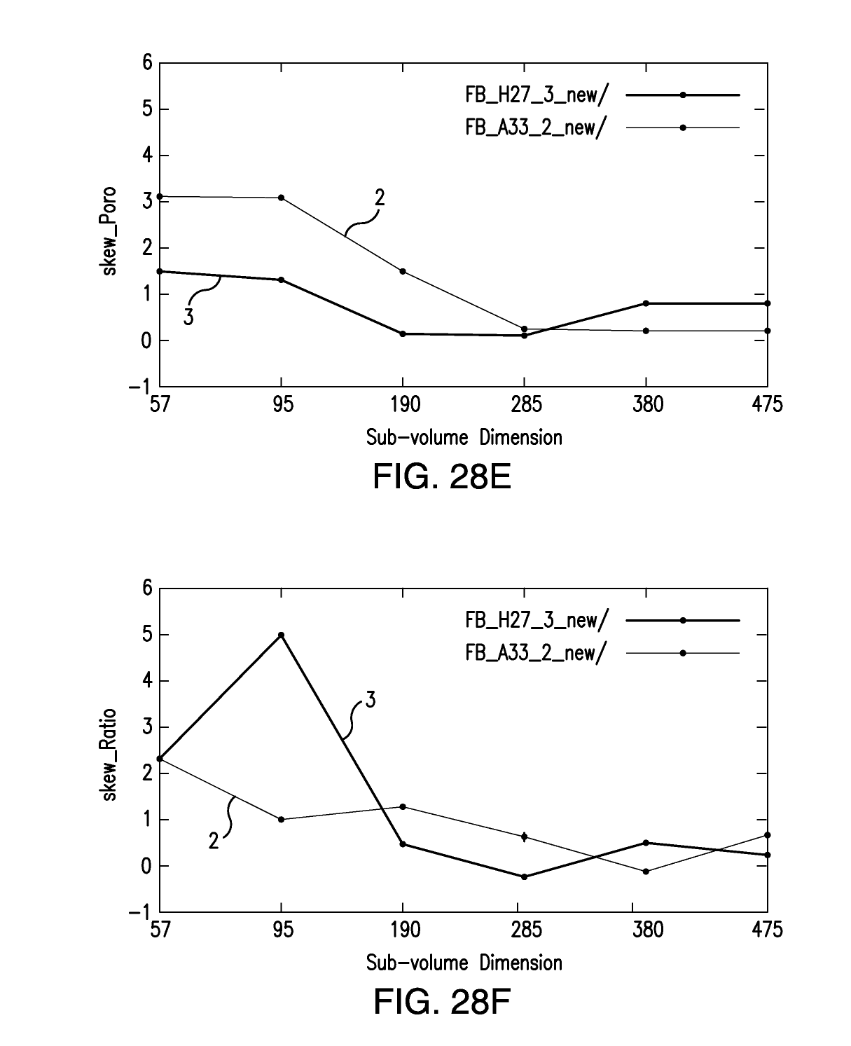

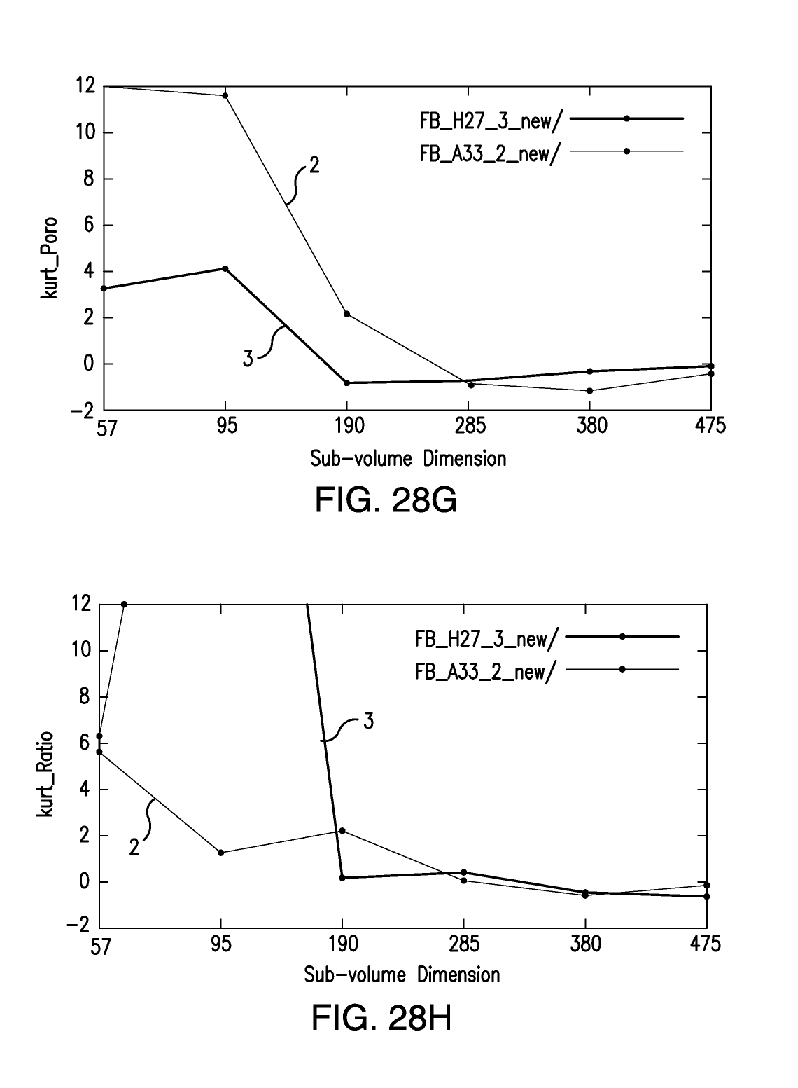

FIGS. 28A-28H illustrate the average value (A) of the distribution of standard deviation for porosity (FIG. 28A) and for surface/volume ratio (FIG. 28B), the variance (V) of the same distribution for porosity (FIG. 28C), and the variance of surface/volume ratio (FIG. 28D)) versus sub-sample dimension (size) for the two Fontainebleau rocks addressed in FIGS. 25 and 27, respectively. The skewness and kurtosis are evaluated as well, with the results shown in FIGS. 28E-28H. In FIGS. 25, 26 and 27, the black diamond, circle, and cross symbols are the optimal choice made by the tool targeting both the function surface/volume and porosity. In FIGS. 28A to 28H, the black circle defined lines are for the larger porosity sample of FIG. 25, and the grey circle defined lines are the smaller porosity sample of FIG. 27. The following becomes evident from these trends of data: both averages of the distribution are decreasing with increasing sub-rock dimension. For a specific size, the rate of change of the average with the dimension of the sub rock becomes small. This is happening for a size of 190 (for the high porosity rock, black line) and a size of 380 (for the low porosity rock, grey line). The variance of the distribution is decreasing as well and reach very small value for the same dimension of the sub rock. The higher order moments give an indication of symmetry of the distribution when the size of the subsample is large enough the distribution becomes Gaussian-like.

Recall the meaning of average and standard deviation (or variance) of the distribution, wherein the average, that is the same as the mode of the distribution when the distribution is a Gaussian, gives the “position” of the distribution respect the “zero”, and the variance accounts for its spread in respect the average value. FIGS. 11A-11B and 15A-15B demonstrated, for example, that a distribution centered in zero and with zero variance, means perfect periodicity of the sub-volume chosen. Thus, the average and the variance is a measure of the “periodicity” for the target function (porosity or surface/volume) of the sub-volume within the whole rock.

When the dimension of the sub-rock is decreasing slowing from the original size (at the limit, decreasing 1 voxel size per time), different things happen to the distribution: first, the variance starts to increase; second, when the size is reduced more than a specific threshold, the average of the distribution starts to change and the distribution becomes non symmetric (it increases, that means larger variation of the target function in the flow direction) respect the value of the target function evaluated in the whole original rock. Basically, the distribution is moving to the right of the original position (see the previous plots referenced herein for two different rocks).

It is evident that for dimension of the sub-rock that gives a shift of the average, the correlation poro-perms is broken. This makes sense because when the average is large and the variance is also large, there is a high probability to pick a sub-sample with large variation of porosity and surface/volume respect the original value of this variation. Note that, when the average has the same value as in the original whole sample, there is a large probability of picking a sub-sample with the same variation of porosity and surface/volume, but this does not imply same value porosity or surface/volume (so permeability). In other words, there can still be a poro-perm trend. To further demonstrate these features, other cases for carbonates and sandstones are provided hereinafter.

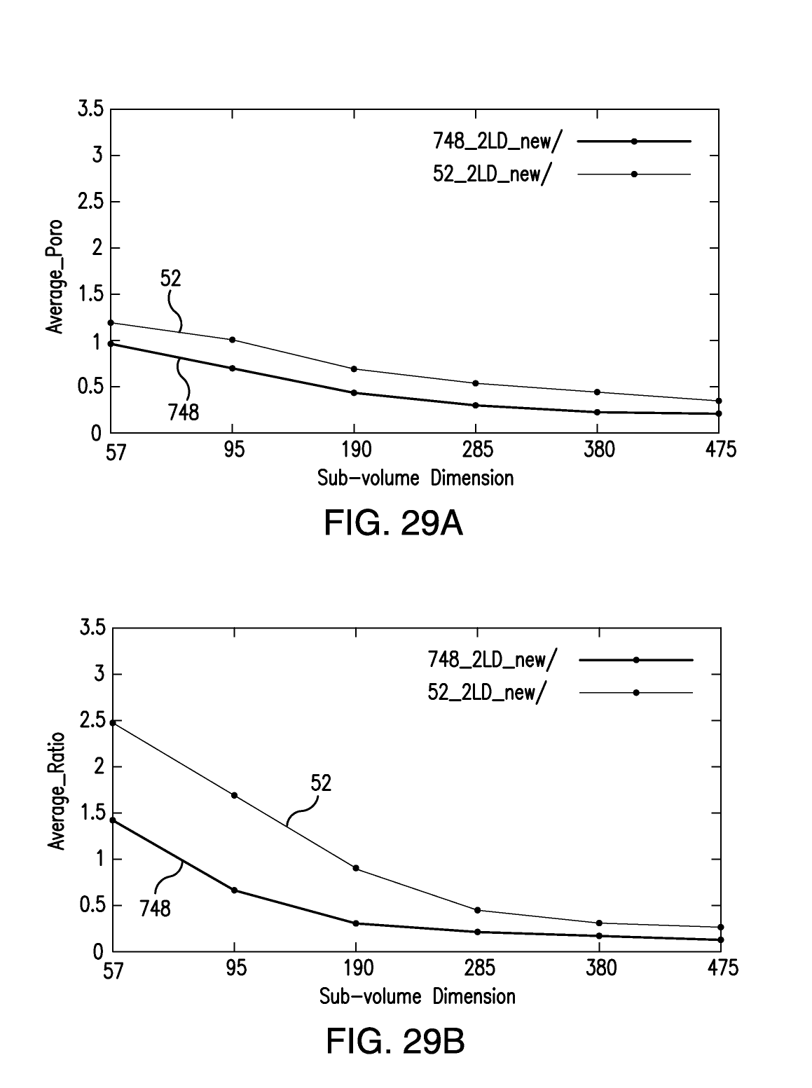

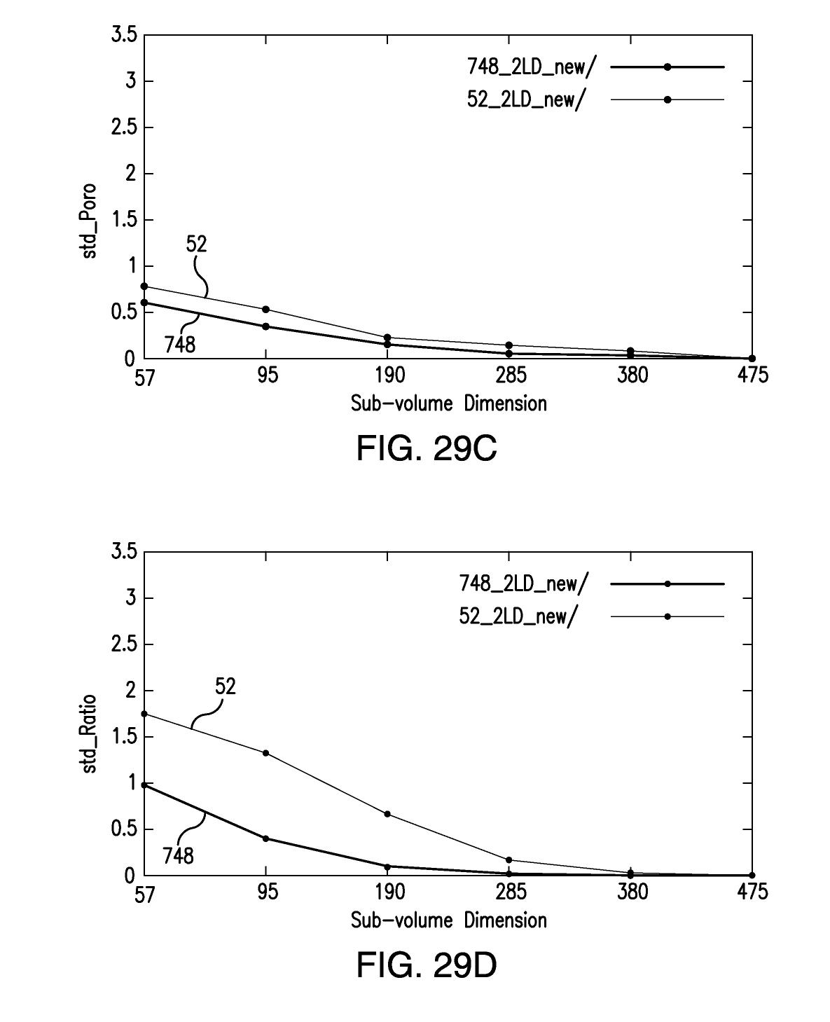

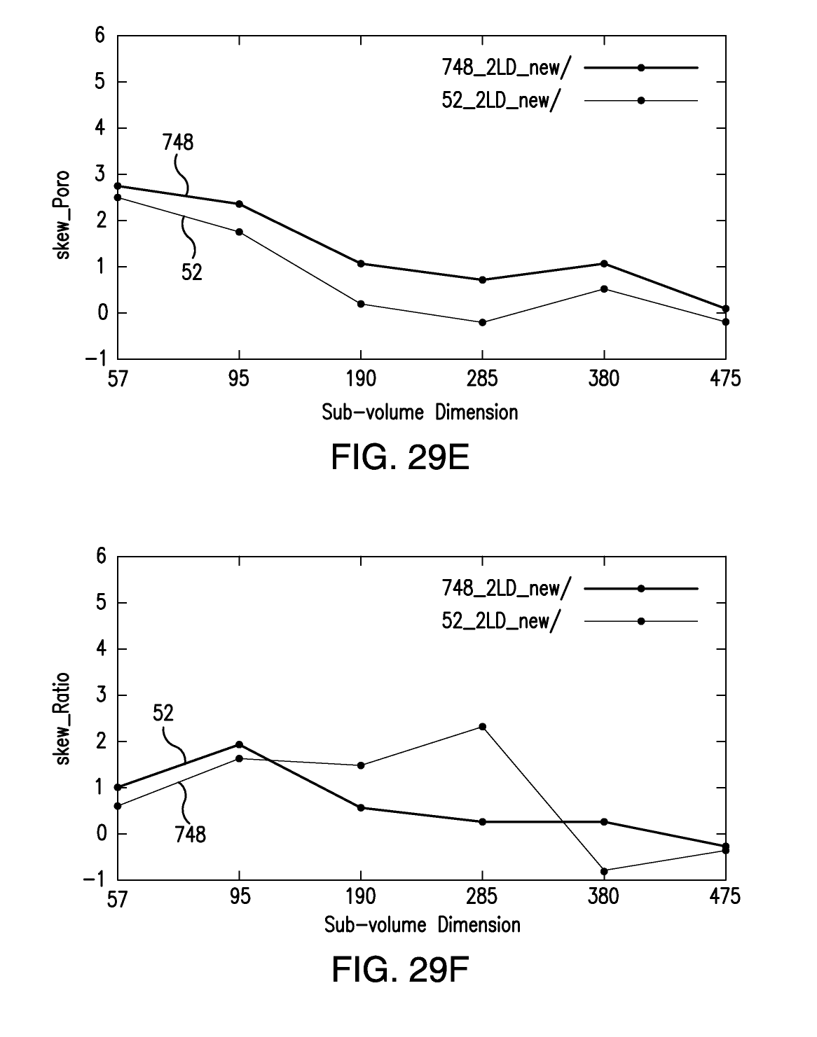

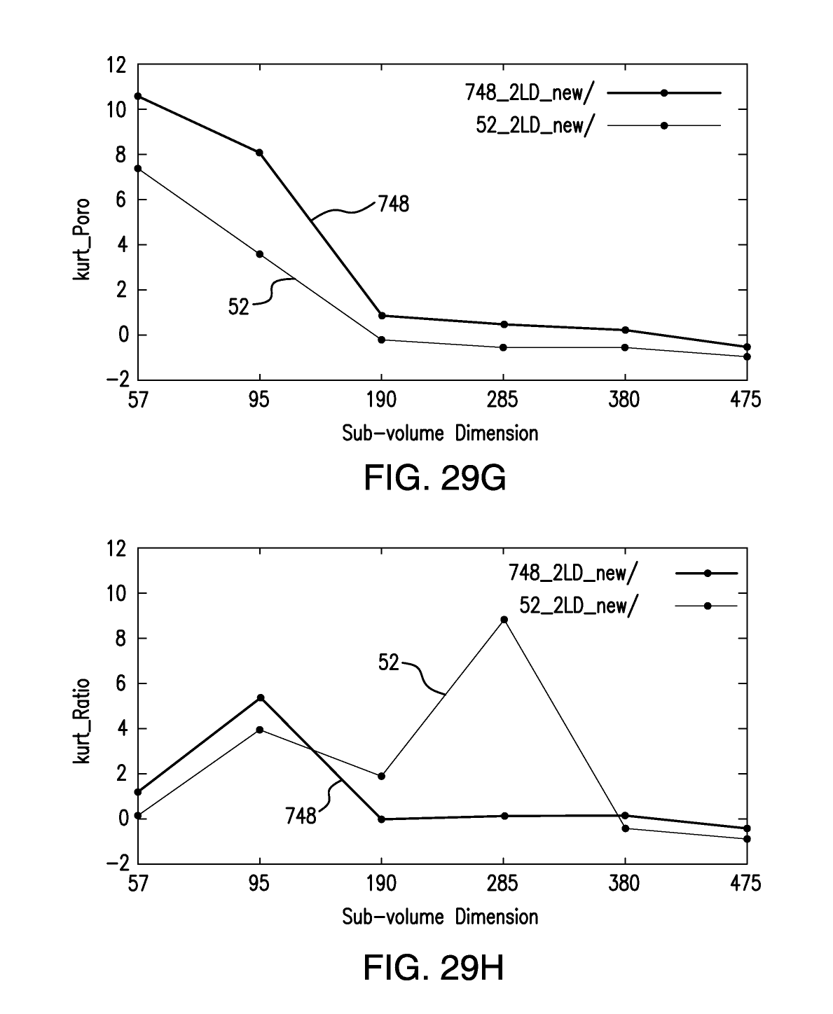

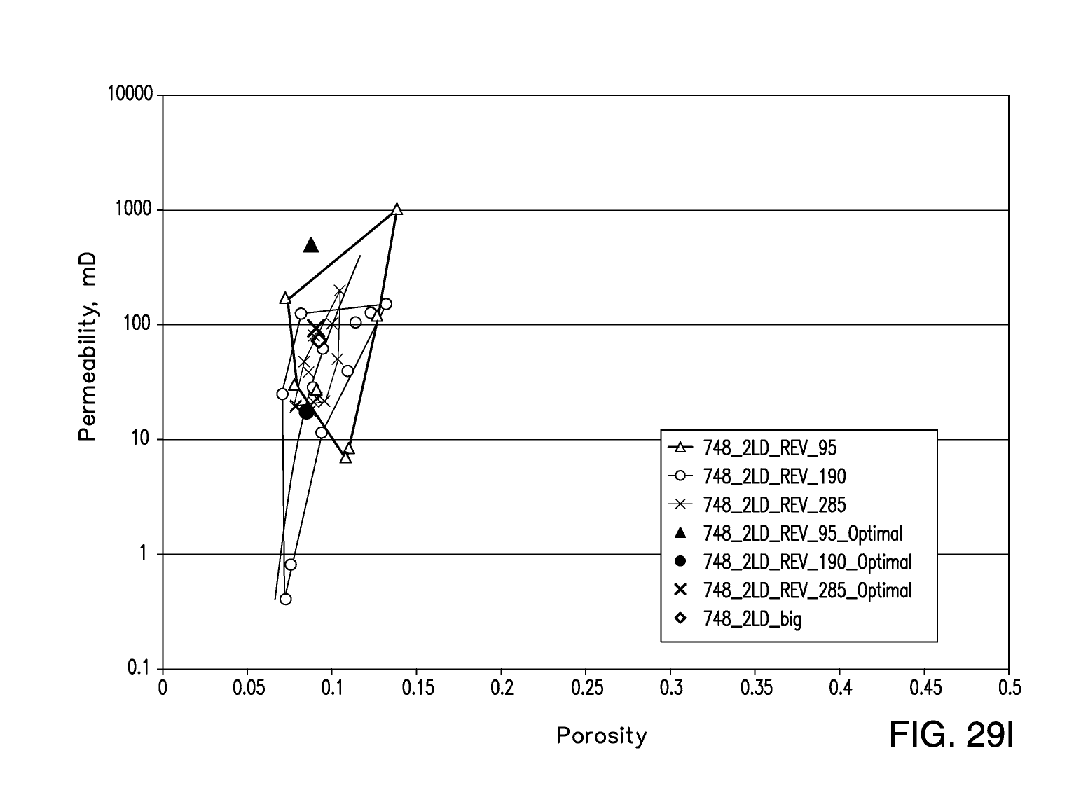

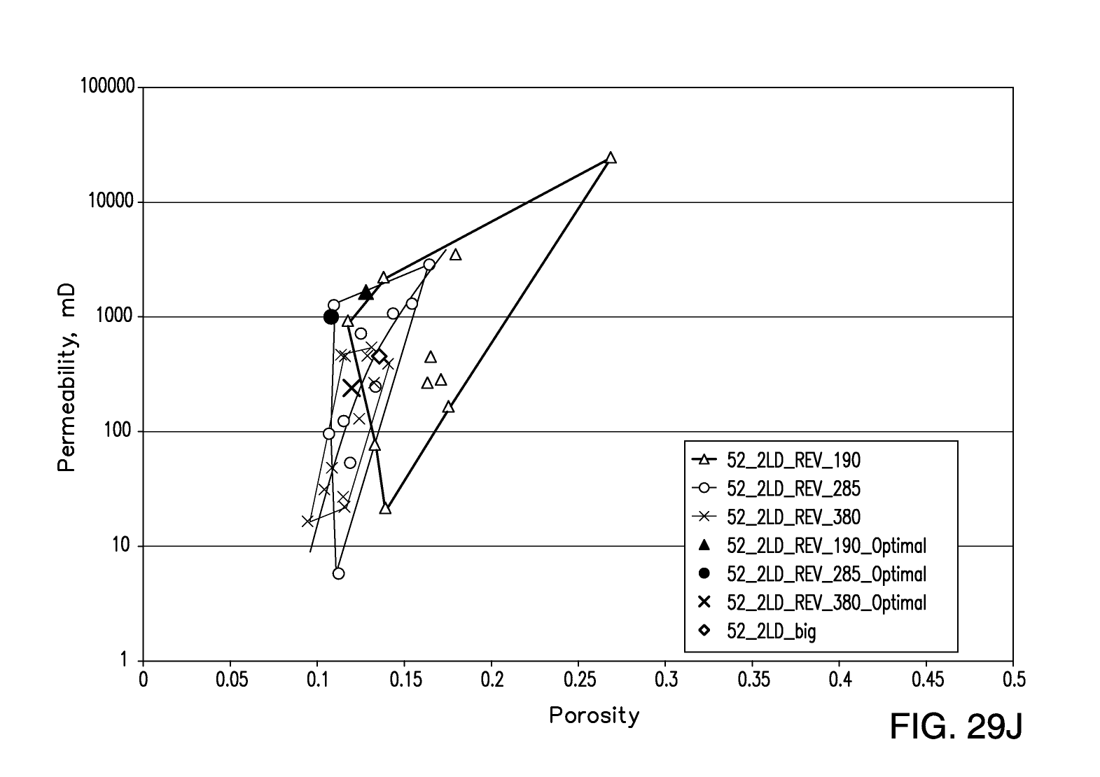

As further demonstrations, for example, FIGS. 29A-29H illustrate application of methods of the present invention for two different carbonate samples. For both of these carbonates, the results are seen to be similar as for the previous rock. That is, when the average of porosity and standard deviation stop to decrease (or decrease at slow rate) for a specific size, the variance is also small and a good trend poro-perm can be expected. In FIGS. 29A-29H, the black circle defined lines are for the larger porosity carbonate sample, and the grey circle defined lines are for the smaller porosity carbonate sample. The two carbonate samples differ in porosity and especially, permeability The one with lower porosity has permeability lower than 100 mD, and the one with higher porosity has permeability of several hundred mD. In FIG. 29I, the grey triangle, the grey circle, and the grey cross symbols relate to the poro-perm trends for subsample dimensions of 95×95×95, 190×190×190, and 285×285×285, respectively, related to poro-perm trends for the sample identified by grey circles in FIGS. 29A-29H. In FIG. 29J, the grey triangle, the grey circle, and the grey cross symbols relate to the poro-perm trends provided for subsample dimensions of 190×190×190, 285×285×285, and 380×380×380, respectively, related to poro-perm trends for the sample identified by black circles in FIGS. 29A-29H. Note that in each plot of FIGS. 29I and 29J, the black triangle, circle, and cross symbols are the optimal choice made by the tool targeting both the function surface/volume and porosity.

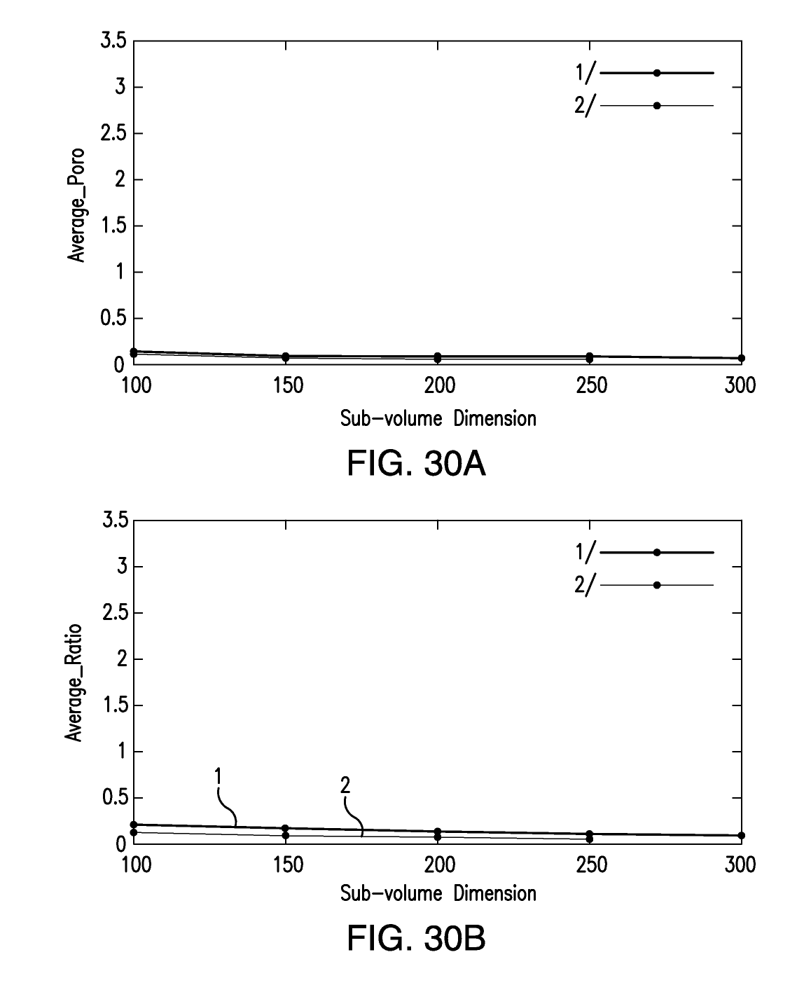

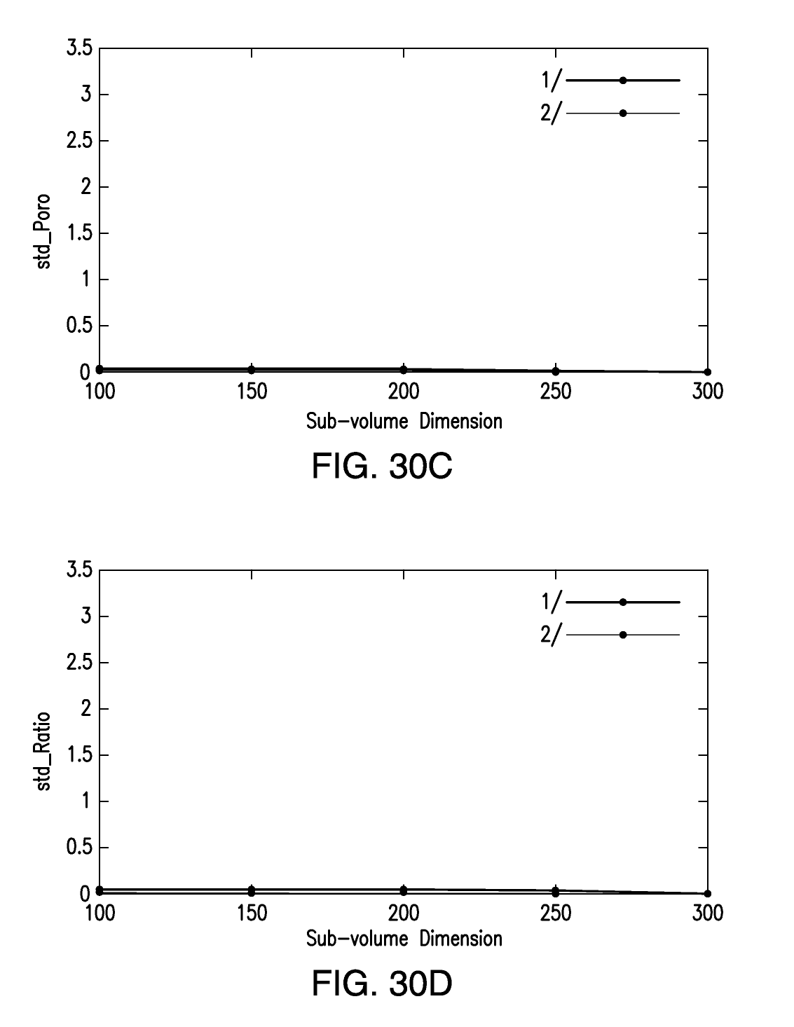

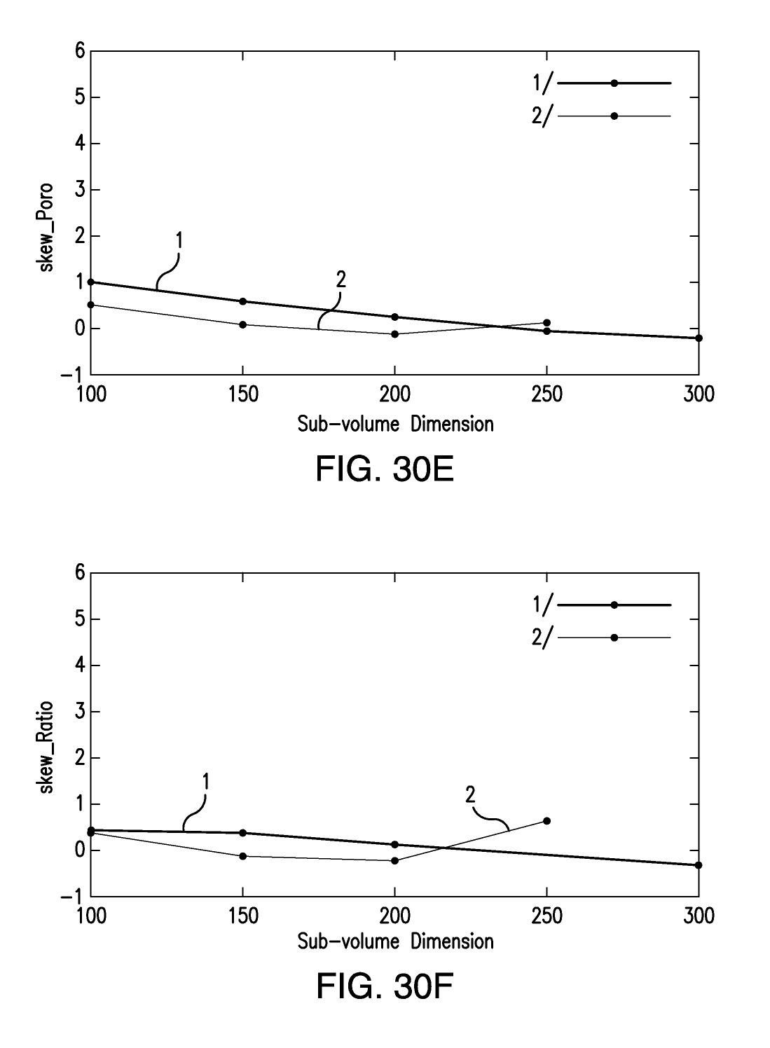

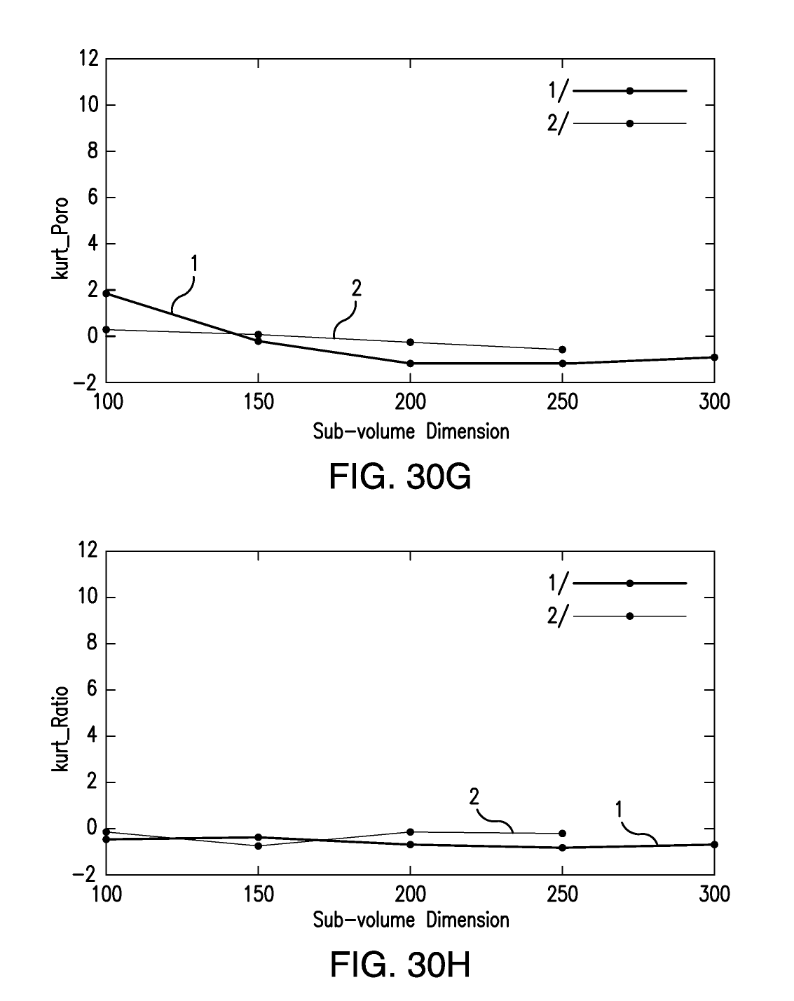

FIGS. 30A-30H illustrate other applications of the present invention, here cases for which the rock is relatively homogeneous and can provide good poro-perm trends starting from a sub-sample size of 100×100×100. Two different relatively homogeneous rocks were used for this study. In FIGS. 30A-30H, the black circle defined line is for the larger porosity sample, and the grey circle defined line is the smaller porosity sample. The poro-perm for FIGS. 30A-30H is shown in FIG. 26.

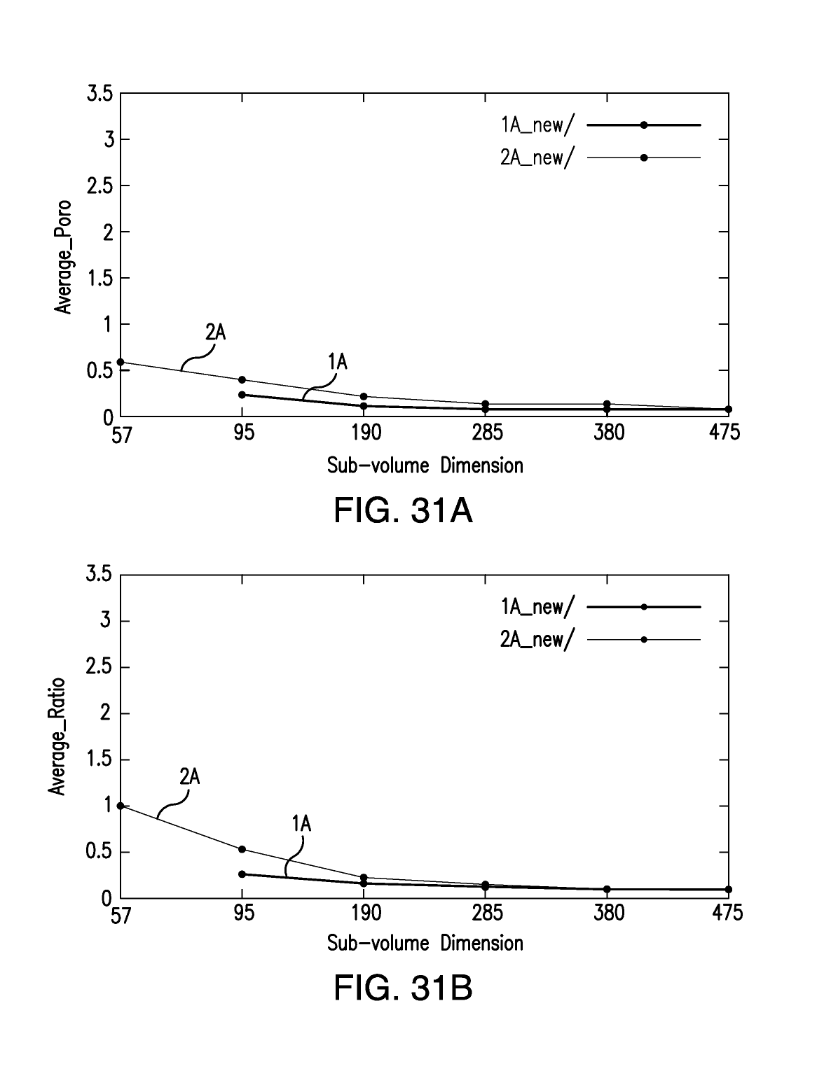

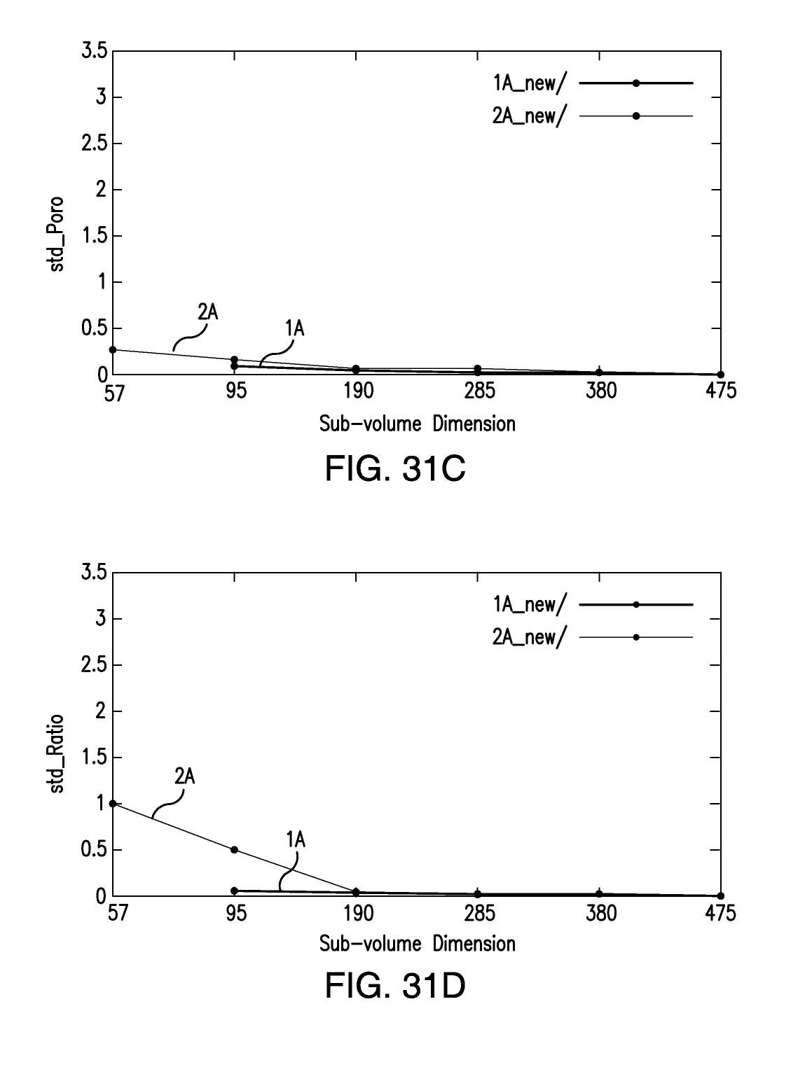

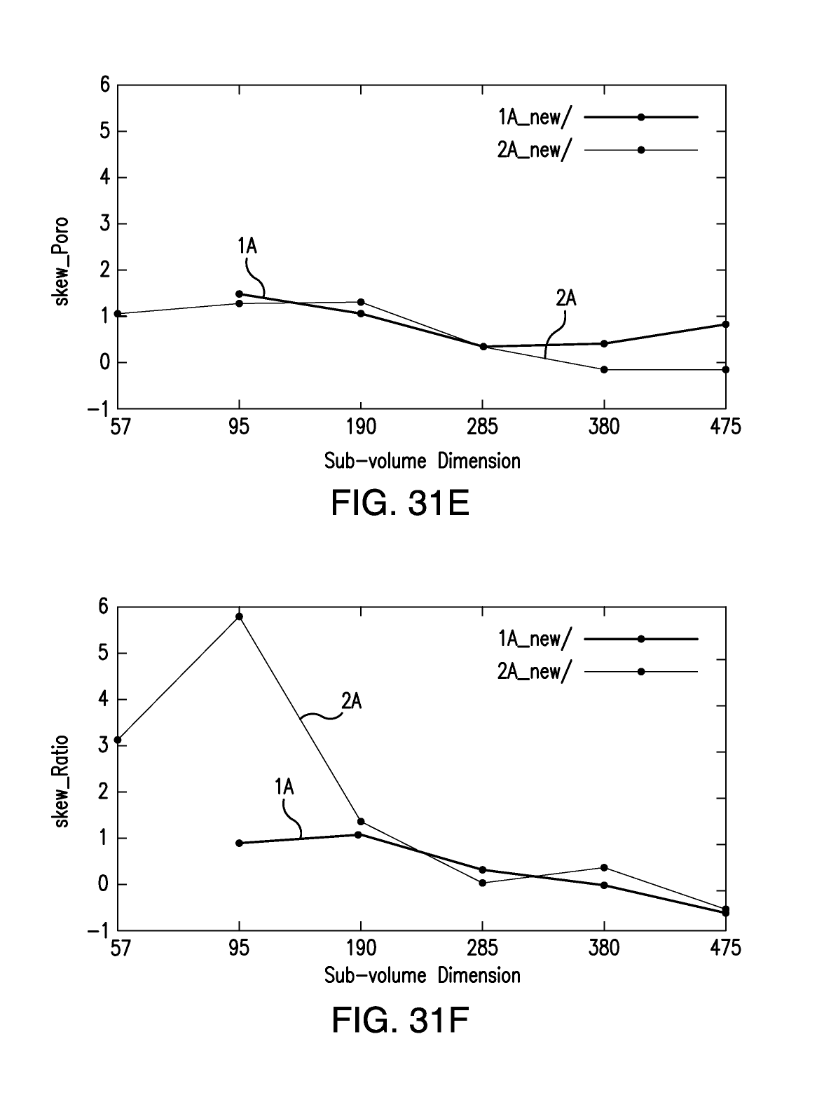

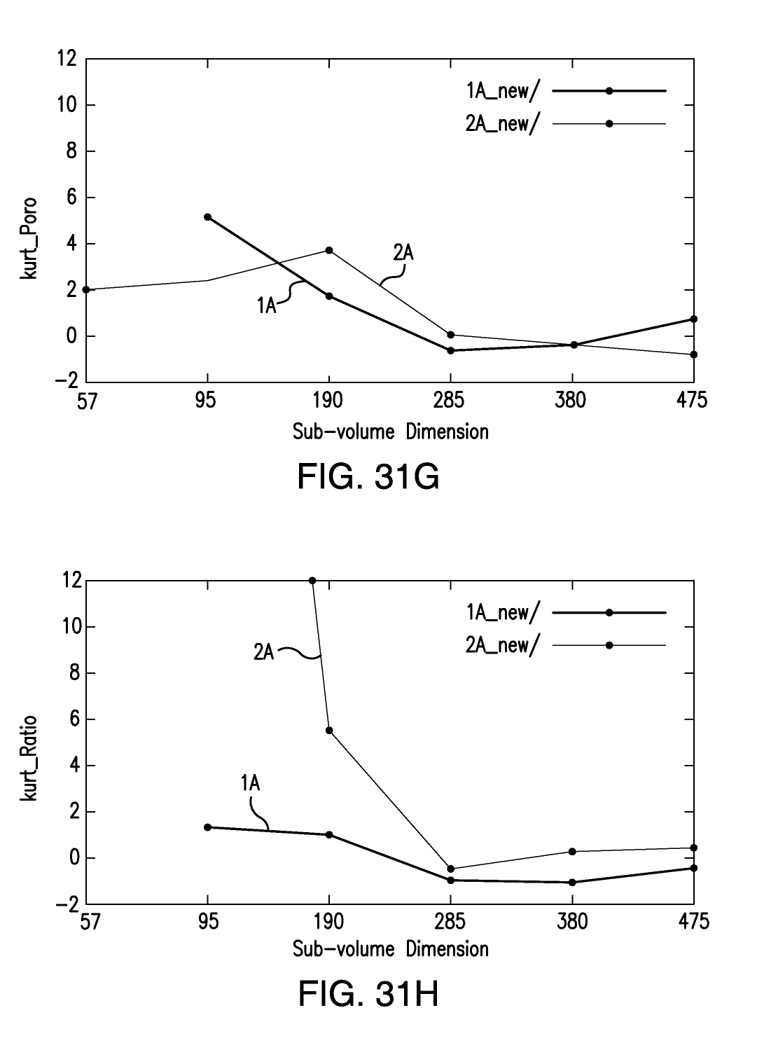

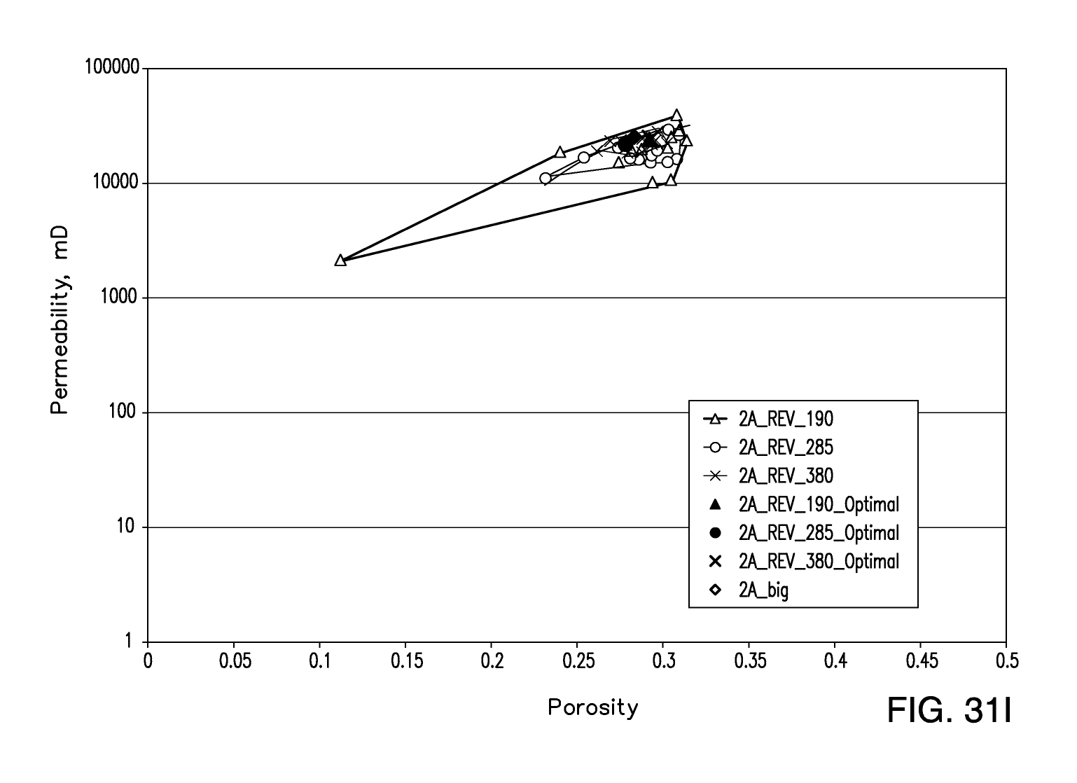

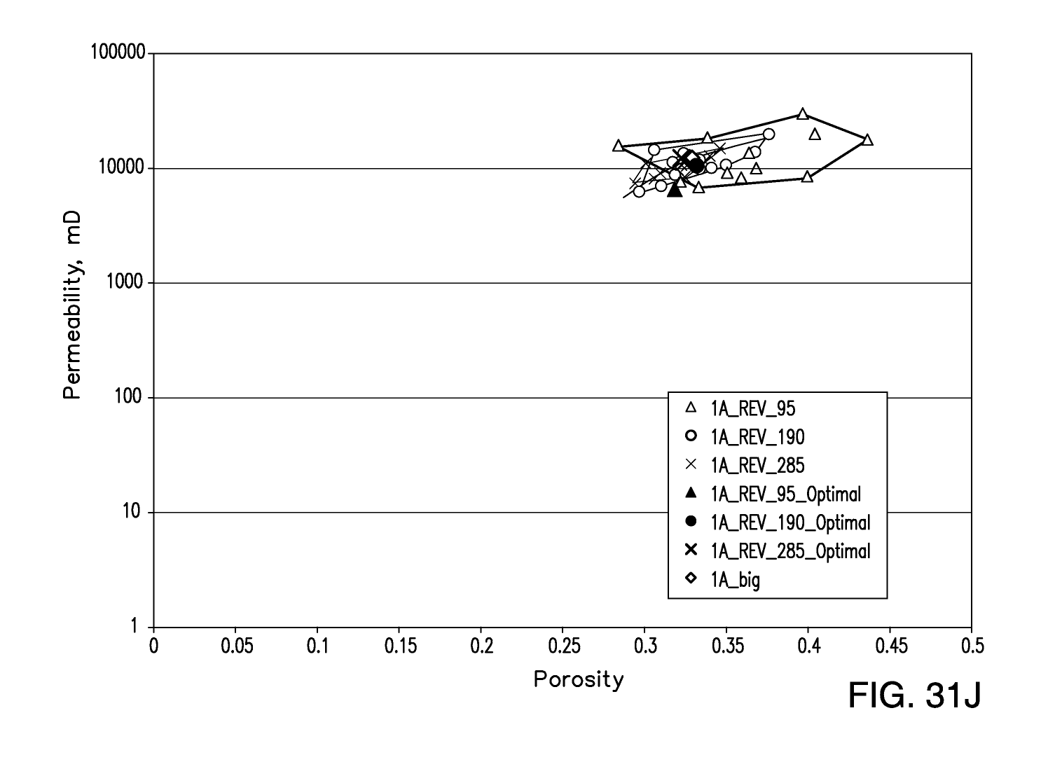

FIGS. 31A-31H provide yet additional examples, here two rocks are investigated where the poro-perm breakdown is at dimensions of 100×100×100 and almost 200×200×200. In FIGS. 31A-31H, the black circle defined line is for the larger porosity sample, and the grey circle defined line is the smaller porosity sample. The samples were sandstone. In FIG. 31I, the grey triangle (corresponding to the outer encircling plot), the grey circle (corresponding to the inner encircling plot), and the grey cross symbols relate to the poro-perm trends for subsample dimensions of 190×190×190, 285×285×285, and 380×380×380, respectively, related to poro-perm trends for the sample identified by grey circles in FIGS. 31A-31H. In FIG. 31J, the grey triangle symbols (corresponding to the largest encircling plot), the grey circle symbols (corresponding to the intermediate sized encircling plot), and the grey cross symbols (corresponding to the smallest encircling plot) relate to the poro-perm trends of subsample dimensions of 95×95×95, 190×190×190, and 285×285×285, respectively, related to poro-perm trends for the sample identified by black circles in FIGS. 31A-31H. In each plot of FIGS. 31I and 31J, the black triangle, circle, and cross symbols are the optimal choice made by the tool targeting both the function surface/volume and porosity.

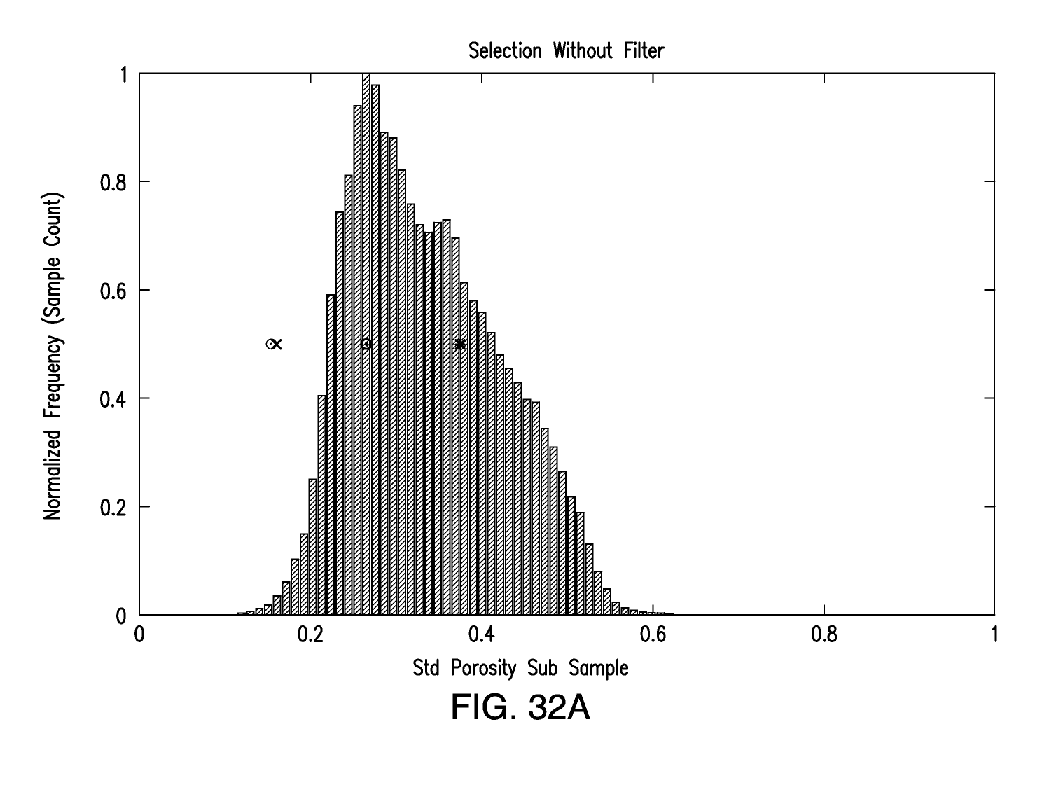

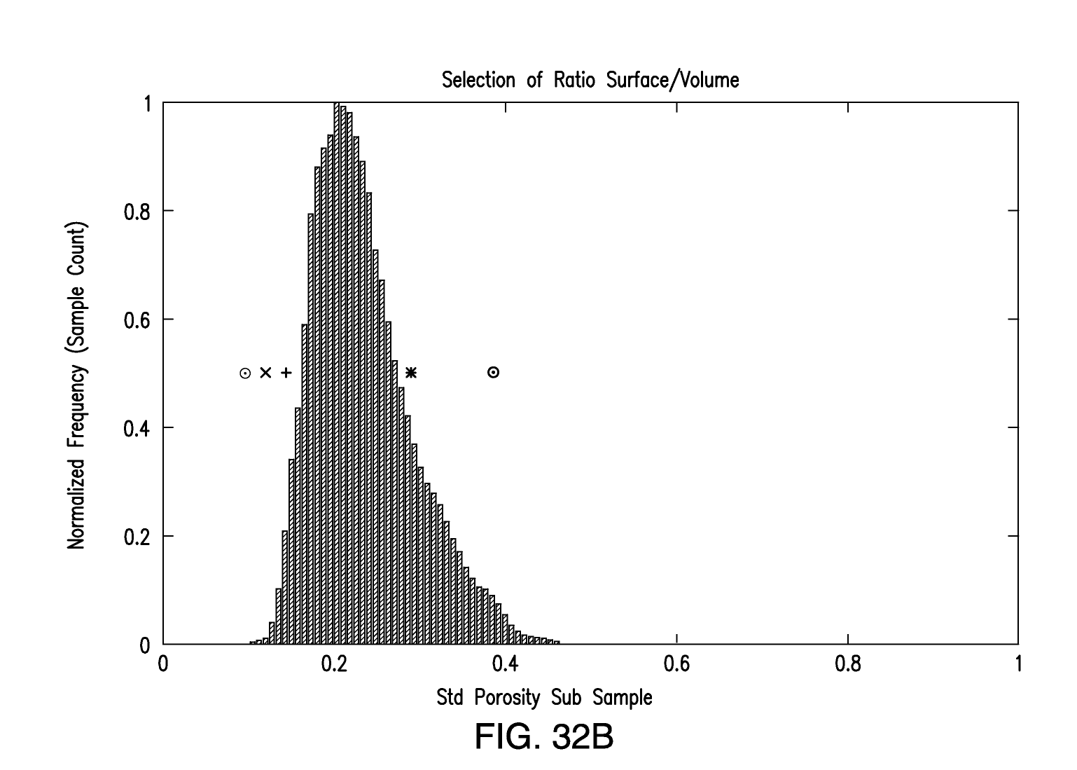

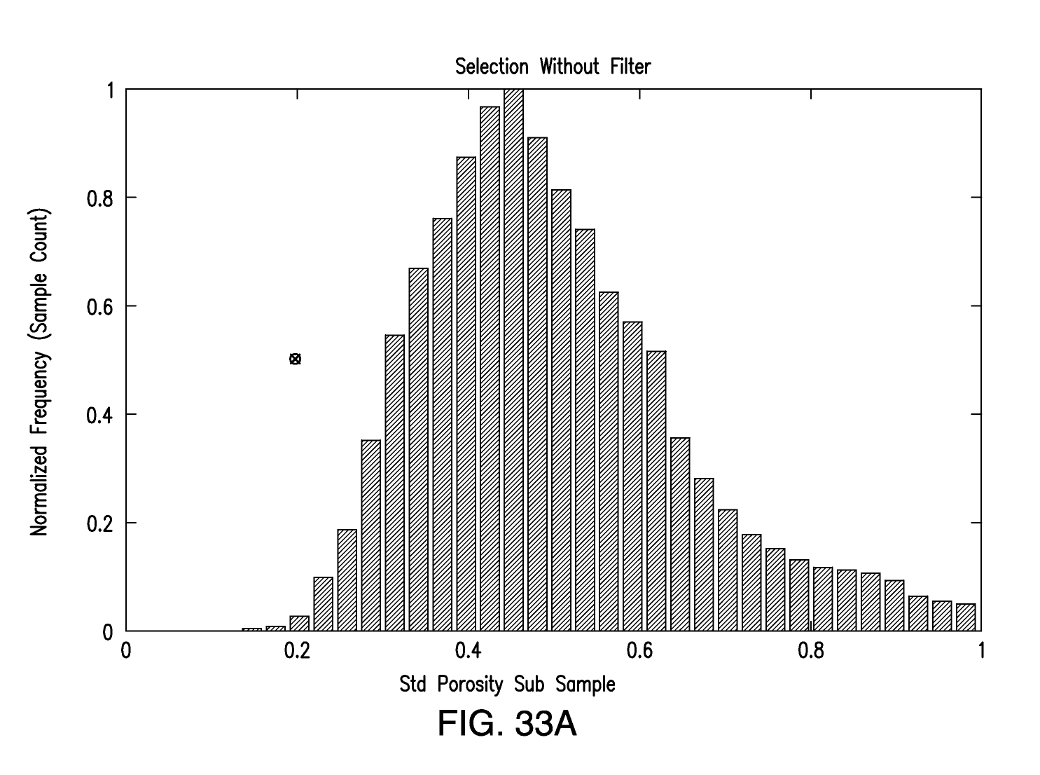

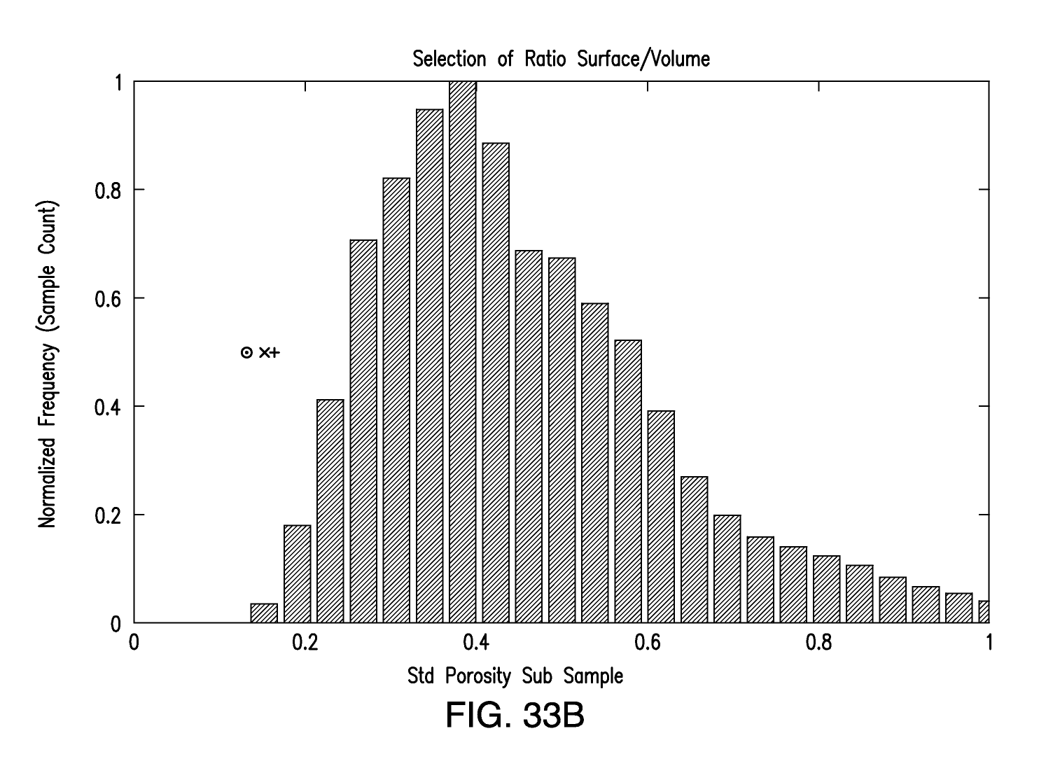

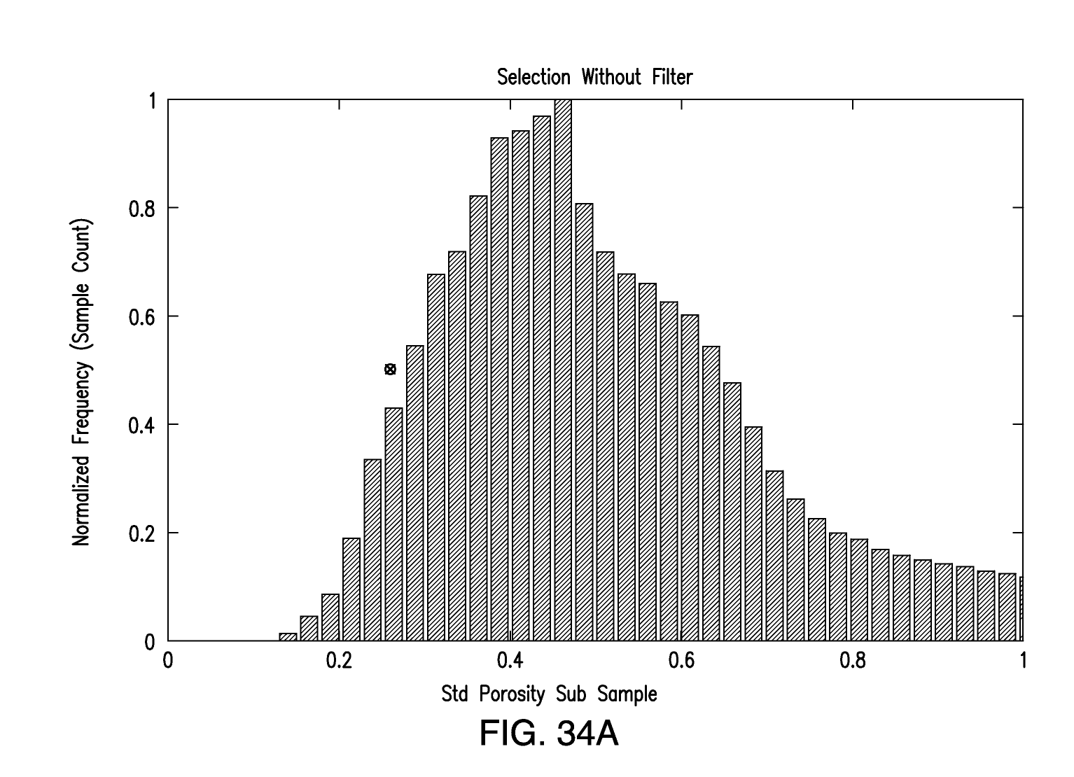

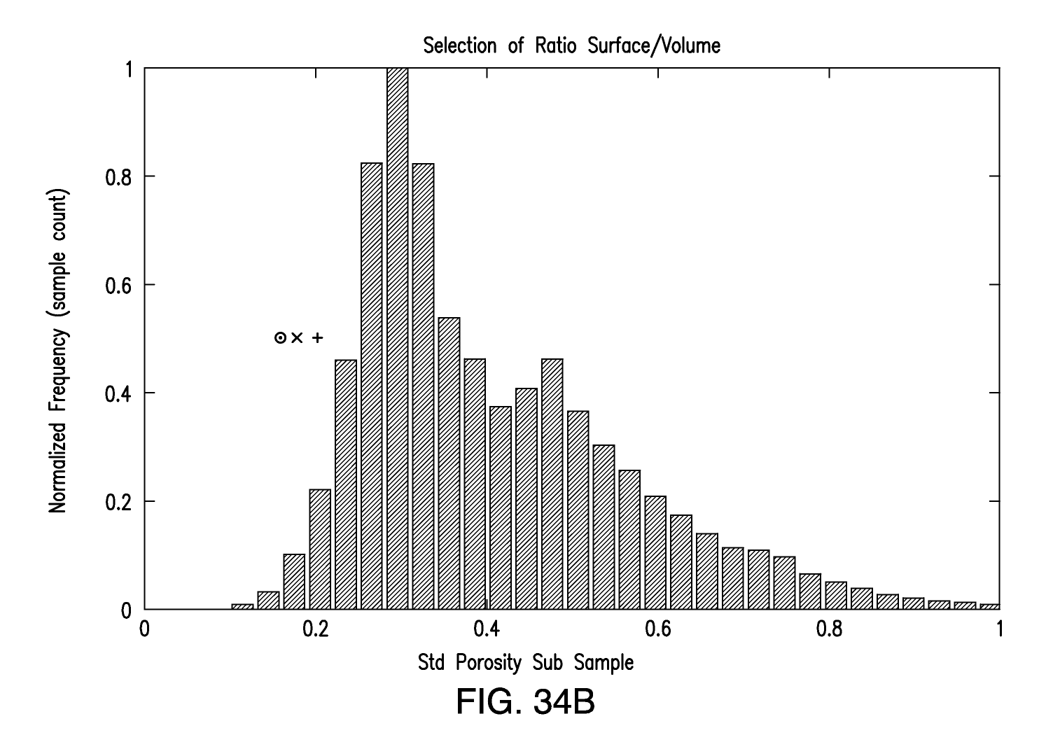

A different way to use this invention is to estimate which resolution and field of view is the most appropriate for a rock. In fact, the dimension of the subsample can be fixed, for example up to 400×400×400, and what is changed is the resolution and field of view of the scan. Typically, the number of points used is fixed by the scanner and those points can be allocated in volume of different size. This gives different resolution for the scan of the rock: for a smaller field of view, the resolution will be larger than a large field of view. One of the problems is to understand which field of view (so resolution) is the appropriate for the rock. The distribution of the standard deviation of the target functions can be used to address this issue, where the dimension of the sub-sample will be fixed for all the field of view. For example, in FIGS. 32A-32B, 33A-33B, and 34A-34B, a sandstone is analyzed with original dimension of 550×550×550. The distribution of standard deviation (porosity right, surface/volume left) is obtained with a sub sample of 200×200×200. What is changing from FIGS. 32A-32B to FIGS. 33A-33B to FIGS. 34A-34B is the resolution of segmentation, wherein the segmented sample has a resolution of 10×, 20×, and 40×, respectively, which can mean that one voxel is 2, 1 and 0.5 micron respectively. It is evident from FIGS. 33A-33B that a resolution of 20× has a distribution with a very large variance and an average that is much larger than the average at 10× resolution as shown in FIGS. 32A-32B. In order to work with a resolution of 20×, a larger field of view should be used in the segmentation. The resolution of 10× is acceptable for this example.

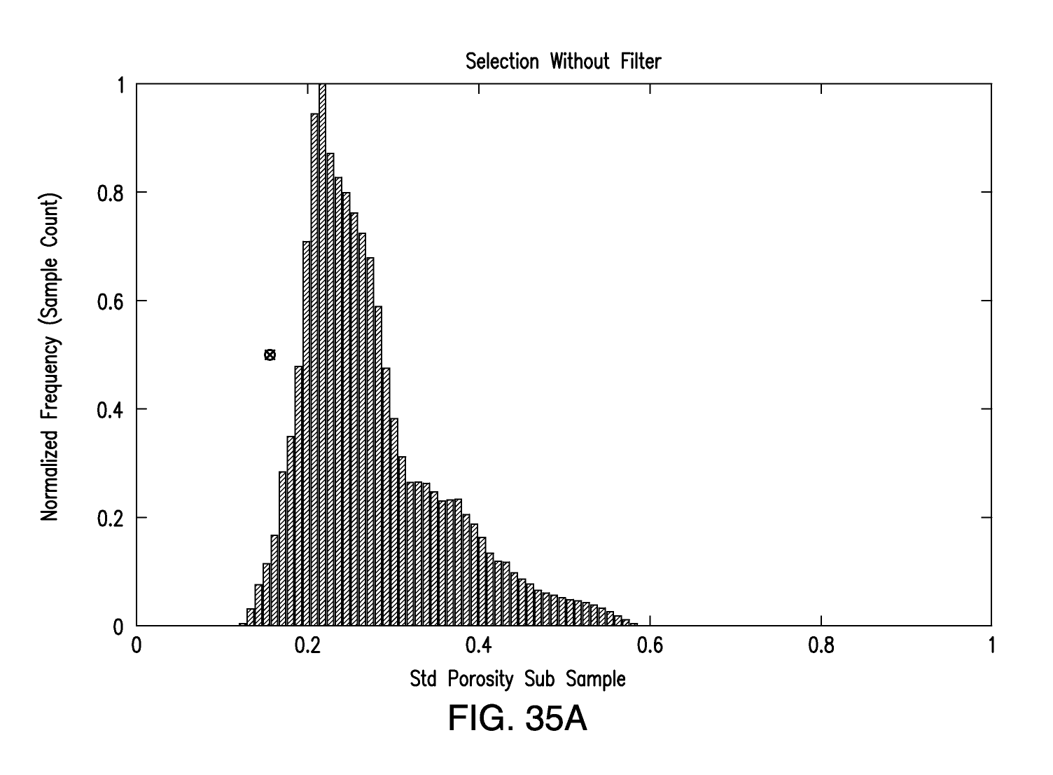

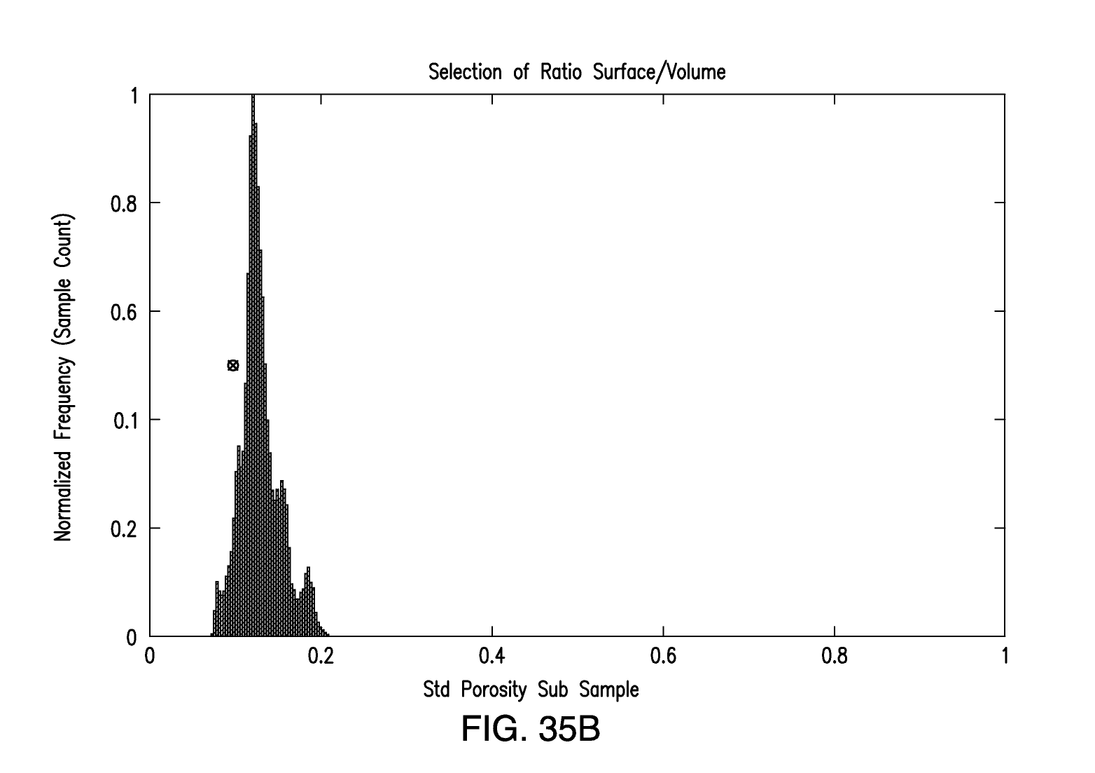

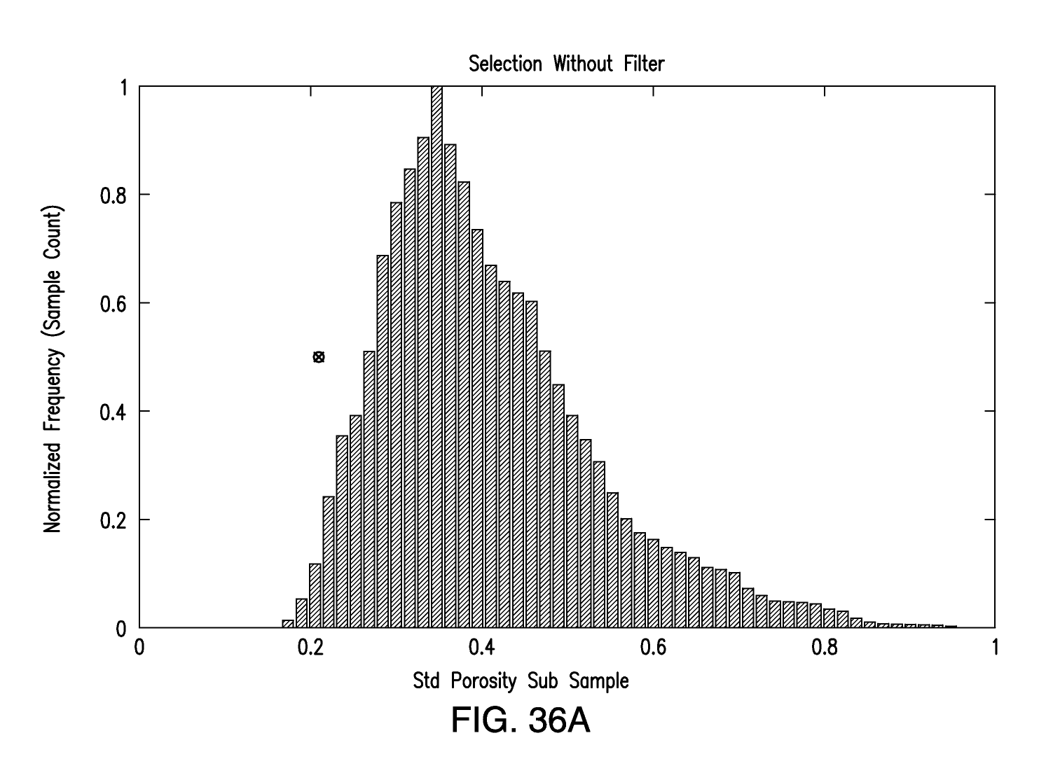

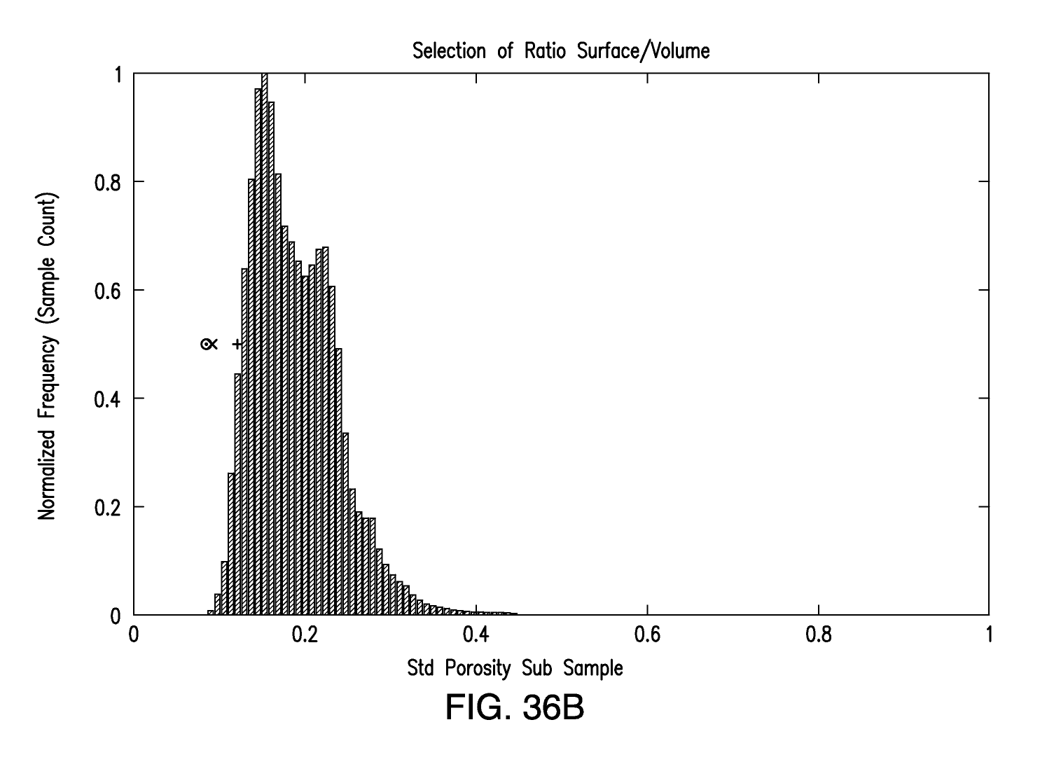

In the next example, which is illustrated in FIGS. 35A-35B and 36A-36B, another sandstone is analyzed and the distribution of standard deviation (porosity right, surface/volume left) is obtained with a sub sample of 200×200×200 as before. In this case, the resolution 4×, which is shown in FIGS. 35A-35B, is more appropriate than the resolution of 10×, which is shown in FIGS. 36A-36B, with respect to the one in the previous example, wherein the resolution of 10× has an average and variance too large.

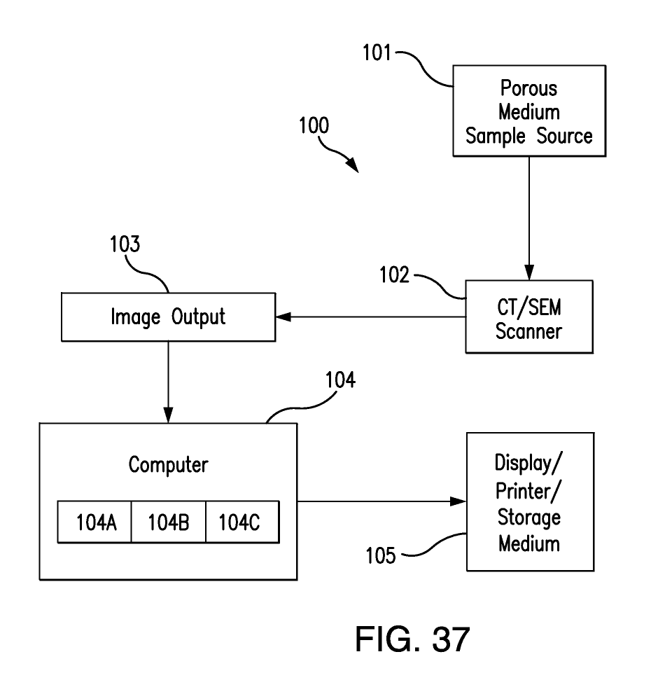

Referring to FIG. 37, a system 100 is shown which can be adapted for performing the present methods. As shown in this example, three dimensional (3D) images of the porous medium samples obtained from source 101 are generated by the scanner 102. The 3D image output 103 of the scanner can be transferred to a computer 104 having program instructions for carrying out the 3D image analysis, and the indicated data and simulation analysis, to generate sample modeling output/results which can transmitted to one or more devices 105, such as a display, a printer, data storage medium, or combinations of these. The computer programs used for 3D image analysis and the CFD computations and simulation modeling can be stored, as a program product, on at least one computer usable storage medium 104B (e.g. a hard disk, a flash memory device, a compact disc, a magnetic tape/disk, or other media) associated with at least one processor 104A (e.g., a CPU) which is adapted to run the programs, or may be stored on an external computer usable storage medium (not shown) which is accessible to the computer processor. Computer 104 can include at least one memory unit 104C for storage of the programs, input data and output data, and other program results, or combinations of these. For output display, device 105 can be, for example, a display monitor, CRT, or other visual means of display (not shown). The computer 104 may include one or more system computers, which may be implemented as a single personal computer or as a network of computers. However, those skilled in the art will appreciate that implementations of various techniques described herein may be practiced in a variety of computer system configurations, including hypertext transfer protocol (HTTP) servers, hand-held devices, multiprocessor systems, microprocessor-based or programmable consumer electronics, network PCs, minicomputers, mainframe computers, and the like. The units of system 100 including scanner 102, computer 104, and output display, printer and/or data storage device/medium 105, can be connected to each other for communications (e.g., data transfer, etc.), via any of hardwire, radio frequency communications, telecommunications, interne connection, or other communication means.

The present invention includes the following aspects/embodiments/features in any order and/or in any combination:

1. The present invention relates to a method for identifying a subsample representative digital volume corresponding to a sample of a porous media, comprising:
a) obtaining a segmented volume characterizing pore space and at least one solid phase;
b) deriving an average property value <P1> of a first target function P1 for the whole of the segmented volume;
c) calculating a standard deviation σᵥₒₗ with respect to average property value <P1> for the whole of the segmented volume;
d) defining a plurality of subvolumes within the volume;
e) calculating a standard deviation σᵢ of property value P of first target function P1 with respect to average property value <P1> for each of said subvolumes;
f) finding all candidate representative subvolumes for which standard deviation a, is a satisfactory match to σᵥₒₗ;
g) selecting and storing a representative subvolume from among the candidates; and
h) using the representative subvolume to derive at least one property value of interest.
2. The method of any preceding or following embodiment/feature/aspect, wherein defining a plurality of subvolumes within the volume further comprises:
defining an initial size for a subvolume;
populating the whole of the volume with subvolumes of the defined initial size; and
iterating the sizes for further subvolumes and populating the whole of the volume with subvolumes of such size and repeating this step until a stop criteria is met.
3. The method of any preceding or following embodiment/feature/aspect, wherein iterating the sizes proceeds from large to small in small increments.
4. The method of any preceding or following embodiment/feature/aspect, wherein selecting and storing a representative volume further comprises finding the smallest representative digital volume.
5. The method of any preceding or following embodiment/feature/aspect, wherein the stop criteria comprises a given size for the subvolume.
6. The method of any preceding or following embodiment/feature/aspect, further comprising:
orienting a selected axis of the Cartesian grid of the segmented volume to a defined flow direction; and
wherein:
deriving an average property value <P1> of a first target function P1 for the whole of the segmented volume comprises analysis of multiple digital slices of the sample volume taken orthogonal to the defined flow direction; and
calculating a standard deviation σᵢ of property P of first target function P1 with respect to average property value <P1> for each of said subvolumes proceeds with respect to the defined direction of flow.
7. The method of any preceding or following embodiment/feature/aspect, further comprising:
deriving an average property value <P2> of a second target function P2 for the whole of the segmented volume;
calculating a standard deviation σᵥₒₗ with respect to average property value <P2> for the whole of the segmented volume;
defining a plurality of subvolumes within the volume;
calculating a standard deviation σᵢ of property value P of second target function P2 with respect to average property value <P2> for each of said subvolumes;
finding all representative subvolumes for which standard deviation a, is a satisfactory match to σᵥₒₗ for a combination of first target function P1 and second target function P2.
8. The method of any preceding or following embodiment/feature/aspect, wherein the first target function P1 is porosity and the second target function P2 is the ratio of surface area to volume of the pore spaces.
9. The method of any preceding or following embodiment/feature/aspect, further comprising a step of qualifying a candidate subvolume before selection, comprising determining its suitability for use in deriving fluid transport properties through Darcy's Law, said step comprising:
building a distribution of standard deviation of target functions;
evaluating the average, or optionally any other first order characterization for the distribution of standard deviation of target function, and variance, kurtosis, or skewness, of the distribution;
evaluating the trend of first and higher order moment with respect to the dimension of the sub volume; and
stopping decreasing the sub volume dimension when the first order moment has change of at least 0.1 with respect to its value for distribution built on larger sub volume and/or when higher moments are higher than a specific threshold of 0.1 for the variance.
10. The present invention also relates to a method for identifying a subsample representative digital volume corresponding to a sample of a porous media, comprising:
a) obtaining a segmented volume characterizing pore space and at least one solid phase;
b) orienting a selected axis of the Cartesian grid of the segmented volume to a defined flow direction;
c) deriving values as one or more functions of at least a first target function P1 for the whole of the segmented volume through analysis of digital slices orthogonal to the defined flow direction;
d) defining a plurality of subvolumes within the volume;
e) calculating values for the one or more functions of at least a first target function P1 for each of said subvolumes respecting the defined direction of flow;
f) finding all representative subvolume candidates for which the function(s) identify a match between volume and subvolume values;
g) selecting a representative volume form among the candidates;
h) storing the representative subvolume; and
i) using the representative subvolume for simulation or to derive at least one property value of interest.
11. The present invention also relates to a method to obtain an efficient estimate of a representative elementary volume from a larger 3D digital image of a porous sample, said method comprising:
a) obtaining a segmented volume characterizing pore space and at least one solid phase;
b) deriving values as at least one function for at least a first target function P1 for the whole of the segmented volume;
c) defining a plurality of subvolumes within the volume, comprising: defining an initial size for a subvolume,
populating the whole of the volume with subvolumes of the defined initial size,
iterating the sized for further subvolumes and populating the whole of the volume with subvolumes of such size and repeating this step until a stop criteria is met;
d) calculating values as at least one function for at least the first target function for each of said subvolumes;
e) finding all representative subvolumes candidates for the values of the volume and the subvolume satisfactory match;
f) selecting and storing a representative subvolume from among the candidates; and
g) using the representative subvolume to conduct a simulation or derive at least one property value of interest.
12. The method of any preceding or following embodiment/feature/aspect, further comprising a step of qualifying a candidate subvolume before selection, comprising determining its suitability for use in deriving fluid transport properties through Darcy's Law, said step comprising:
building a distribution of standard deviation of target functions;
evaluating the average, or optionally any other first order characterization for the distribution of standard deviation of target function, and variance, kurtosis, or skewness, of the distribution;
evaluating the trend of first and higher order moment with respect to the dimension of the subvolume; and
stopping decreasing the subvolume dimension when the first order moment has change of at least 0.1 with respect to its value for distribution built on larger subvolume and/or when higher moments are higher than a specific threshold of 0.1 for the variance.
13. The present invention also relates to a method to obtain an efficient estimate of a representative elementary volume from a larger 3D digital image of a porous sample, comprising:
a) obtaining a segmented volume characterizing pore space and at least one solid phase;
b) orienting a selected axis of the Cartesian grid of the segmented volume to a defined flow direction;
c) deriving an average property value <P1> of a first target function P1 for the whole of the segmented volume using an analysis of multiple digital slices of the sample volume taken orthogonal to the defined flow direction;
d) calculating a standard deviation with respect to average property value <P1> for the whole of the segmented volume;
e) defining a plurality of subvolumes within the volume, comprising:
defining an initial size for a subvolume,
populating the whole of the volume with subvolumes of the defined initial size,
iterating the sizes for further subvolumes from large to small and populating the whole of the volume with subvolumes of such size and repeating this step until a stop criteria is met;
f) calculating a standard deviation a of property P with respect to average property value <P1> for each of said subvolumes respecting the defined direction of flow;
g) finding all candidate representative subvolumes for which σᵢ is a satisfactory match to σᵥₒₗ;
h) selecting the smallest candidate and storing this as a representative elementary volume; and
i) using the representative elementary volume to derive at least one property value of interest.
14. The method of any preceding or following embodiment/feature/aspect, further comprising:
deriving an average property value <P2> of a second target function P2 for the whole of the segmented volume;
calculating a standard deviation with respect to average property value <P2> for the whole of the segmented volume;
defining a plurality of subvolumes within the volume;
calculating a standard deviation a, of second target function P2 with respect to average property value <P2> for each of said subvolumes;
finding all representative subvolumes for which σᵢ is a satisfactory match to σᵥₒₗ for a combination of first target function P1 and second target function P2.
15. The method of any preceding or following embodiment/feature/aspect, wherein first target function P1 is porosity and second target function P2 is the ratio of surface area to volume of the pore spaces.
16. The method of any preceding or following embodiment/feature/aspect, further comprising a step qualifying a candidate subvolume before selection, comprising determining its suitability for use in deriving fluid transport properties through Darcy's Law, said step comprising:
building a distribution of standard deviation of target functions;
evaluating the average, or optionally any other first order characterization for the distribution of standard deviation of target function, and variance, kurtosis, or skewness, of the distribution;
evaluating the trend of first and higher order moment with respect to the dimension of the subvolume; and
stopping decreasing the subvolume dimension when the first order moment has change of at least 0.1 (or at least 0.5, 1, 2, 5, or any value) with respect to its value for distribution built on larger subvolume and/or when higher moments are higher than a specific threshold of 0.1 (or other value) for the variance.
17. A method for identifying a subsample representative digital volume corresponding to a sample of a porous media, comprising:
1) loading a segmented three dimensional image of a porous medium into a computer system;

wherein the segmented three-dimensional image comprises voxels each of which is assigned a grey scale value,

2) selecting a flow direction that is defined as the Z direction;
3) defining sizes of interrogation volumes, wherein
i) an interrogation volume is a subsample of the original segmented three-dimensional image with dimensions Xi, Yi and Zi, wherein the dimensions of the entire sample are Xs, Ys, Zs,
ii) a maximum number of interrogation volumes, imax, is defined,
iii) dimensions in voxels for each interrogation volume (Xi, Yi, Zi) are set, wherein Xi, Yi and Zi are defined for values of i from 1 to imax,
iv) the initial value of i is set to 1;
4) calculating selected properties Ps(0,0,0) through Ps(0,0,Zs) for each slice of the interrogation volume;
5) calculating σs(0,0,0);
6) setting the maximum coordinates that the interrogation volume of size Xi, Yi, Zi occupy within the entire sample of size Xs, Ys, Zs, wherein
i) amax=Xs−Xi+1,
ii) bmax=Ys−Yi+1,
iii) cmax=Zs−Zi+1;
7) setting location coordinates of the current interrogation volume to a=b=c=0;
8) calculating selected properties Pi(a,b,c) through Pi(a,b,c+Zi) for slices of the current interrogation volume, wherein the selected properties comprise porosity, surface area to volume ratio, similar properties, or any combination thereof;
9) calculating σi(a,b,c), i) wherein optionally values of Pi that are used to calculate the value of σi are filtered, ii) wherein optionally an average value for Pi is set;
10) moving the location of the interrogation volume by 1 voxel in the X direction, a=a+1;
11) repeating steps 8) through 10) and storing all values of Pi and σi until the value of the X coordinate of the current interrogation volume, a, has equaled the maximum value that the current interrogation volume can occupy, amax;
12) setting the X coordinate of the current interrogation volume to zero, a=0, and incrementing the Y coordinate of the current location volume by one voxel, b=b+1;
13) repeating steps 8) through 12) and storing all values of Pi and σi until the value of the Y coordinate of the current interrogation volume, b, has equaled the maximum value that the current interrogation volume can occupy, bmax;
14) setting the X coordinate of the current interrogation volume to zero, a=0, setting the Y coordinate of the current interrogation volume to zero, b=0, and incrementing the Z coordinate of the current location volume by one voxel, c=c+1;
15) repeating steps 8) through 14) and storing all values of Pi and σi until the value of the Z coordinate of the current interrogation volume, c, has equaled the maximum value that the current interrogation volume can occupy, cmax;
16) increasing the size of the current interrogation volume, comprising:
i) selecting the next set of interrogation volumes by increasing the pointer to the next interrogation volume, i=i+1, and
ii) setting the current interrogation size to Xi, Yi, Zi;
17) repeating steps 6) through 16) until all of the interrogation volumes have been selected and all values of Pi and of have been calculated and stored;
18) choosing one or more selected properties to match;
19) calculating λi for each interrogation volume;
20) selecting the interrogation volume with the smallest value of λi, wherein the selected interrogation volume is the size and location of the REV; and
21) computing properties of the porous medium.
18. The method of any preceding or following embodiment/feature/aspect, wherein the segmented three-dimensional image is produced as an image of the sample obtained by scanning the sample with a computed tomographic x-ray scanner, and segmenting the image by a software program to classify voxels as grain, pore, and optionally other phases.
19. The method of any preceding or following embodiment/feature/aspect, wherein the properties comprise properties of routine Core Analysis (RCAL) properties, Special Core Analysis (SCAL) properties, or both.
20. The method of any preceding or following embodiment/feature/aspect, wherein the RCAL analysis properties are porosity, kerogen content, absolute permeability in multiple axes, and the SCAL properties are relative permeability, capillary pressure, grain size distribution, electrical properties, elastic properties, and any combinations thereof.
21. A system for identifying a subsample representative digital volume corresponding to a sample of a porous media, comprising:
a) a scanner capable of producing a three dimensional digital image of a porous medium,
b) a computer comprising at least one processor operable for executing a computer program capable of obtaining a segmented volume characterizing pore space and at least one solid phase,
c) a computer (same or different from b)) comprising at least one processor operable for executing a computer program capable of performing computations, wherein said computations comprise i) deriving an average property value <P1> of a first target function P1 for the whole of the segmented volume, ii) calculating a standard deviation σᵥₒₗ with respect to average property value <P1> for the whole of the segmented volume, iii) defining a plurality of subvolumes within the volume, iv) calculating a standard deviation σᵢ of property value P of first target function P1 with respect to average property value <P1> for each of said subvolumes, v) finding all candidate representative subvolumes for which standard deviation σᵢ is a satisfactory match to σᵥₒₗ, vi) selecting and storing a representative subvolume from among the candidates, and vii) using the representative subvolume to derive at least one property value of interest, and
d) at least one device to display, print, or store results of the computations.
22. A computer program product on a computer readable medium (e.g., non-transitory) that, when performed on a processor in a computerized device provides a method for performing computations of one or more or all of the indicated steps of the preceding method and system.

The present invention can include any combination of these various features or embodiments above and/or below as set forth in sentences and/or paragraphs. Any combination of disclosed features herein is considered part of the present invention and no limitation is intended with respect to combinable features.

Other features, aspects, and advantages will be apparent from the foregoing description and appended claims. Further, not all features, aspects or advantages need be present in each embodiment of the invention and may appear individually, in various combinations, or in combination with other features, aspects or advantages without departing from the scope of the claimed invention.

What is claimed is:

1. A method for identifying a subsample representative digital volume corresponding to a sample of a porous media, comprising:
a) obtaining a segmented volume characterizing pore space and at least one solid phase;
b) deriving an average property value <P1> of a first target function P1 for the whole of the segmented volume;
c) calculating a standard deviation σᵥₒₗ with respect to average property value <P1> for the whole of the segmented volume;
d) defining a plurality of subvolumes within the volume;
e) calculating a standard deviation σᵢ of property value P of first target function P1 with respect to average property value <P1> for each of said subvolumes;
f) finding all candidate representative subvolumes for which standard deviation σᵢ is a satisfactory match to σᵥₒₗ;
g) selecting and storing a representative subvolume from among the candidates; and
h) using the representative subvolume to derive at least one property value of interest.

2. The method of claim 1, wherein defining a plurality of subvolumes within the volume further comprises:
defining an initial size for a subvolume;
populating the whole of the volume with subvolumes of the defined initial size; and
iterating the sizes for further subvolumes and populating the whole of the volume with subvolumes of such size and repeating this step until a stop criteria is met.

3. The method of claim 2, wherein iterating the sizes proceeds from large to small in small increments.

4. The method of claim 3, wherein selecting and storing a representative volume further comprises finding the smallest representative digital volume.

5. The method of claim 4, wherein the stop criteria comprises a given size for the subvolume.

6. The method of claim 2, further comprising:
orienting a selected axis of the Cartesian grid of the segmented volume to a defined flow direction; and
wherein:
deriving an average property value <P 1> of a first target function P1 for the whole of the segmented volume comprises analysis of multiple digital slices of the sample volume taken orthogonal to the defined flow direction; and
calculating a standard deviation σᵢ of property P of first target function P1 with respect to average property value <P 1> for each of said subvolumes proceeds with respect to the defined direction of flow.

7. The method of claim 6, further comprising:
deriving an average property value <P2> of a second target function P2 for the whole of the segmented volume;
calculating a standard deviation σᵥₒₗ with respect to average property value <P2> for the whole of the segmented volume;
defining a plurality of subvolumes within the volume;
calculating a standard deviation σᵢ of property value P of second target function P2 with respect to average property value <P2> for each of said subvolumes;
finding all representative subvolumes for which standard deviation σᵢ is a satisfactory match to σᵥₒₗ for a combination of first target function P1 and second target function P2.

8. The method of claim 7, wherein the first target function P1 is porosity and the second target function P2 is the ratio of surface area to volume of the pore spaces.

9. The method of claim 8, further comprising a step of qualifying a candidate subvolume before selection, comprising determining its suitability for use in deriving fluid transport properties through Darcy's Law, said step comprising:
building a distribution of standard deviation of target functions;
evaluating the average, or optionally any other first order characterization for the distribution of standard deviation of target function, and variance, kurtosis, or skewness, of the distribution;
evaluating the trend of first and higher order moment with respect to the dimension of the subvolume; and
stopping decreasing the subvolume dimension when the first order moment has change of at least 0.1 with respect to its value for distribution built on larger subvolume and/or when higher moments are higher than a specific threshold of 0.1 for the variance.

10. A method for identifying a subsample representative digital volume corresponding to a sample of a porous media, comprising:
a) obtaining a segmented volume characterizing pore space and at least one solid phase;
b) orienting a selected axis of the Cartesian grid of the segmented volume to a defined flow direction;
c) deriving values as one or more functions of at least a first target function P1 for the whole of the segmented volume through analysis of digital slices orthogonal to the defined flow direction;
d) defining a plurality of subvolumes within the volume;
e) calculating values for the one or more functions of at least a first target function P1 for each of said subvolumes respecting the defined direction of flow;
f) finding all representative subvolume candidates for which the function(s) identify a match between volume and subvolume values;
g) selecting a representative volume form among the candidates;
h) storing the representative subvolume; and
i) using the representative subvolume for simulation or to derive at least one property value of interest.

11. A method to obtain an efficient estimate of a representative elementary volume from a larger 3D digital image of a porous sample, comprising:
a) obtaining a segmented volume characterizing pore space and at least one solid phase;
b) deriving values as at least one function for at least a first target function P1 for the whole of the segmented volume;
c) defining a plurality of subvolumes within the volume, comprising:
defining an initial size for a subvolume,
populating the whole of the volume with subvolumes of the defined initial size,
iterating the sized for further subvolumes and populating the whole of the volume with subvolumes of such size and repeating this step until a stop criteria is met;
d) calculating values as at least one function for at least the first target function for each of said subvolumes;
e) finding all representative subvolumes candidates for the values of the volume and the subvolume satisfactory match;
f) selecting and storing a representative subvolume from among the candidates; and
g) using the representative subvolume to conduct a simulation or derive at least one property value of interest.

12. The method of claim 11, further comprising a step of qualifying a candidate subvolume before selection, comprising determining its suitability for use in deriving fluid transport properties through Darcy's Law, said step comprising:
building a distribution of standard deviation of target functions;
evaluating the average, or optionally any other first order characterization for the distribution of standard deviation of target function, and variance, kurtosis, or skewness, of the distribution;
evaluating the trend of first and higher order moment with respect to the dimension of the sub volume; and
stopping decreasing the subvolume dimension when the first order moment has change of at least 0.1 with respect to its value for distribution built on larger subvolume and/or when higher moments are higher than a specific threshold of 0.1 for the variance.

13. A method to obtain an efficient estimate of a representative elementary volume from a larger 3D digital image of a porous sample, comprising:
a) obtaining a segmented volume characterizing pore space and at least one solid phase;
b) orienting a selected axis of the Cartesian grid of the segmented volume to a defined flow direction;
c) deriving an average property value <P 1> of a first target function P1 for the whole of the segmented volume using an analysis of multiple digital slices of the sample volume taken orthogonal to the defined flow direction;
d) calculating a standard deviation with respect to average property value <P1> for the whole of the segmented volume;
e) defining a plurality of subvolumes within the volume, comprising:
defining an initial size for a subvolume,
populating the whole of the volume with subvolumes of the defined initial size,
iterating the sizes for further subvolumes from large to small and populating the whole of the volume with subvolumes of such size and repeating this step until a stop criteria is met;
f) calculating a standard deviation σᵢ of property P with respect to average property value <P1> for each of said subvolumes respecting the defined direction of flow;
g) finding all candidate representative subvolumes for which σᵢ is a satisfactory match to σᵥₒₗ;
h) selecting the smallest candidate and storing this as a representative elementary volume; and
i) using the representative elementary volume to derive at least one property value of interest.

14. The method of claim 13, further comprising:
deriving an average property value <P2> of a second target function P2 for the whole of the segmented volume;
calculating a standard deviation with respect to average property value <P2> for the whole of the segmented volume;
defining a plurality of subvolumes within the volume;
calculating a standard deviation σᵢ of second target function P2 with respect to average property value <P2> for each of said subvolumes;
finding all representative subvolumes for which σᵢ is a satisfactory match to σᵥₒₗ for a combination of first target function P1 and second target function P2.

15. The method of claim 14, wherein first target function P1 is porosity and second target function P2 is the ratio of surface area to volume of the pore spaces.

16. The method of claim 15, further comprising a step qualifying a candidate subvolume before selection, comprising determining its suitability for use in deriving fluid transport properties through Darcy's Law, said step comprising:
building a distribution of standard deviation of target functions;
evaluating the average, or optionally any other first order characterization for the distribution of standard deviation of target function, and variance, kurtosis, or skewness, of the distribution;
evaluating the trend of first and higher order moment with respect to the dimension of the subvolume; and
stopping decreasing the subvolume dimension when the first order moment has change of at least 0.1 with respect to its value for distribution built on larger subvolume and/or when higher moments are higher than a specific threshold of 0.1 for the variance.

17. A method for identifying a subsample representative digital volume corresponding to a sample of a porous media, comprising:
1) loading a segmented three dimensional image of a porous medium into a computer system;
wherein the segmented three-dimensional image comprises voxels each of which is assigned a grey scale value;
2) selecting a flow direction that is defined as the Z direction;
3) defining sizes of interrogation volumes, wherein
i. an interrogation volume is a subsample of the original segmented three-dimensional image with dimensions Xi, Yi and Zi, wherein the dimensions of the entire sample are Xs, Ys, Zs,
ii. a maximum number of interrogation volumes, imax, is defined,
iii. dimensions in voxels for each interrogation volume (Xi, Yi, Zi) are set, wherein Xi, Yi and Zi are defined for values of i from 1 to imax,
iv. the initial value of i is set to 1;
4) calculating selected properties Ps(0,0,0) through Ps(0,0,Zs) for each slice of the interrogation volume;
5) calculating σs(0,0,0);
6) setting the maximum coordinates that the interrogation volume of size Xi, Yi, Zi occupy within the entire sample of size Xs, Ys, Zs, wherein
i. amax=Xs−Xi+1,
ii. bmax=Ys−Yi+1,
iii. cmax=Zs−Zi+1;
7) setting location coordinates of the current interrogation volume to a=b=c=0;
8) calculating selected properties Pi(a,b,c) through Pi(a,b,c+Zi) for slices of the current interrogation volume,
i. wherein the selected properties comprise porosity, surface area to volume ratio, similar properties, or any combination thereof;
9) calculating σi(a,b,c),
i. wherein optionally values of Pi that are used to calculate the value of σi are filtered,
ii. wherein optionally an average value for Pi is set;
10) moving the location of the interrogation volume by 1 voxel in the X direction, a=a+1;
11) repeating steps 8) through 10) and storing all values of Pi and σi until the value of the X coordinate of the current interrogation volume, a, has equaled the maximum value that the current interrogation volume can occupy, amax;
12) setting the X coordinate of the current interrogation volume to zero, a=0, and incrementing the Y coordinate of the current location volume by one voxel, b=b+1;
13) repeating steps 8) through 12) and storing all values of Pi and σi until the value of the Y coordinate of the current interrogation volume, b, has equaled the maximum value that the current interrogation volume can occupy, bmax;
14) setting the X coordinate of the current interrogation volume to zero, a=0, setting the Y coordinate of the current interrogation volume to zero, b=0, and incrementing the Z coordinate of the current location volume by one voxel, c=c+1;
15) repeating steps 8) through 14) and storing all values of Pi and σi until the value of the Z coordinate of the current interrogation volume, c, has equaled the maximum value that the current interrogation volume can occupy, cmax;
16) increasing the size of the current interrogation volume, comprising:
i. selecting the next set of interrogation volumes by increasing the pointer to the next interrogation volume, i=i+1, and
ii. setting the current interrogation size to Xi, Yi, Zi;
17) repeating steps 6) through 16) until all of the interrogation volumes have been selected and all values of Pi and σi have been calculated and stored;
18) choosing one or more selected properties to match;
19) calculating λi for each interrogation volume;
20) selecting the interrogation volume with the smallest value of λi, wherein the selected interrogation volume is the size and location of the REV; and
21) computing properties of the porous medium.

18. The method of claim 17, wherein the segmented three-dimensional image is produced as an image of the sample obtained by scanning the sample with a computed tomographic x-ray scanner, and segmenting the image by a software program to classify voxels as grain, pore, and optionally other phases.

19. The method of claim 17, wherein the properties comprise properties of routine Core Analysis (RCAL) properties, Special Core Analysis (SCAL) properties, or both.

20. The method of claim 19, wherein the RCAL analysis properties are porosity, kerogen content, absolute permeability in multiple axes, and the SCAL properties are relative permeability, capillary pressure, grain size distribution, electrical properties, elastic properties, and any combinations thereof.

21. A system for identifying a subsample representative digital volume corresponding to a sample of a porous media, comprising:
a) a scanner capable of producing a three dimensional digital image of a porous medium,
b) a computer comprising at least one processor operable for executing a computer program capable of obtaining a segmented volume characterizing pore space and at least one solid phase,
c) a computer (same or different from b)) comprising at least one processor operable for executing a computer program capable of performing computations, wherein said computations comprise i) deriving an average property value <P1> of a first target function P1 for the whole of the segmented volume, ii) calculating a standard deviation σᵥₒₗ with respect to average property value <P1> for the whole of the segmented volume, iii) defining a plurality of subvolumes within the volume, iv) calculating a standard deviation a, of property value P of first target function P1 with respect to average property value <P 1> for each of said subvolumes, v) finding all candidate representative subvolumes for which standard deviation σᵢ is a satisfactory match to σᵥₒₗ, vi) selecting and storing a representative subvolume from among the candidates, and vii) using the representative subvolume to derive at least one property value of interest, and
d) at least one device to display, print, or store results of the computations.

22. A computer program product on a computer readable medium that, when performed on a processor in a computerized device provides a method for performing computations of one or more or all of the indicated steps of the method of claim 1.
